(19) United States
(12) Patent Application Publication
(10) Pub. No.: US 2024/0328245 A1
(43) Pub. Date: Oct. 3, 2024

(54) MODULAR ROLL-UP WALL SYSTEM, TUBE MOTOR APPARATUS, AND METHOD FOR CORRECTING DIFFERENTIAL TUBE ASSEMBLY TRAVEL

(71) Applicant: TUDELU HOLDINGS LLC, Little Ferry, NJ (US)

(72) Inventors: Jacob Fleischman, Brooklyn, NY (US); Avihay Ashush, Nir Akiva (IL)

(21) Appl. No.: 18/523,753

(22) Filed: Nov. 29, 2023

Related U.S. Application Data
(60) Provisional application No. 63/385,361, filed on Nov. 29, 2022.
(60) Provisional application No. 63/516,511, filed on Jul. 29, 2023.

(51) Int. Cl. E06B 9/13; E06B 5/20; E06B 9/171; E06B 9/68; E06B 9/72

(52) U.S. Cl. CPC E06B 9/13; E06B 5/20; E06B 9/171; E06B 9/68; E06B 9/72; E06B 2009/6845

(57) ABSTRACT

A modular roll-up wall system (10) is disclosed. The modular roll-up wall system (10) may include a frame (20), a first tube motor assembly (366A), a second tube motor assembly (366B), and a control unit (264) operatively associated with the first tube motor assembly (366A) and the second tube motor assembly (366B). The control unit (264) may monitor and correct differential rotational travel between the first tube motor assembly (366A) and the second tube motor assembly (366B). A first screen (16A) may be connected to the first tube motor assembly (366A). A second screen (16B) may be connected to the second tube motor assembly (366B). The modular roll-up wall system (10) may form an acoustic barrier which achieves a Sound Transmission Class rating of approximately 46 STC.

### CROSS-REFERENCE TO RELATED APPLICATIONS

This application claims the benefit of U.S. Provisional Application No. 63/385,361 filed Nov. 29, 2022. Also, this application claims the benefit of U.S. Provisional Application No. 63/516,511 filed Jul. 29, 2023. The entire disclosure of each of the U.S. patent applications mentioned in this paragraph is incorporated by reference herein.

### FIELD OF THE INVENTION

The present invention generally relates to a retractable wall or partition system. More particularly, this invention relates to a modular retractable wall system which may be used to divide a room or space or create an acoustic barrier.

### BACKGROUND

Retractable walls may provide the ability to divide a room. Still, a need exists for retractable wall systems that may be suitable for dividing larger rooms and interior public spaces. Hence, a modular roll-up wall system, components for same, and a method for constructing and operating a modular roll-up wall system are presented.

### SUMMARY

A modular roll-up wall system is disclosed. The modular roll-up wall system may include a vertical track, a frame and roller assembly, a tube, and a flexible barrier connected to the tube. The modular roll-up wall system may be erected within a structure to form a relocatable partition. More particularly, the roll-up wall system may include a frame having a longitudinal axis, a first roller disposed in the frame, and a second roller disposed in the frame. The second roller may be spaced from the first roller along a first axis that is perpendicular to the longitudinal axis. The roll-up wall system further may include a tube assembly disposed in the frame, the tube assembly including a cleat and being spaced from the first roller and the second roller along a second axis, the second axis being perpendicular to the longitudinal axis and the first axis.

The roll-up wall may include a fabric panel and a hook segment, the fabric panel being secured to the hook segment, and the hook segment being interlocked with the cleat. The tube assembly may be supported by the first roller and the second roller, the screen being movable between a first configuration and a second configuration. In the first configuration, the screen may be rolled onto the tube assembly and the hook segment, the tube assembly being spaced a first distance from the first roller along the second axis. In the second configuration, the screen forms a barrier adjacent the frame, the tube assembly being spaced a second distance from the first roller along the second axis, and the second distance being less than the first distance.

The frame further may include a first end, a second end spaced from the first end along the longitudinal axis, a first support arm adjacent the first end, and a second support arm located between the first support arm and the second end. The first roller may be supported by the first support arm and the second support arm. Also, the second roller may be supported by the first support arm and the second support arm. The second roller may be parallel to the first roller. Further, the second roller and the first roller may be substantially the same. The frame may further include a proximal end cap and a distal end cap.

The tube assembly may hold a tube motor. The tube motor may be disposed inside the tube assembly. An anti-rotation arm may be connected to the tube motor and the proximal end cap. The tube motor may be a 280 N-m tube motor. Also, the tube motor may be a 300 N-m tube motor. A plurality of support arms may be secured to the frame between the proximal end cap and the distal end cap. Each of the plurality of support arms may be spaced uniformly (e.g., 24 inches apart from each other).

The screen may be formed from one or more fabric panels. For instance, the one or more fabric panels may each include a decorative material layer, a reinforced mass loaded vinyl core, and a felt backing layer. The decorative layer and the reinforced mass loaded vinyl core may be laminated together to form a unitary fabric. The felt backing layer may be a felt material formed from natural or synthetic non-woven fibers. The felt backing layer may be glued to the fabric panel. A fabric panel may be joined to another fabric panel by a zipper chain.

The modular roll-up wall system may include a second tube assembly adjacent to the tube assembly. A second screen may be connected to the second tube assembly. The first screen and the second screen may provide an acoustic barrier with a Sound Transmission Class rating ranging from approximately 46 STC to 53 STC.

Additionally, the roll-up wall system also may include a control unit operatively associated with the first tube assembly and the second tube assembly. The control unit may include means for monitoring and correcting differential rotational travel between the first tube assembly and the second tube assembly. Additionally, the control unit may include a combinational logic circuit to ensure that the system's I/O peripherals and hardware components are operating properly before the first tube motor assembly, or the second tube motor assembly is energized.

### DESCRIPTION OF THE DRAWINGS

In the accompanying drawings, which form part of this specification and are to be read in conjunction therewith and in which like reference numerals are used to indicate like parts in the various views:

FIG. 1 is a perspective view of an exemplary embodiment of a modular wall system;

FIG. 2 is a perspective view of a base frame component of FIG. 1;

FIG. 3 is a perspective view of the base frame component of FIG. 1, along with two parallel tube assemblies, a partial proximal end cap component, and a partial distal end cap component;

FIG. 4 is detailed perspective view of part of the base frame component, the proximal end cap component, the associated tube motor, and tube.

FIG. 5 is an exploded view of the tube motor and anti-rotation arm of FIG. 4;

FIG. 6 is sectional view of the modular wall system of FIG. 1, along line 6-6;

FIG. 7 is a cross-sectional view the modular wall system of FIG. 1, along line 7-7:

FIG. 8 is a perspective view of the distal end of the modular wall system of FIG. 1;

FIG. 9 is an exploded view of a tube and idler of the modular wall system of FIG. 1;

FIG. 10 is sectional view of the modular wall system of FIG. 1, along line 10-10;

FIG. 11 is a partial cut away view of the distal end cap component of FIG. 8;

FIG. 12 is a sectional view of the modular wall system of FIG. 1, along line 12-12, the modular wall system being in a mounted configuration;

FIG. 13 is a sectional view of the modular wall system of FIG. 1, along line 12-12, the modular wall system being in a wound configuration;

FIG. 14 is a perspective view of a modular tube segment and associated hook of FIG. 12;

FIG. 15 is an exploded cross-sectional view of the modular tube segment and associated hook of FIG. 12;

FIG. 16 is a cross-sectional view of a modular tube segment and associated hook of FIG. 12 in a deployed configuration;

FIG. 17 is a perspective view of a support arm of FIG. 2;

FIG. 18 is another perspective view of the support arm of FIG. 17;

FIG. 19 is a top view of the support arm of FIG. 17;

FIG. 20 is a right side view of the support arm of FIG. 17;

FIG. 21 is a rear view of the support arm of FIG. 17;

FIG. 22 is a flat pattern for fabricating the support arm of FIG. 17;

FIG. 23 is a perspective view of a distal support plate of FIG. 2;

FIG. 24 is a right side view of the distal support plate of FIG. 23;

FIG. 25 is a partial sectional view of a vertical track, base track, and flexible barrier material in a first lowered configuration;

FIG. 26 is a partial sectional view of the vertical track, base track, and flexible barrier material in a second lowered configuration;

FIG. 27 is a cross-section of the modular wall system of FIG. 1, along line 27-27.

FIG. 28 is a partial exploded view of an end cap and associated base track and flexible barrier material;

FIG. 29 is a perspective view of the end cap of FIG. 28.

FIG. 30 is a perspective view of another embodiment of a modular wall system, the flexible barrier material being in a deployed configuration;

FIG. 31 is a cross-section of the modular wall system of FIG. 30, along line 31-31;

FIG. 32 is an exemplary fabric panel;

FIG. 33 is a detail view of the top of the fabric panel of FIG. 32;

FIG. 34 is a detail view of the bottom of the fabric panel of FIG. 32;

FIG. 35 is a detail view of the fabrication of the fabric panel of FIG. 32 showing a binder and zipper ribbon configuration on the side of the fabric;

FIG. 36 is a detail view of the fabrication of the fabric panel of FIG. 32 showing the application of a keder to the top of the fabric;

FIG. 37 is a detail view of the fabrication of the fabric panel of FIG. 32 showing the application of a keder to the bottom of the fabric;

FIG. 38 is a detail view of the fabrication of the fabric panel of FIG. 32 showing the application of a felt backing to the fabric;

FIG. 39 is a detail view of two fabric panels of FIG. 32, the fabric panels being zipped together;

FIG. 40 is a perspective view of the fabric panel of FIG. 32 rolled on a 6″ diameter core:

FIG. 41 is a detail view of the fabric panel of FIG. 40 being connected to a hook segment;

FIG. 42 is a perspective view of the fabric panel and hook segment of FIG. 41 being arranged for shipment with a packing material;

FIG. 43 is a perspective view of the fabric panel and hook segment of FIG. 42 with a protective cover;

FIG. 44 is a perspective view of the fabric panel and hook segment of FIG. 43 inside a packaging tube;

FIG. 45 is a perspective view of the packaging tube of FIG. 43, the packaging tube being sealed with an end cap.

FIG. 46 is a perspective view of six packaging tubes, each of the packaging tubes containing a fabric panel and hook segment of FIG. 43 for use in a modular roll up wall system.

FIG. 47 is a perspective view of an exemplary control panel and control unit for the modular roll up wall system of FIG. 1 or FIG. 30.

FIG. 48 is a schematic diagram of the modular roll up wall system of FIG. 1 or FIG. 30;

FIG. 49 is a block diagram of an exemplary power and control system for FIG. 48;

FIG. 50 is front perspective view of an illustrative control box of FIG. 48;

FIG. 51 is front perspective view of the main PCB and power control box of FIG. 48;

FIG. 52 is a rear perspective view of the front panel of the control box of FIG. 48;

FIG. 53 is a perspective view of the main PCB and an LED PCB of the control box of FIG. 48;

FIG. 54 is a perspective view of an exemplary encoder (or sensor assembly) for the control system of FIG. 48;

FIG. 55 is a perspective view of an exemplary sensor holder and sensor assembly of FIG. 54.

FIG. 56 is a perspective view of an exemplary tube motor assembly for the modular roll-up wall system of FIG. 1;

FIG. 57 is another view of the tube motor assembly of FIG. 56 without the sensor assembly;

FIG. 58 is a perspective view of the encoder ring and tube assembly of FIG. 57;

FIG. 59 is a front perspective view of the encoder ring of FIG. 58;

FIG. 60 is a plan view of an exemplary design of the encoder ring of FIG. 59;

FIG. 61 is a side view of the encoder ring of FIG. 59;

FIG. 62 is a section view of the encoder ring of FIG. 61 along line 62-62;

FIG. 63 is a section view of the encoder ring of FIG. 61 along line 63-63;

FIG. 64 is a perspective view of a magnet of the encoder ring of FIG. 60;

FIG. 65 is a side view of the magnet of FIG. 64;

FIG. 66 is a plan view of the magnet of FIG. 64;

FIG. 67 is a plan view of the sensor holder of FIG. 56;

FIG. 68 is a section view of the magnetic sensor holder of FIG. 67, along line 68-68;

FIG. 69 is a perspective view of an illustrative tube motor;

FIG. 70 is a perspective view of the tube motor of FIG. 69 with a sensor holder;

FIG. 71 is perspective view of a tube motor assembly including the tube motor of FIG. 69, the sensor holder of FIG. 67, along with the encoder ring and tube assembly of FIG. 58;

FIG. 72 shows an exemplary light-curtain sensor, including a transmitter component and a receiver component;

FIG. 73 is an illustrative embodiment of a panel of FIG. 48;

FIG. 74 is a perspective view of an illustrative roll up wall system, including a control panel and cabling for connecting to the control unit of FIG. 50;

FIG. 75 is an integrated circuit logic diagram for line control of a tube motor of FIG. 49;

FIG. 76 is a state table for the integrated circuit logic diagram of FIG. 75;

FIG. 77 is a state diagram of a software program resident in the main controller of FIG. 49;

FIG. 78 presents an exemplary control system algorithm for correcting misalignment of the first tube assembly and the second tube assembly of FIG. 49;

FIG. 79 is a flowchart of an exemplary software program resident in the main controller of FIG. 49 for monitoring and correcting travel misalignment of the first tube assembly and the second tube assembly;

FIG. 80 is a continuation of the flowchart of FIG. 79;

FIG. 81 is schematic diagram illustrating estimated travel of a tube assembly at time t₀;

FIG. 82 is schematic diagram illustrating estimated travel of a tube assembly at time t1;

FIG. 83 is schematic diagram illustrating estimated travel of a tube assembly at time t2;

FIG. 84 is schematic diagram illustrating estimated travel of a tube assembly at time t3;

FIG. 85 is schematic diagram illustrating estimated travel of a tube assembly at time t4;

FIG. 86 is a perspective view of a multiple panel modular wall system in a deployed configuration;

FIG. 87 is a perspective view of concealment strip being applied over a seam between adjacent panels of the multiple panel modular wall system of FIG. 86;

FIG. 88 is a perspective view of the as-applied concealment strip of FIG. 87.

### DESCRIPTION

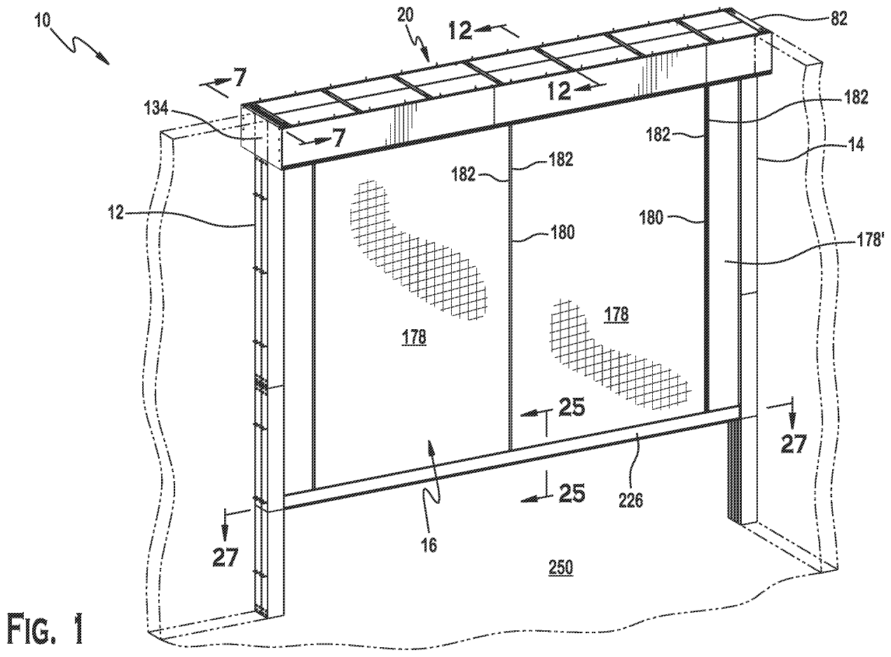

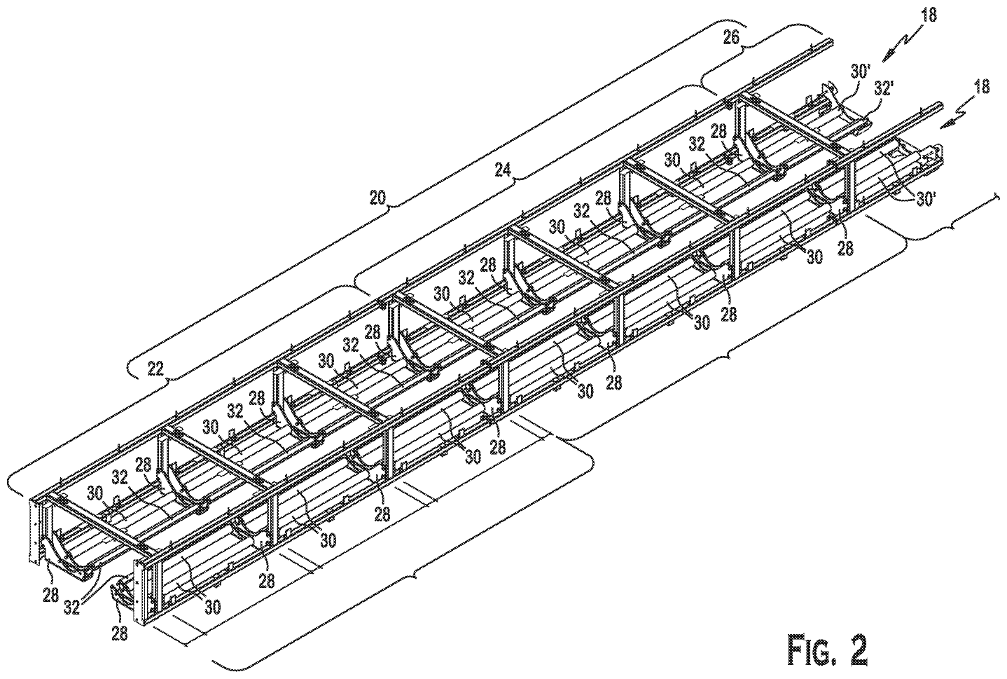

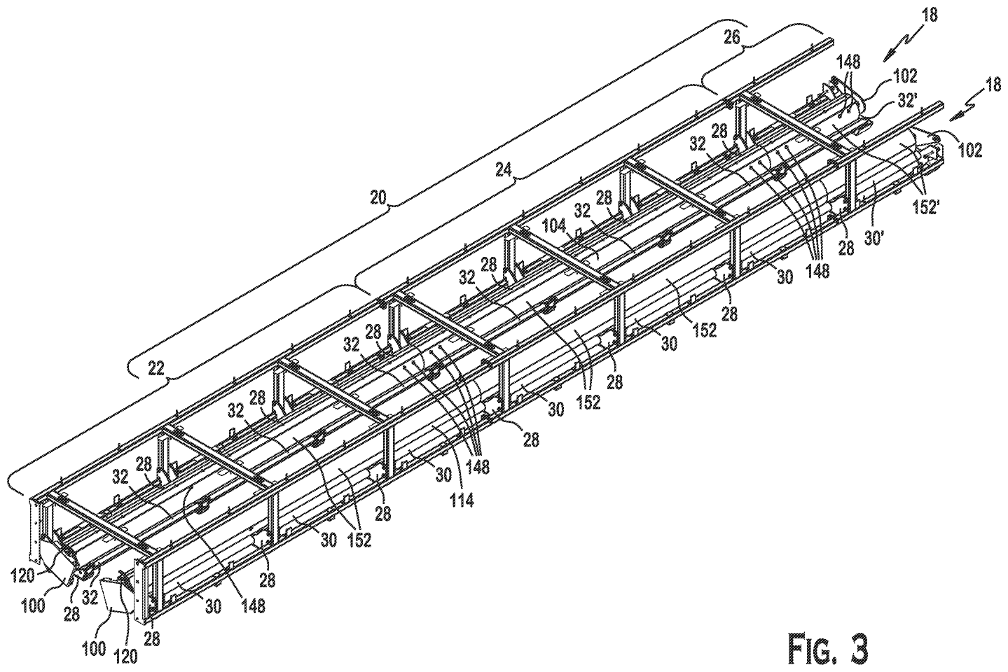

FIG. 1 depicts an exemplary modular wall system 10. The modular wall system 10 may include a first vertical post 12, and a second vertical post 14. Disposed between the first and second vertical posts is a screen (or flexible barrier material) 16. Referring to FIG. 3, the screen 16 may be connected to a tube assembly 104 and set up on a roller system 18. Referring to FIG. 2 and FIG. 3, the roller system 18 may be mounted in a frame 20. As shown in FIG. 1, the first vertical post 12 and the second vertical post 14 may be arranged below the frame 20. The frame 20 may be secured to a structure (not shown) above an opening in which the modular wall system 10 is to be installed.

Referring to FIG. 2, the frame 20 may be formed from one or more components, including a motor frame 22 and a center frame 24 and end frame 26. Referring to FIG. 3, the motor frame 22 may house one or more support arms 28. A plurality of rollers 30, 32 may be disposed between adjacent support arms 28. The rollers 30, 32 may be steel rollers manufactured by Miller Bearing Company, Inc of Bromfield, Ohio. For example, a pair of 1.375-inch diameter rollers 30 and one 0.75-inch diameter roller 32 may be supported on one end by one support arm 28 and on the other end by an adjacent support arm 28. Additionally, each pair of adjacent support arms 28 may support a pair of 1.375-inch diameter rollers 30 and one 0.75-inch diameter roller 32.

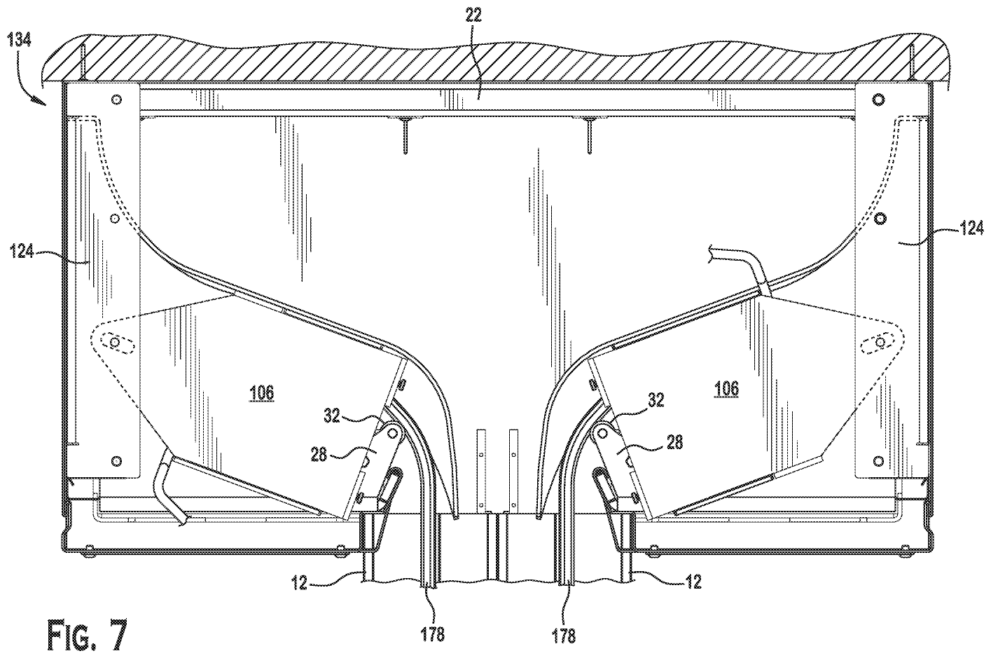

Referring to FIG. 2, the length of the frame 20 may be increased by connecting a center frame 24 to the motor frame 22. Generally, as shown in FIG. 8, a flange(s) 34 with one (or more) fastener hole(s) on one end of the one frame segment may be bolted to an opposing flange(s) 36 and fastener hole(s) on an adjacent frame segment. In this manner, an additional center frame 24 may be fixed to the other end of one center frame 24. As shown in FIG. 2 and FIG. 3, a center frame 24 may be measured, cut to a desired length, and then secured to a preceding motor frame 22 or a preceding center frame 24 to create a custom and intermediate length end frame 26. Accordingly, the length of the frame 20 may be determined by the number of modular sections of center frames and end frames connected to the motor frame.

Although a motor frame 22 and a center frame 24 may be weldment frames formed from square and rectangular members, as well as hot rolled steel bars, other structural shapes and members (e.g., channel, angle, T. I, or thin wall structural members) and joint constructions may be used to create a substantially rigid load bearing frame that may support and house components of the roll-up wall system. Similarly, although the structural members of the frame may be formed from carbon steel, other metals, alloys, or other materials may be used to modify or optimize engineering properties of the frame for a given application. For example, a titanium alloy may be used to reduce weight and enhance strength of the frame to facilitate modular wall systems having increased tube lengths or multiple roller assemblies. In another example, a corrosion resistant alloy may be selected for use in installations near the ocean.

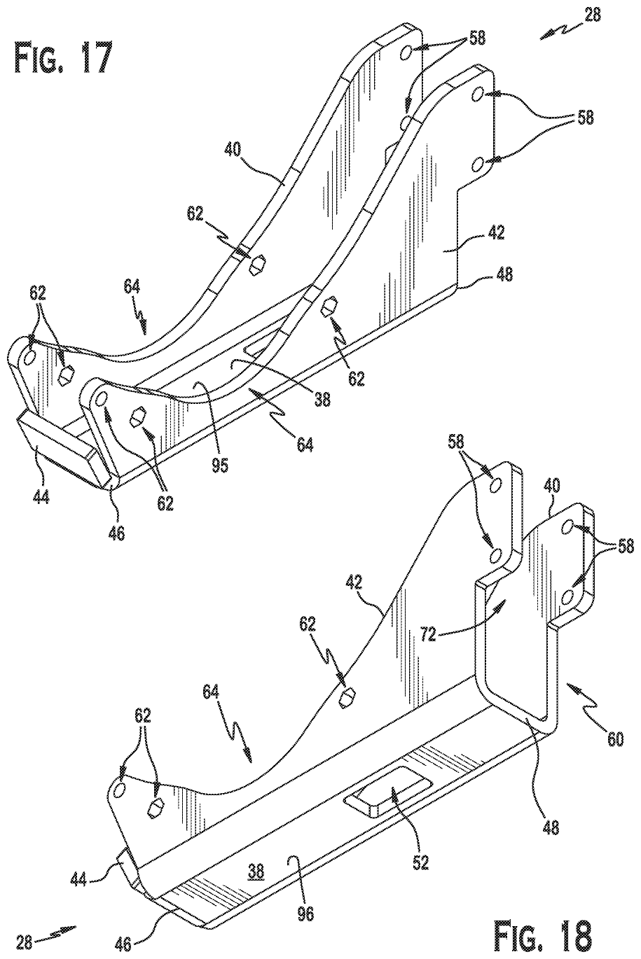

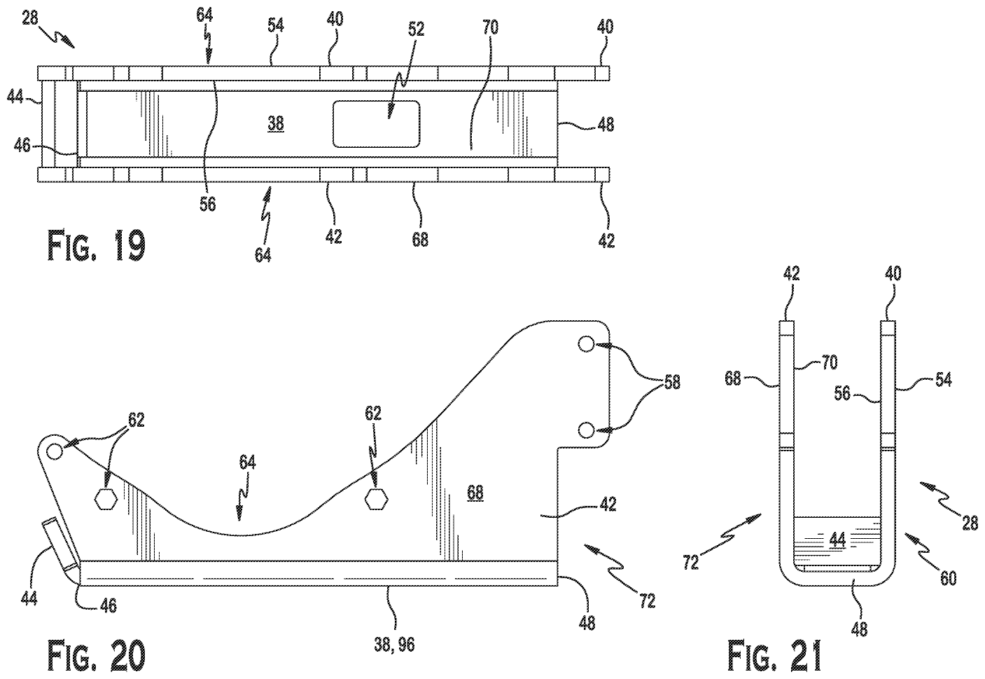

Referring to FIGS. 17-21, a support arm 28 may include a base 38, a port side bracket 40 and a starboard side bracket 42. The support arm may include a stem 44, and front end 46 and a rear end 48. An upper surface 100 may extend from the front end to the rear end of the bracket. The upper surface may be planar and smooth. Referring to FIGS. 18, 20 and 21, the base 38 further may include a lower surface 102. Referring to FIG. 19, the base 38 may include an aperture 52 situated adjacent to the rear end. The aperture 52 may extend from the upper surface to the lower surface.

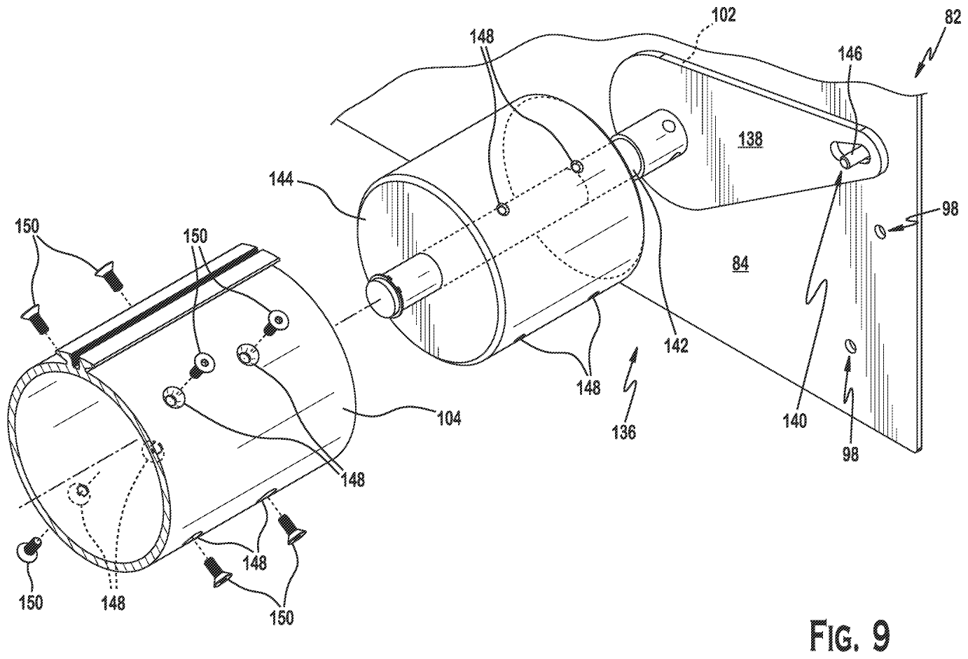

The port side bracket 40 may connect to the base 38 on the port side of the motor support arm 28. Referring to FIGS. 17, 19 and 21, the port side bracket 40 may be planar having a generally flat and smooth outer surface 54 and a generally flat and smooth inner surface 56. The inner surface and outer surface of the port side bracket may be substantially parallel to one another. The port side bracket 40 further may include two fastener receiving holes 58. Each fastener receiving hole 58 may extend from the inner surface to the outer surface. As shown in FIG. 18, two fastener receiving holes may be aligned vertically above a generally square notch 60 located at the lower rear portion of the port side interior bracket 40. The port side bracket 40 further may include three spindle receiving bores 62. One spindle receiving bore may be situated adjacent the front end 46 of the base. The other two spindle receiving bores 62 may be disposed on opposite sides of a recessed profile segment 64. The recessed profile segment 64 may extend below the adjacent spindle receiving bores 62. The recessed profile segment 64 may be concave. The adjacent spindle receiving bores may be horizontally aligned. One or more of the spindle receiving bores 62 may possess a central axis and the bore may define a cross-sectional area normal to the central axis of the bore. The cross-sectional area may be uniform along the central axis. The cross-sectional area may have a geometric shape. For example, one or more spindle receiving bores may each define a cross-sectional area having a hex shape. In another example, a spindle receiving bore may define a cross-sectional area having a circular shape. Although, the spindle receiving bores 62 shown in FIGS. 17-21 define a cross-sectional area having a circular shape or a hex shape, any shape may be used provided that the bore securely holds a roller spindle 66 (see e.g., FIG. 6 and FIG. 10).

The starboard side bracket 42 may connect to the base 38 on the starboard side of the motor support arm 28. Referring to FIG. 21, the starboard side bracket 42 may be planar having a generally flat and smooth outer surface 68 and a generally flat and smooth inner surface 70. The inner surface and outer surface of the exterior bracket may be substantially parallel to one another. The starboard side bracket 42 further may include two fastener receiving holes 58. Each fastener receiving hole 58 may extend from the inner surface 70 to the outer surface 68. As shown in FIG. 18, two fastener receiving holes may be aligned vertically above a generally square notch 72 located at the lower rear portion of the starboard side bracket 42. Each of the two vertically aligned fastener receiving bores 58 may include a weldment nut on the outer surface 68. The fastener receiving holes 58 on the starboard side bracket 42 and the fastener receiving holes 58 on the port side bracket 54 may be aligned. Each respective pair of aligned fastener-receiving holes may be used to hold and receive a fastener (e.g., a bolt or rivet). Further still, each support arm 28 may be configured and dimensioned to attach to a vertical structural member of the frame 20. For example, one support arm 28 may be secured to a vertical structural member of the motor frame 22 or center frame 24 at a spacing of approximately 24 inches.

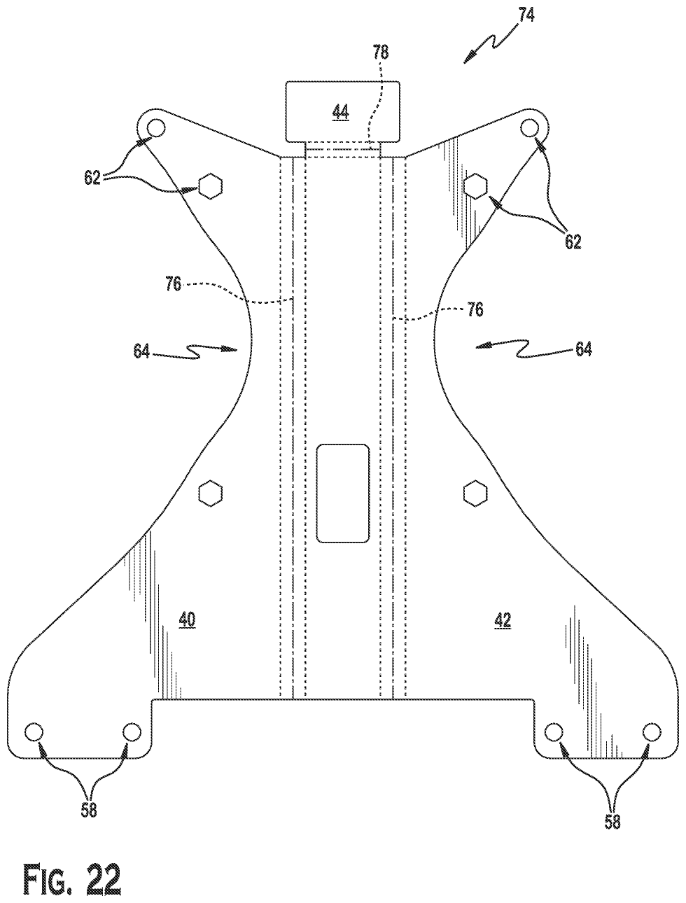

FIG. 22, shows a flat pattern 74 for forming the support arm 28. The flat pattern 28 includes two parallel bend lines 76. The direction of each bend is down. The bend angle for each of the bend lines is approximately 90 degrees. For example, the work piece may be a sheet of carbon steel. A third bend line 78 for forming the stem may have a bend angle ranging from approximately 45 degrees to approximately 60 degrees.

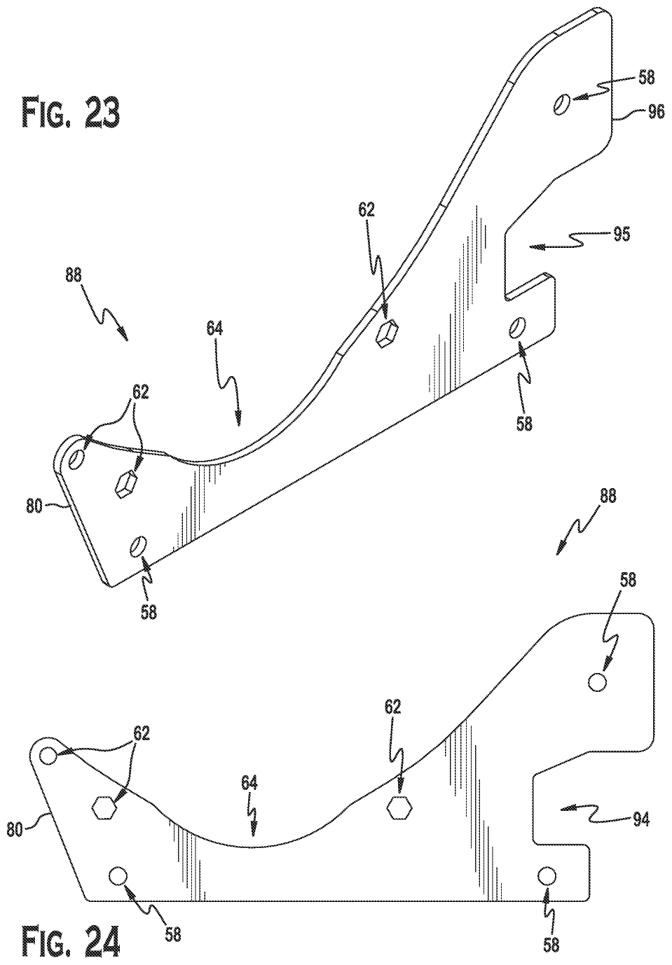

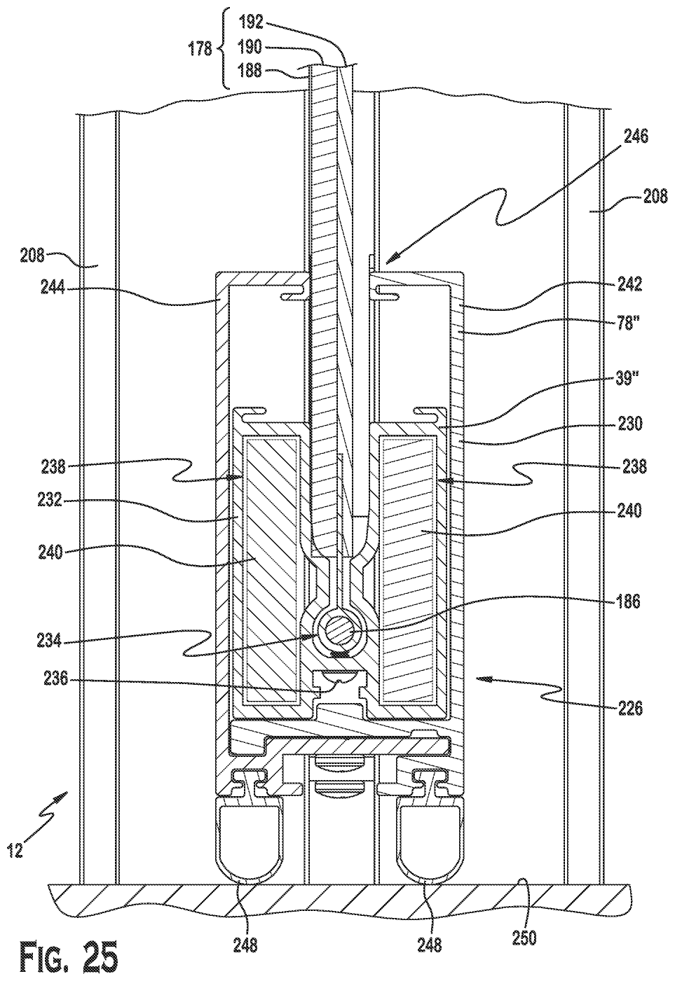

Referring to FIGS. 2, 3 and 4, the end frame 26 may include an end cap 82. Referring to FIG. 2 the end cap 82 may include an end wall 84, an L-shaped bracket 86, a roller support plate 88, a threaded fastener 90, and a compression screw 92. Referring to FIG. 23 and FIG. 24, the roller support plate 88 may be shaped like the support arm brackets 54, 56. For example, the roller support plate may include a similar shaped profile including a front end 80 and a rear end as well as a plurality of corresponding spindle receiving bores 62. The roller support plate 88 further may include a plurality of fastener receiving holes 58 and notch 94 in the rear end 98. Each of the fastener receiving bores 58 may include a weldment nut (not shown) on the starboard side surface.

A shown in FIGS. 8, 10 and 11 each of the threaded fasteners may be arranged through a fastener receiving hole, a compression spring and advanced into a fastener receiving hole in the L-shaped bracket 86 or end wall 84. In this manner, a spring-loaded device may be formed for selectively adjusting the spacing between the roller support plate 88 and the end wall 84. In use, each threaded fastener 90 is adjusted until the gap between the roller support plate 88 and the end wall 84 allows the end wall to cover the distal end of the end frame 26 while positioning the roller support plate 88 to accept the respective spindles 66 of a terminal set of rollers 30′, 32′ in the corresponding spindle receiving bores 62. Generally, the terminal set of rollers are approximately 1-inch shorter than the length of the end frame.

Referring to FIG. 3, the modular wall system 10 further may include a proximal anti-rotation arm 100 and a distal anti-rotation arm 102. Generally, a pair of proximal and distal anti-rotation arms 100, 102 may be secured to opposite ends of the tube assembly 104. In use, an anti-rotation arm 100, 102 may restrict oscillation of the tube assembly as the flexible barrier material 16 is wound or unwound from the tube assembly 104.

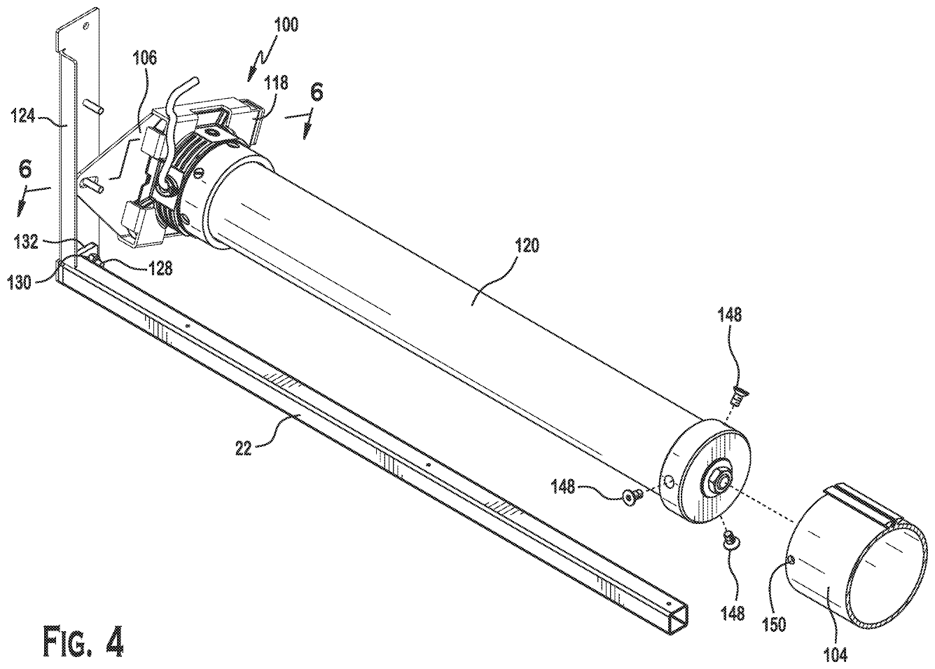

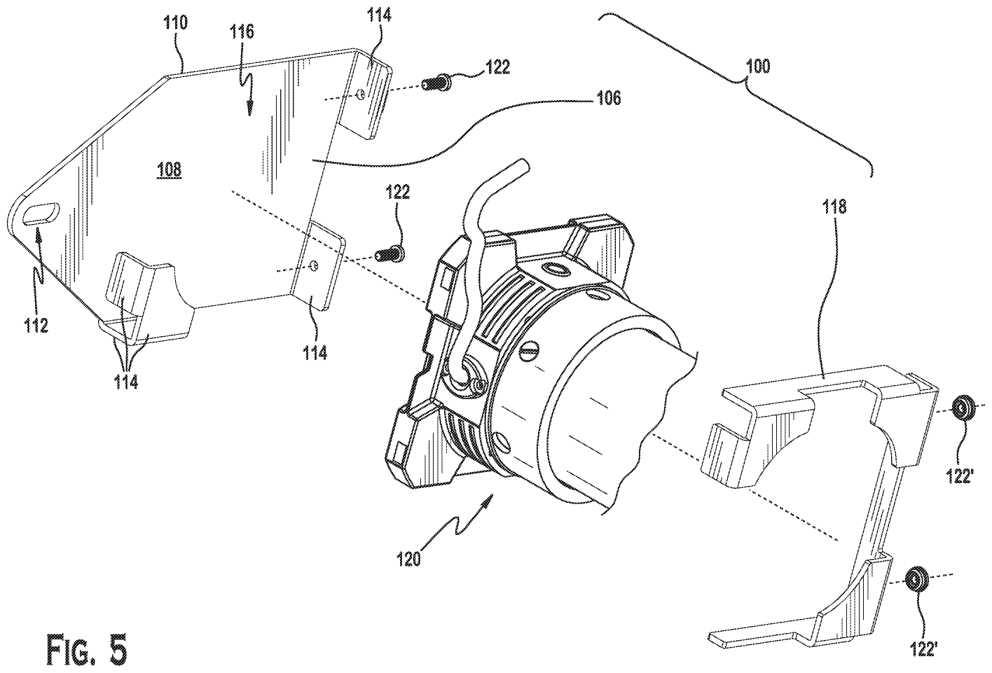

Referring to FIG. 4 and FIG. 5, the proximal anti-rotation arm 100 may include a plate 106. The plate 106 may include a motor mounting side surface 108, an outer surface 110, and a frame securement opening 112. The frame securement opening 112 may extend from the motor mounting side surface 108 to the outer surface 110. The frame securement opening 112 may be elongated along a longitudinal axis. The longitudinal axis may be a line of symmetry for the plate. Although the plate may possess reflectional symmetry, the plate may be asymmetric. Generally, the plate 106 may further include a plurality of tabs 114 that define an enclosure 116 for slidably receiving and holding one end of a tube motor 120. Moreover, the proximal anti-rotation arm 100 further may include a cage 118. The cage 118 may be a bracket which interlocks with the plate 106 to securely enclose and hold a tube motor 120. Referring to FIG. 5 and FIG. 6, the cage 118 further may be fixed to the plate 106 with a fastener system 122, 122′. For example, the cage 118 may be screwed, wired shut, riveted, or welded to the plate 106. Also, the plate 106 and the cage 118 may form a press fitting.

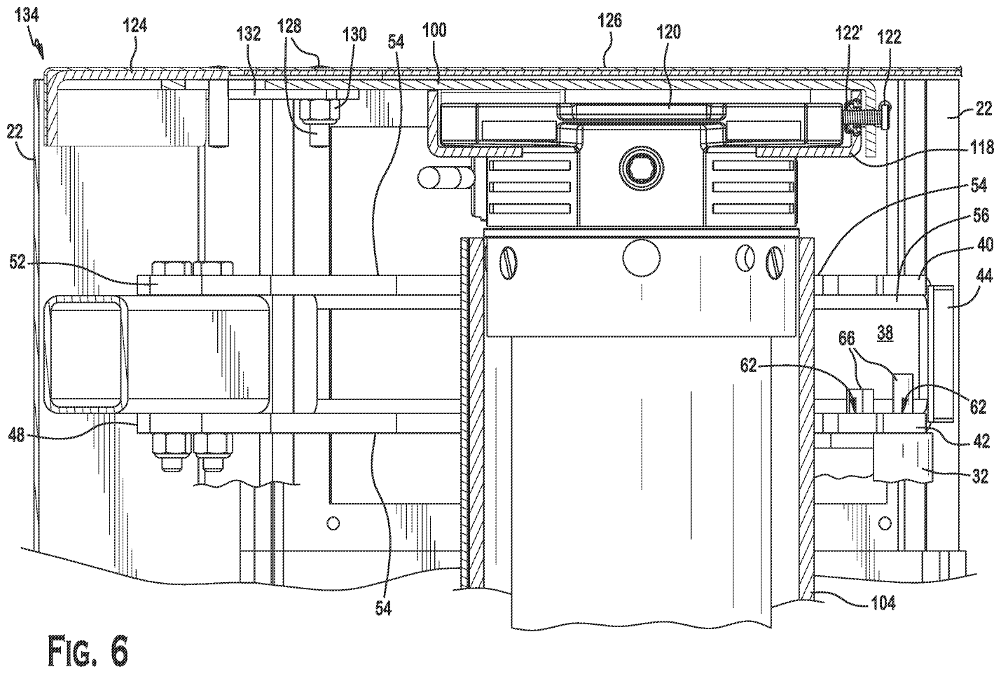

Referring to FIG. 6 and FIG. 7, the frame securement opening 112 of the plate 106 may be secured to a structural member 124 which in turn may be connected to the motor frame 22. As shown in FIG. 6, a proximal end wall 126 may be secured to the structural member 124. Additionally, as shown in FIG. 4, a bolt 128 and a nut 130 may be used to secure the structural member 124 to an end flange 132 on the motor frame. Referring to FIG. 6, the proximal end wall 126, structural member 124, and proximal anti-rotation arm 100 may form part of a proximal end cap 134 for the frame 20. As may be appreciated from FIG. 6 and FIG. 7, the proximal end cap 134 may enclose the proximal end of the motor frame 22 and may include a structural member 124 and anti-rotation arm 106 for each tube assembly 104.

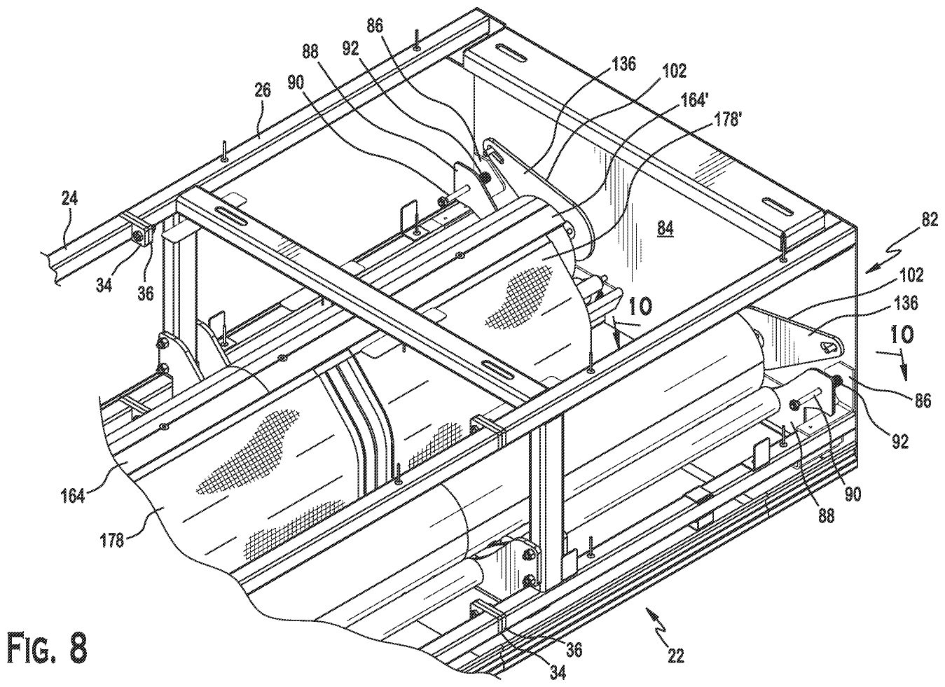

Referring to FIG. 8 and FIG. 9, the end cap 82 further may include a distal anti-rotation arm 136 102. As shown in FIG. 9, the distal anti-rotation arm 102 may include a plate 138 with an elongated slot 140, an axle 142 secured to the plate, and an idler 144 spaced from the plate. The distal anti-rotation arm 102 may be secured to the end wall 84 by a fastener 146 arranged through the slot 140. As shown in FIG. 9 and FIG. 10, the idler 144 may be configured and dimension to be received in the distal end of the tube assembly 104. The idler 144 and tube assembly 104 may include a plurality of corresponding fastener receiving holes 148. The idler 144 and tube assembly 104 may be secured by a plurality of fasteners 150 advanced in the respective corresponding receiving holes 148.

Referring to FIG. 3 and FIG. 4, the modular wall system 10 may include a tube motor 120 and a tube assembly 104. For instance, the tube motor 120 may be a 280 newton-meter (nm) or 300 nm electric tube motor manufactured by Somfy (Somfy Activities SA, 50 avenue du Nouveau Monde 74300 Cluses France) or MaestroShield (MaestroShield 2141 Flint Dr., Fort Myers, Florida 33916 USA), respectively. For instance, the tube motor(s) may be a Somfy T8S DMI 280 adjustable tube motor.

As shown in FIG. 4, the tube motor 120 may be received within one end of the tube assembly 104. The tube assembly 104 may be screwed to the tube motor 120. Referring to FIG. 3, the tube assembly 104 may be formed from a plurality of tubular segments 152. The tube assembly 104 may include a modular tubular segment 152 that is dimensioned for use with the motor frame 22 or the center frame 24. The modular tubular segment 152 may have an inner diameter of approximately 4.0 inches and a length of approximately 78 inches. The modular tubular segments 152 may be secured together by a coupling element. The coupling element may be a hollow circular cylindrical member that includes a slot which extends from one end of the coupling member to the other end. A pair of fastener-receiving holes may be situated near each end of the coupling tube. Referring to FIG. 9 and FIG. 10, the distal end of the tube assembly 104 may receive an idler 144 from a distal anti-rotation arm 102.

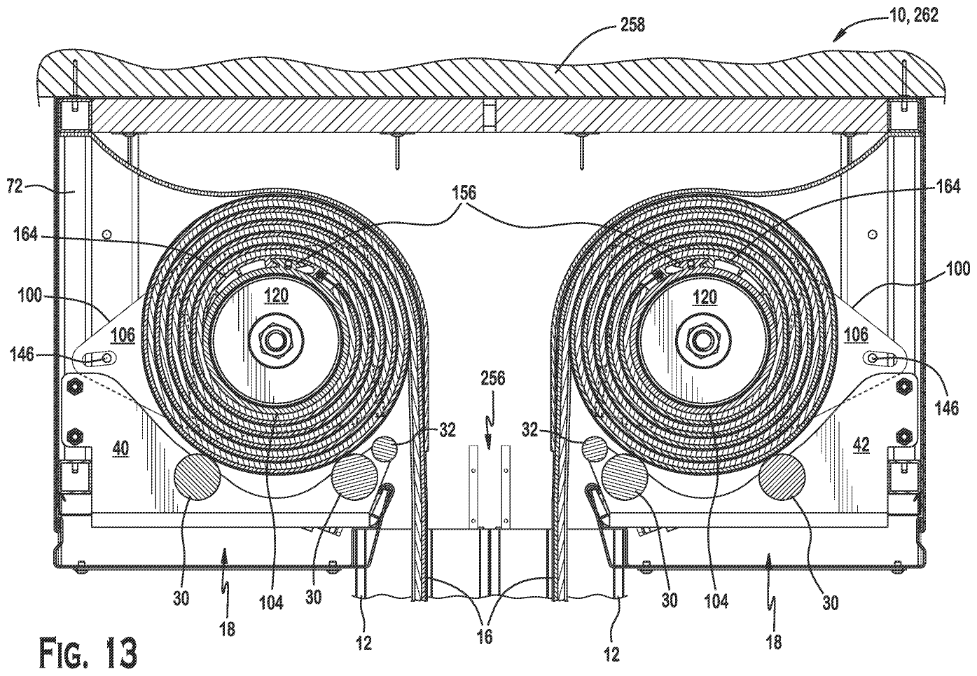

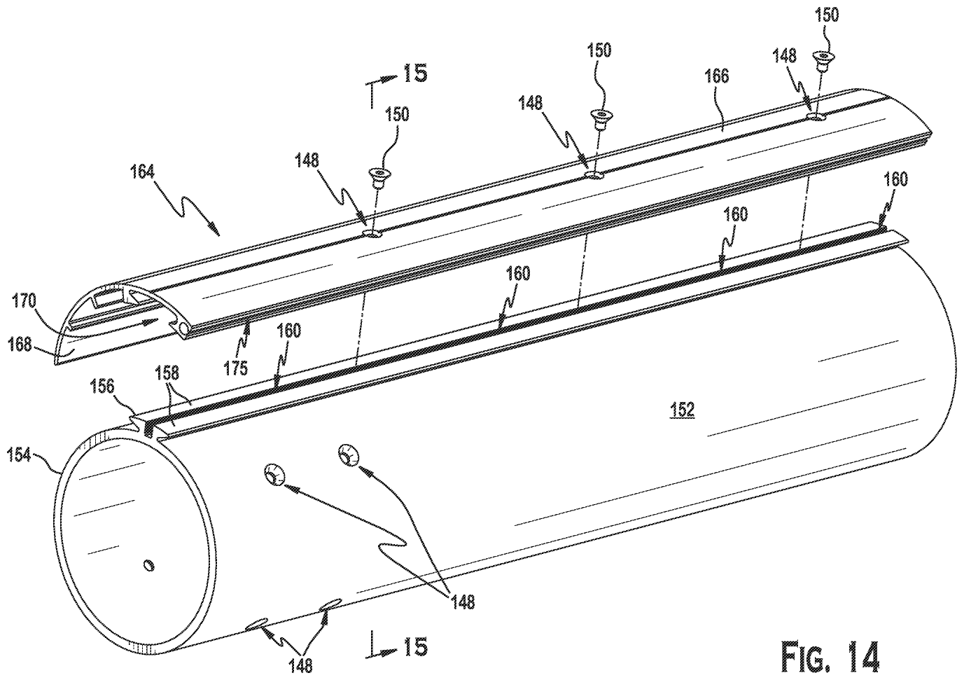

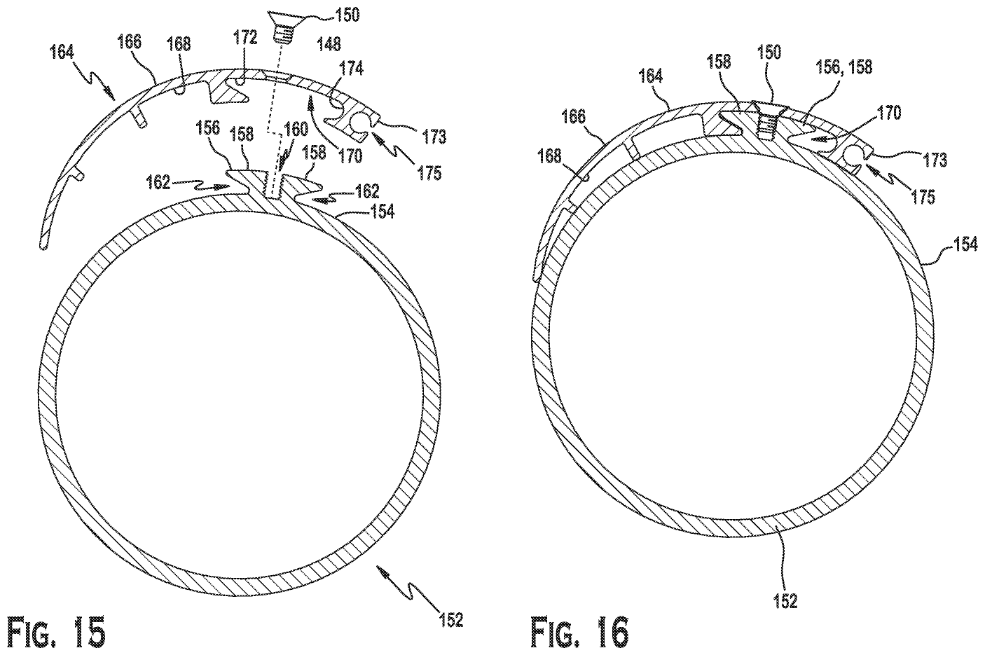

Referring to FIG. 14 and FIG. 15, although the modular tubular segment 152 may be a hollow circular cylindrical member, in a preferred embodiment the modular tubular segment 152 may have a non-circular outer profile 154. More particularly, the outer profile 154 may be circular with a cleat 156. The cleat 156 may include two wedges 158. The modular tubular segments 152 may be secured together by a coupling element. The coupling element may be a hollow circular cylindrical member that includes a slot which extends from one end of the coupling member to the other end. A pair of fastener-receiving holes may be situated near each end of the coupling member. Referring to FIG. 15, the modular tubular segment 152 may include a threaded groove 160 between the wedges 158. Additionally, the wedges 158 may each define an inferior wedge-shaped cavity 162 with the outer circular profile 154 of the modular tubular segment 152. Moreover, the modular tubular segment 152 may be configured and dimensioned to interlock with a hook segment 164.

Referring to FIG. 14 and FIG. 15, the hook segment 164 may be curved metal strip. The superior surface 166 of the hook segment 164 may be rounded and include one or more fastener receiving holes 148. The inferior surface 168 of the hook segment may also be curved. The inferior surface 168 may include a cleat shaped groove 170. The cleat shaped groove 170 may be configured and dimensioned to mate with the cleat 156 on the outer profile 154 of the modular tubular segment 152.

Referring to FIG. 15 and FIG. 16, the cleat shaped groove 170 may include a wedge-shaped portion 172 that is configured and dimensioned to mate with the cleat 156 and a rounded portion 174 that is configured and dimensioned to allow arrangement of the cleat 156 in the cleat shaped groove 170. The cleat shaped groove 170 may be dimensioned to allow the cleat 156 to slide into the wedge-shaped portion 172, thereby interlocking the hook segment 164 and the modular tubular segment 152. Additionally, one or more fastener holes 148 in the hook segment 164 may be positioned over the threaded slot 160. A screw 150 may be arranged through one of the fastener-receiving holes 148 and advanced into the threaded slot 160 to fix the hook segment 164 to the modular tubular segment 152.

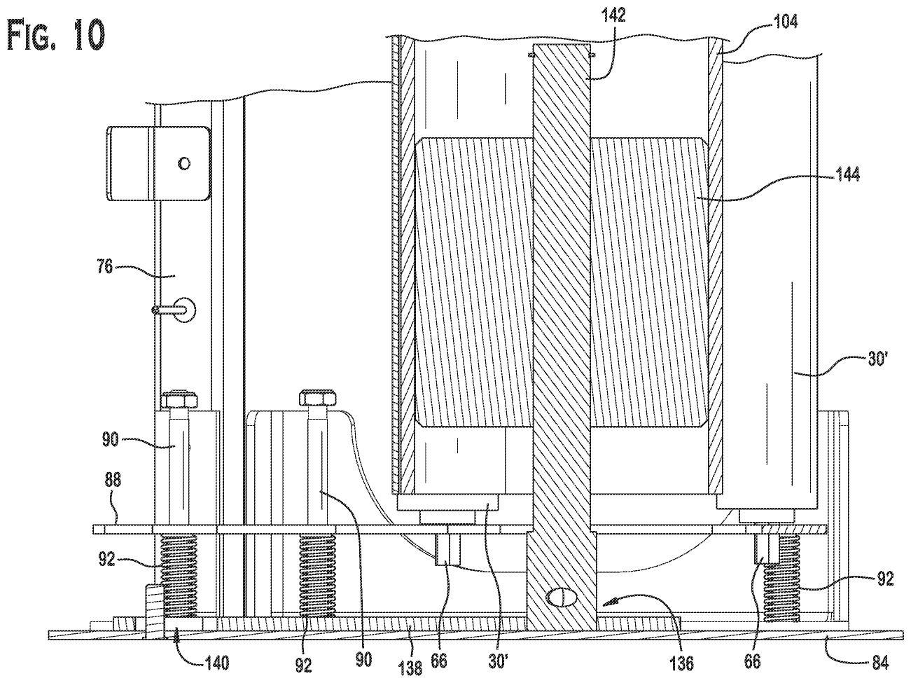

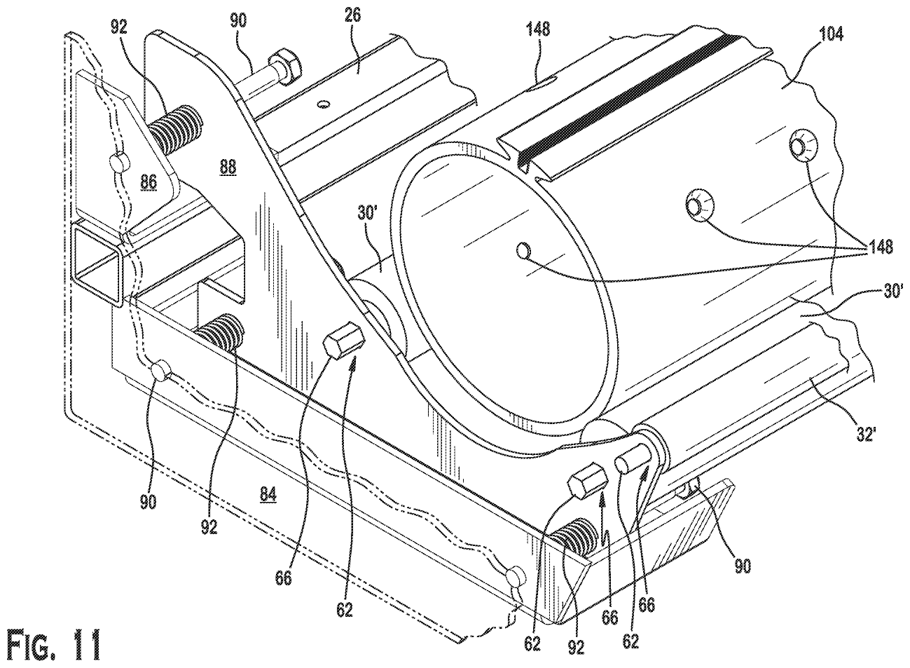

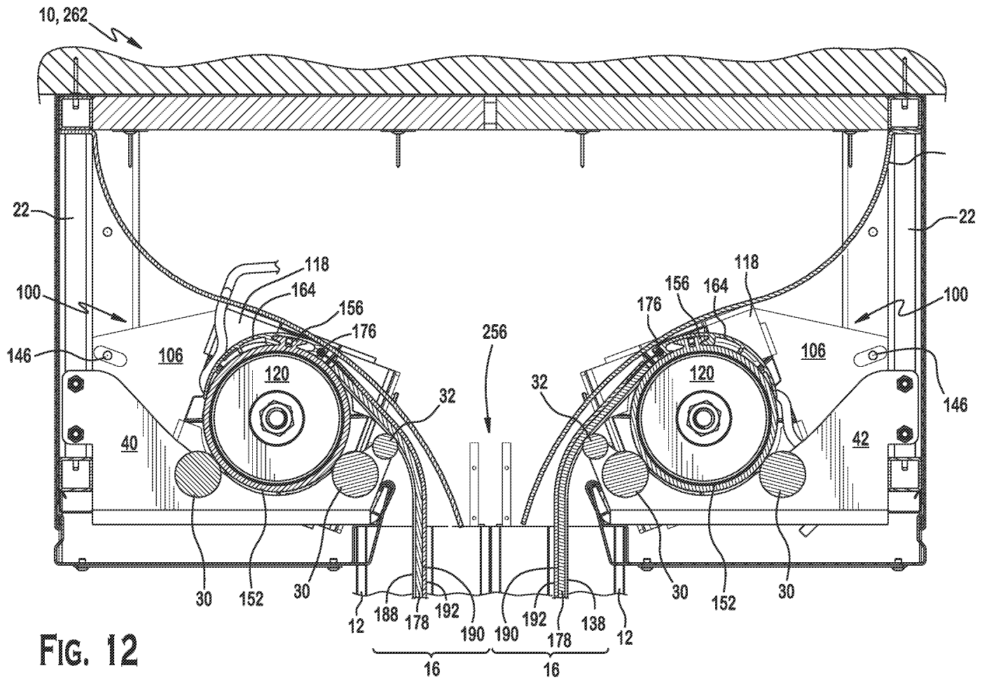

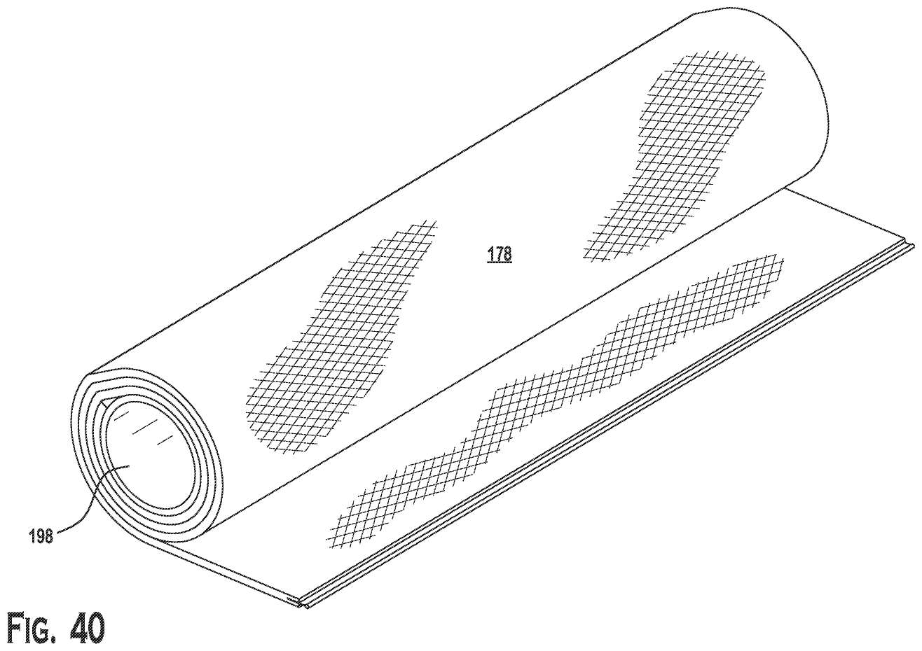

Further, the hook segment 164 may include an edge 173 adjacent the cleat shaped groove 170. The edge 173 may include a crevice 175. The crevice 175 may include a neck portion adjacent the edge and an interior anchor portion. Referring to FIG. 41, the crevice 174 may be configured and dimensioned to receive and securely hold a keder 176 edge of a fabric panel 178. For instance, referring to FIG. 12, a top edge of a fabric panel 178 may include a keder 176, and the keder 176 may interlock with the crevice 174 to securely connect the fabric panel 178 to the hook segment 164.

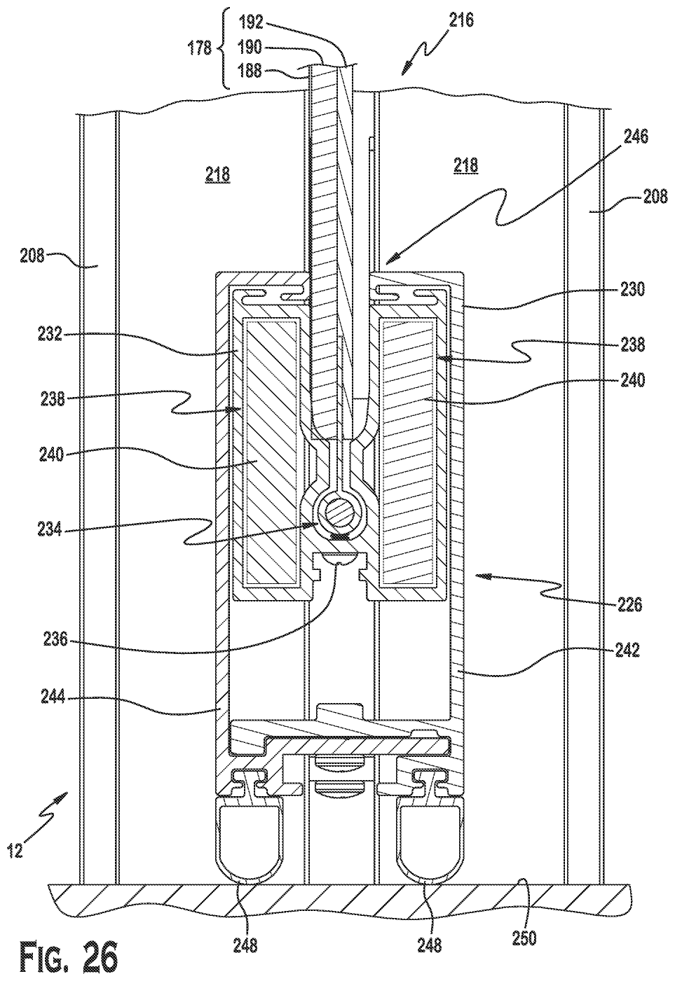

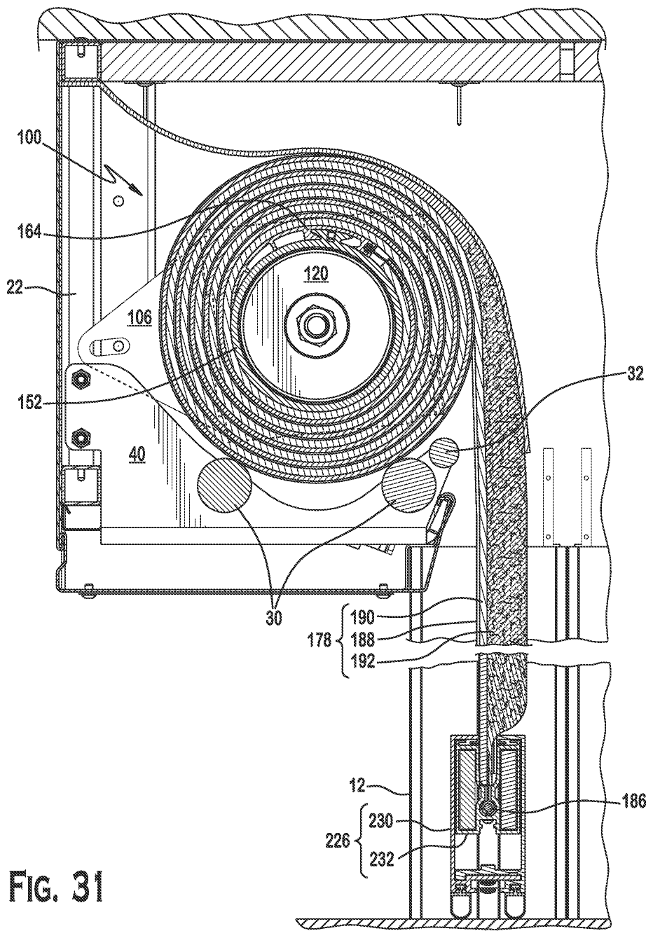

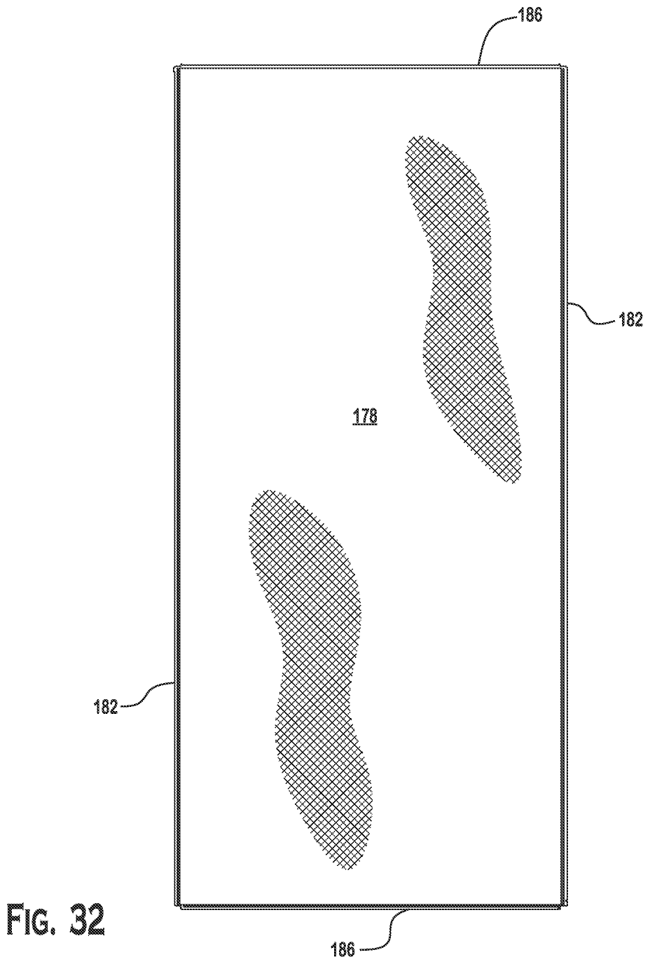

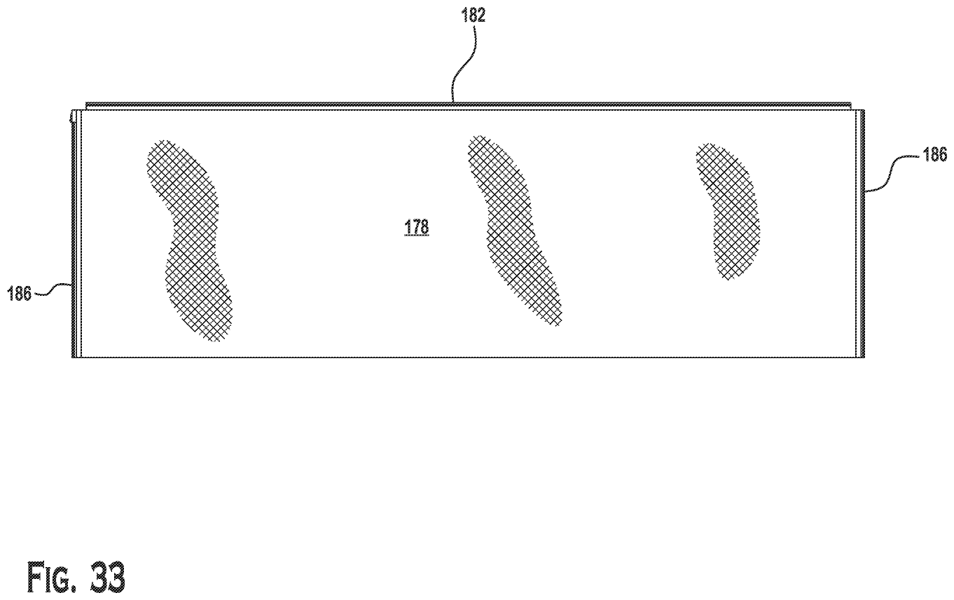

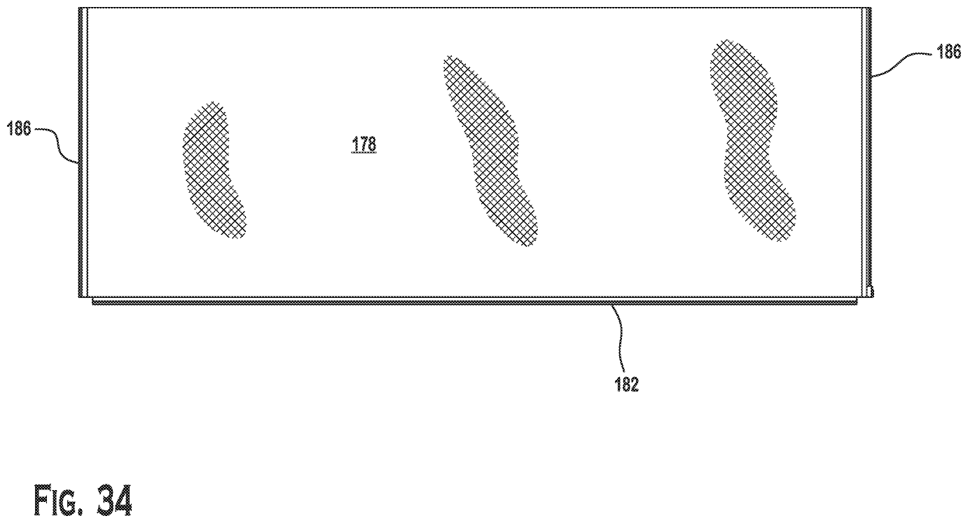

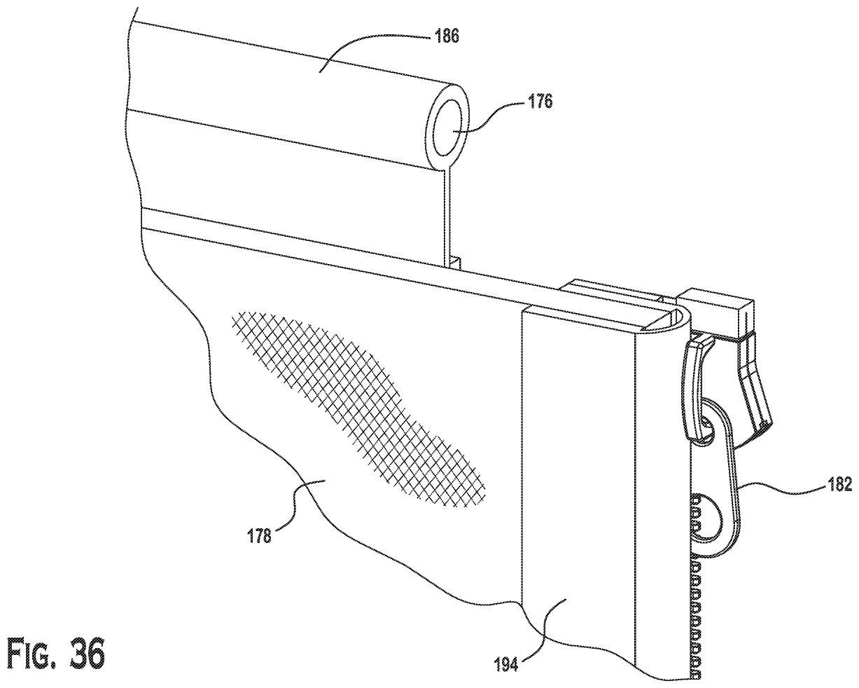

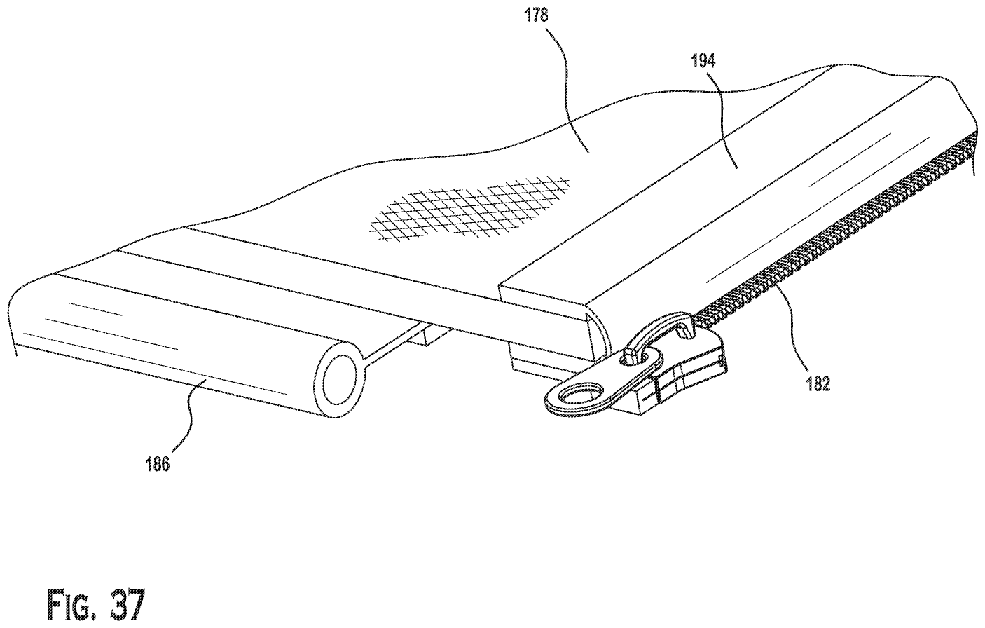

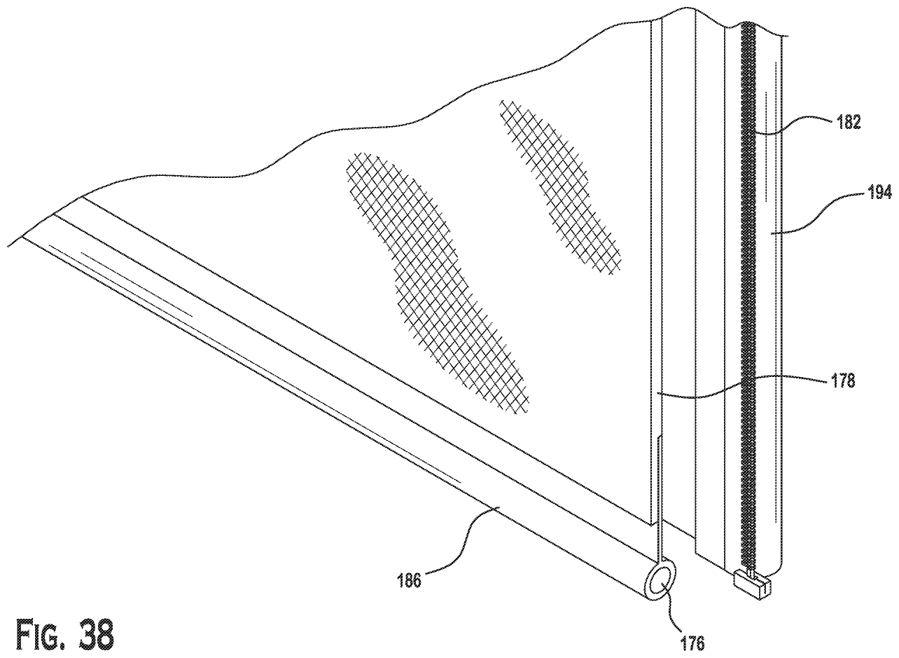

Referring to FIG. 1 and FIG. 30, the screen (or flexible barrier material) 16 of the modular wall system 10 may be formed from one or more segments. The one or more segments may be fabric panels 178. For example, the screen 16 may be formed from five fabric panels 178. The fabric panels 178 may be fastened together using mechanical fasteners. For example, two panels 178 may be joined together by a zipper chain 180, as the lateral edges of each panel 178 may include a zipper ribbon 182. The zipper ribbon may include zipper teeth 184. See e.g., FIGS. 31-39. Although, in a preferred embodiment the zipper ribbon may be a Size 5 zipper, other sizes of zippers or fastening systems may be used to connect the fabric panels provided that a stable and secure connection is formed. Additionally, the upper and lower edges of the fabric panel 178 may include a fastening structure 186. The fastening structure 186 may be used to connect the fabric panel 178 to a hook segment 164 and a lateral base track 226, respectively. See e.g., FIGS. 25, 26, 28, and 31. Referring to FIG. 36, preferably, the fastening structure 186 may be a keder 176. Although, the fastening structure 186 may be a keder 176, a zipper or similar device may be used to connect the fabric panel 178 to a hook segment 164 or a lateral base track 226. See e.g., FIG. 31. Referring to FIGS. 32-34, the fastening structure 186 attached to the upper edge of the fabric panel 178 may include a 3 mm keder 176 (FIGS. 36-37), and the fastening structure 186 attached to the lower edge of the fabric panel 178 may include an 8.5 mm keder 176 (FIG. 38). Referring to FIG. 1, the fabric panels 178 may be fabricated in a standard size. For instance, a standard size fabric panel 178 may measure approximately 48 inches wide by 72 inches tall. Fabric panels 178′ having other dimensions may be constructed to size.

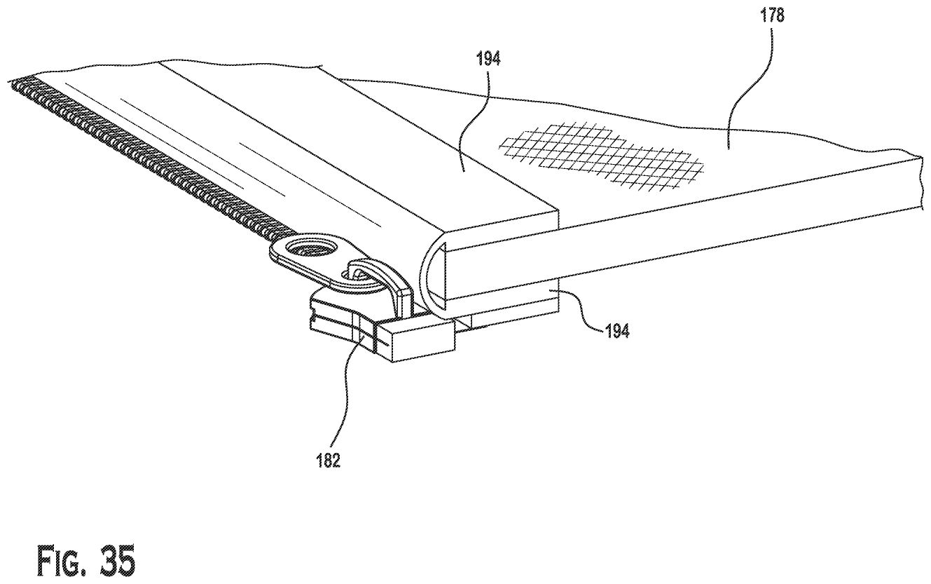

Referring to FIG. 12 and FIG. 31, each fabric panel 178 may include a decorative material layer 188, a mass loaded vinyl core 190, and a felt backing layer 192. Preferably, the decorative layer 188 and the mass loaded vinyl core 190 may be laminated together to form a unitary fabric. Referring to FIGS. 35-37 and 39, the side edges of the unitary fabric may include a strip 194 of decorative material that is welded to the front side and rear side of the unitary fabric to enclose the cut sides of the unitary fabric. The welded strip of decorative material 194 may be referred to as a binder.

Referring to FIG. 31, the decorative material layer 188 may provide an aesthetic visual appearance and texture, as well as structural reinforcement for the unitary fabric. Also, the decorative material layer 188 may provide enhanced stain resistance and be easy to clean. For instance, the decorative material layer 188 may be a screen material with 1-percent or less open area. Suitable fabrics that may be used for the decorative material layer may include Nano 97™ manufactured by Twitchel Technical Products, LLC (Dothan, AL), Mini Basketweave™ sold by Chilewich (Chatsworth GA), and Sheerweave® Style 5000 manufactured by Phifer Incorporated (Tuscaloosa, AL).

The core 190 may be formed from rolls of reinforced mass loaded vinyl. Generally, the rolls of reinforced mass loaded vinyl may have density from about 0.5 to 2.5 lbs./sf. and may include metal shavings or other inert materials and additives to add mass and enhance sound blocking characteristics of the material. Preferably, the core 190 may be formed from a roll of flexible reinforced mass loaded vinyl having a density of 1 lb./sf. For example, the roll of reinforced mass loaded vinyl may be 1.0 lb./sf a XTRM PLY SoundSafe™ material manufactured by E Squared Technical Textiles (Hillside, NJ). Physical and acoustic properties of an exemplary reinforced mass loaded vinyl material are provided in Table 1 (below).

TABLE 1
Exemplary Product Specification for 1
lbs/SF Mass Loaded Vinyl Material (a)

| | | | Typical |
|---|---|---|---|
| Physical Property | Units | Test Method | Value |
| Thickness | mm | ASTM D751 | 2.79 |
| Weight | g/m2 | ASTM D751 | 4882 |
| Tear Strength | N | ASTM D751-B | 133 (MD), |
| | | | 200 (TD) |
| Breaking Strength | N | ASTM D751-A | 1334 (MD), |
| | | | 1334 (TD) |
| Adhesion-Ply | N/25 mm | ASTM D751 | 35 |
| Dimensional Stability (Max) | % | ASTM D1204 | 3.0% |
| Flame Resistance | | NFPA-701 | Pass |
| Specific Gravity | g/cc | ASTM D 792 | 1.6 |
| Sound Transmission Loss | Shore A | ASTM E 90-09 | 41 |
| (STC) | | | |
| Maximum Static Use | Degrees F. | | 170 |
| Temperature | | | |
| Minimum Static Use | Degrees F. | | −29 |
| Temperature | | | |

Notes:
(a) E Squared Tech. Textiles (Hillside, NJ), Product #7102-110xx - EPT XTRM PLY SB 1 lbs/SF

Generally, the core 190 may be formed, in part, from two layers of reinforced mass loaded vinyl. More particularly, the fabric panel 178 may be a lamination formed from a decorative material layer 188, a core 190 formed from a 1 lb./sf reinforced mass loaded vinyl layer, a scrim, and another 1 lb./sf reinforced mass load vinyl layer. Other thicknesses of reinforced mass loaded vinyl, however, may be used for the core 190 of the fabric panel, as may be appropriate for a particular application. For instance, without limitation, the core 190 may formed from two layers of reinforced mass loaded vinyl where each layer has a density of about 0.3 lb./sf, 0.5 lbs./sf, or 1.25 lbs./sf.

The felt backing layer 192 may be a felt material formed from natural or synthetic non-woven fibers. The felt backing layer 192 may be secured to the lamination formed from the decorative material layer 188 and the core 190 on the side opposite the decorative material layer 188. For example, an adhesive material may be uniformly applied to the exposed surface of the reinforced mass loaded vinyl layer to bond with a felt backing layer 192. One suitable adhesive for bonding the mass loaded vinyl and felt fabric is a water-based adhesive having product code WZ-0866 manufactured by Worthen Industries, 3 E. Spit Brook Road, Nashua, NH 03060. The adhesive may be a milky white liquid having a specific gravity of 1.0304.

Generally, the felt backing layer 192 may range in thickness from approximately 1 mm to 3 mm for an 18-ounce or 21-ounce nonwoven polyester material. Alternatively, the felt backing layer may range in thickness from approximately 6 mm to 10 mm for non-woven polyester material product numbers TN8724™, TN8740™ or TN 8747™ manufactured by Precision Textiles (Pembroke, ON). Moreover, the felt backing 192 may be formed from an outer layer of the foregoing nonwoven polyester materials and an inner layer of expansive felt or nonwoven polyester material. These materials may be laminated. A felt backing layer 192 formed from an outer layer of regular felt or nonwoven polyester and an inner layer of expansive felt or “fluffy.” nonwoven polyester material may possess a thickness of approximately 3 mm to 4 mm in a compressed state and a thickness of approximately 1 inch or greater in an uncompressed state. Accordingly, as depicted in FIG. 30 and FIG. 31 a felt backing layer 192 formed from an outer layer of regular felt or nonwoven polyester and an inner layer of expansive felt or nonwoven polyester material may expand in thickness from approximately 3 mm to 4 mm while the flexible barrier material is wrapped around the tube to a thickness of approximately 1 inch when the flexible barrier material is unwound from the tube assembly. Table 2 (below) summarizes exemplary flexible barrier material construction alternatives.

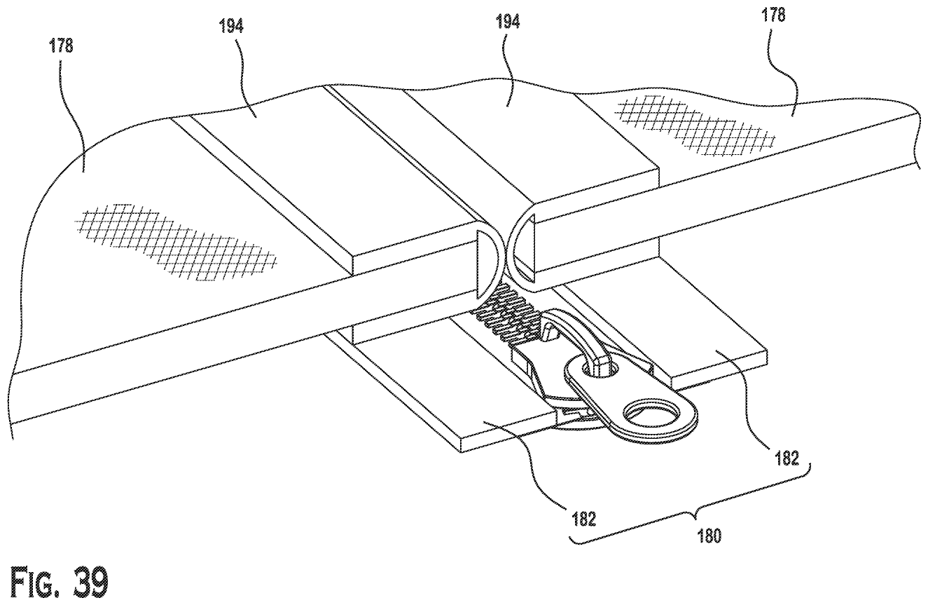

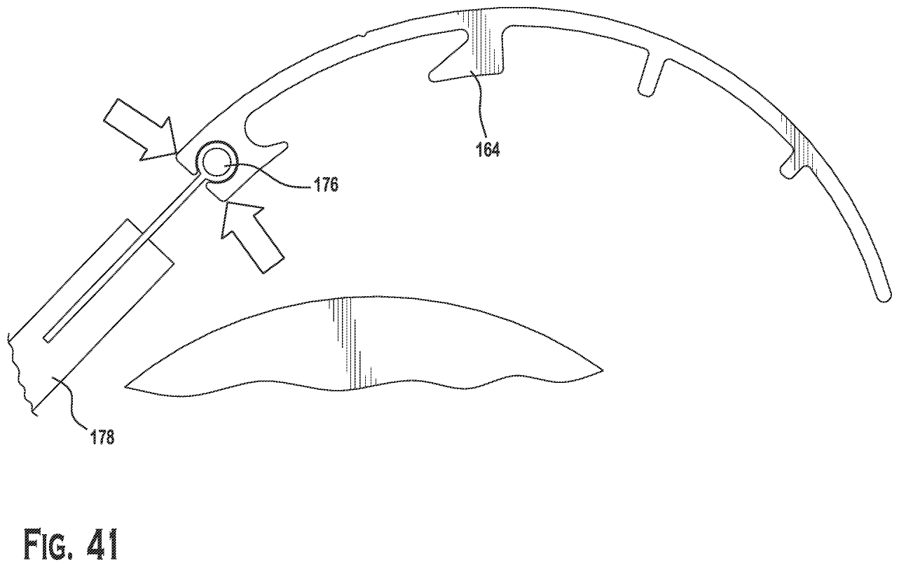

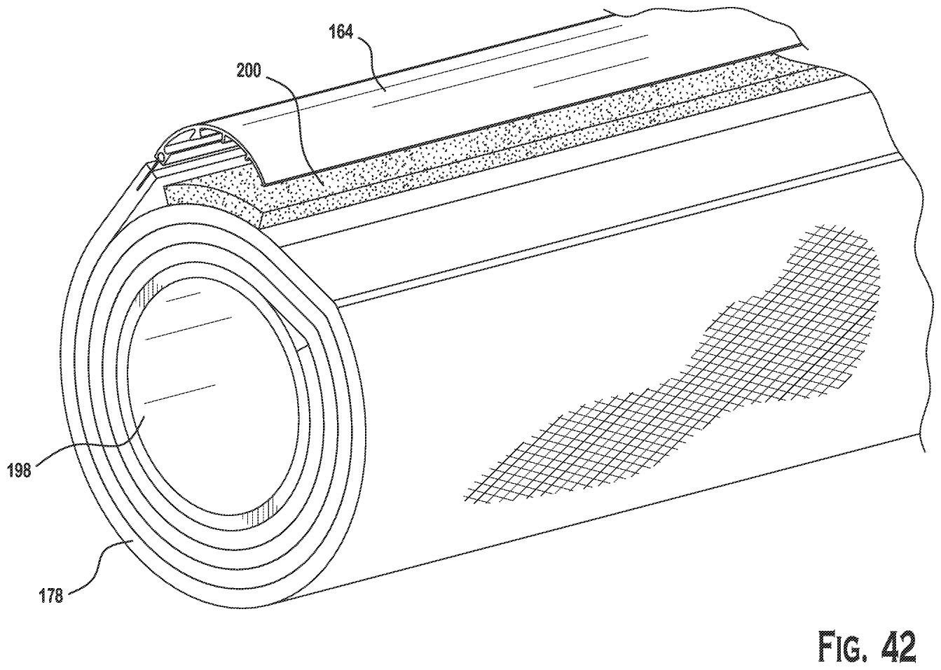

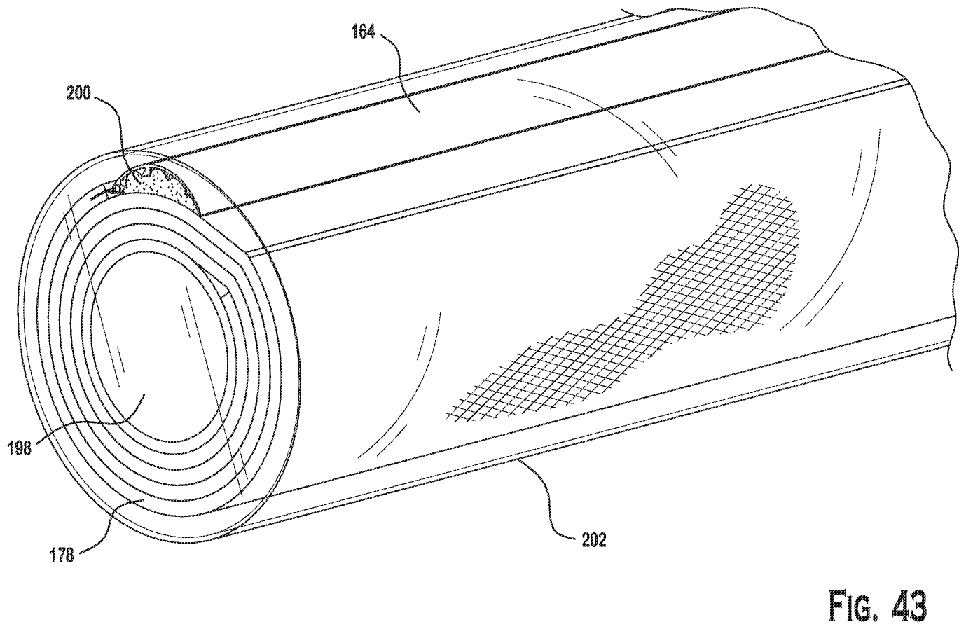

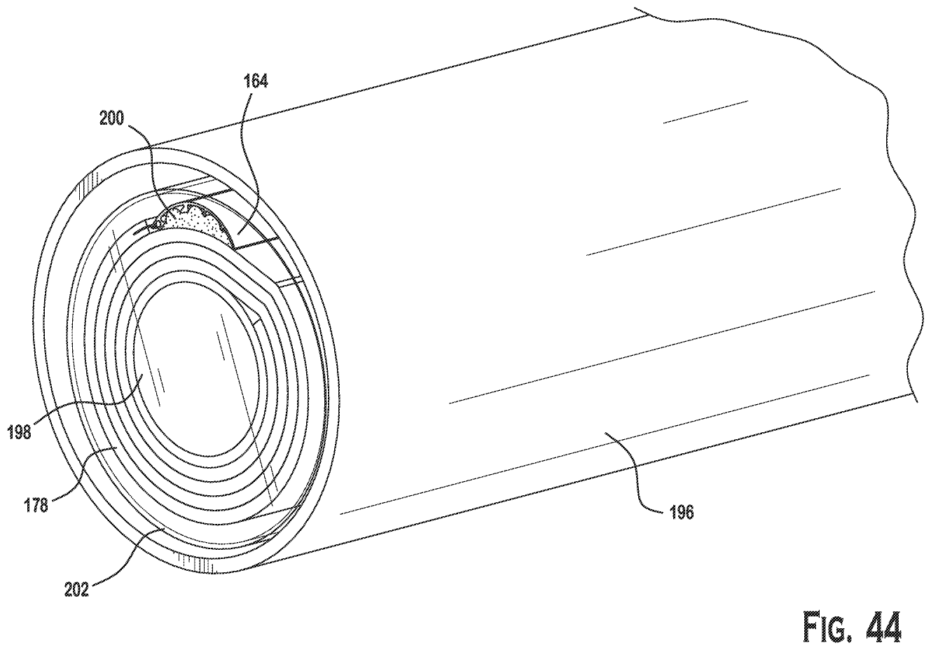

As illustrated in FIGS. 44, a fabric panel 178 may be packaged for transport in a packaging or shipping tube 196, along with an associated hook segment 164. For example, the exemplary panel 178 may be wound about a roll or tube 198 (FIG. 40), connected to a hook segment 164 (FIG. 41), protected with a foam packaging 200 arranged beneath the hook segment 164 (FIG. 42), and covered in a protective sleeve or wrapping material 202 (FIG. 43), before being inserted into the packaging tube 196 (FIG. 44) and sealed with caps 204 (FIG. 45). Alternatively, the hook segment 164 may be wrapped with protective material and stored inside the roll or tube 198. As depicted in FIG. 46, a screen or flexible membrane barrier 16 may be formed from a plurality of fabric panels 178. Each fabric panel 178 may be packaged for transport in a sealed shipping tube 205.

TABLE 2
Exemplary Fabric Panel Configurations

| Layer Type | 6-layer | 5-layer | 4-layer | 3-layer | 2-layer |
|---|---|---|---|---|---|
| Decorative | X | X | X | X | X |
| RMLV (a) | X | X | X | X | X |
| Scrim | X | X | X | X | — |
| RMLV | X | X | — | — | — |
| ENWPET (b) | X | — | — | — | — |
| NWPET (c) | X | X | X | — | — |

Notes:
(a) RMLV = Reinforced Mass Loaded Vinyl
(b) ENWPET = Expansive Non-Woven Polyester (Fluffy felt)
(c) NWPET = Non-Woven Polyester (Felt)
(d) X = indicates present in flexible material barrier configuration

Generally, a fabric panel 178 may be constructed by rolling a sheet of felt out on a flat surface. A sheet of mass loaded vinyl may then be placed over the felt. The mass loaded vinyl material may be positioned such that the felt extends beyond the limits of the mass loaded vinyl sheet. An adhesive material may be uniformly applied to the contact surface of the mass loaded vinyl sheet. One suitable adhesive for bonding the mass loaded vinyl and felt fabric is a water based adhesive having product code WZ-0866 manufactured by Worthen Industries, 3 E. Spit Brook Road, Nashua, NH 03060. The adhesive may be a milky white liquid having a specific gravity of 1.0304.

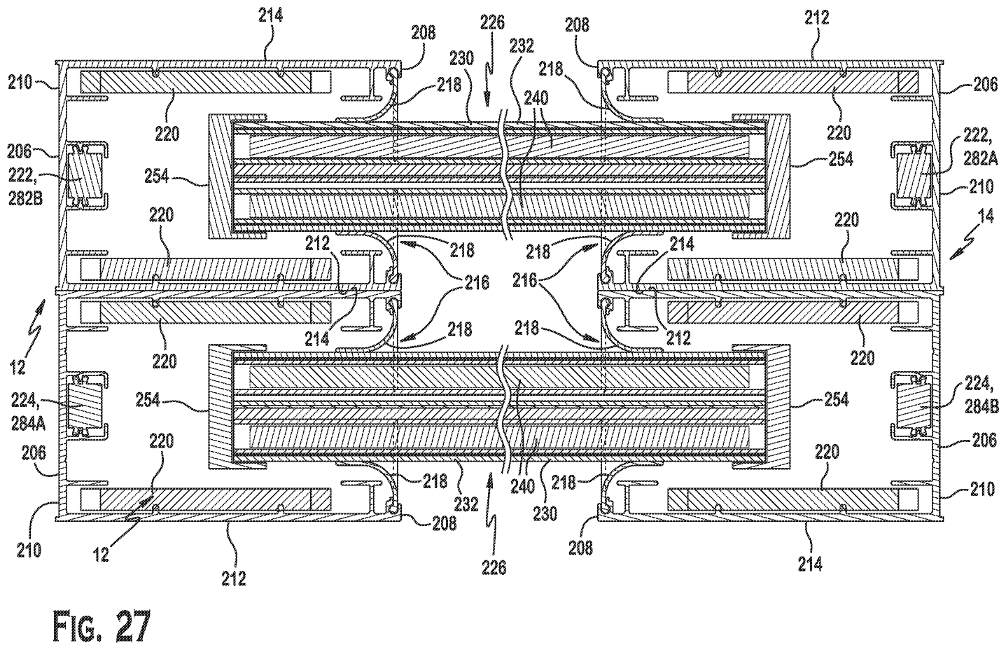

As shown in FIG. 1 and FIG. 27, the modular wall system 10 may include a first vertical post 12 and a second vertical post 14. Referring to FIG. 27, the first and second vertical posts 12, 14 may be constructed from vertical tracks 206 having a longitudinal axis and a cross-section perpendicular to the longitudinal axis. For example, the cross-section of the vertical track 206 may include a front side 208, a rear side 210, a port side 212, and a starboard side 214. The front side 208 of the cross-section of the vertical track 206 may include a slot 216. The slot 216 may extend from the top of the vertical track 206 to the bottom of the vertical track 206. The slot 216 generally may have a width. The width of the slot may be substantially constant. Also, the vertical track 206 may include a resilient flap 218 adjacent to each side of the slot 216. The resilient flap 218 may be secured to the vertical track 206 by a keder. Alternatively, the resilient flap 218 may be secured to the vertical track with another fastening system. For instance, the other fastening system may include one or more screws or rivets. The vertical track 206 may be formed from aluminum, carbon steel, other metals or alloys. The vertical track 206 may be cut to length.

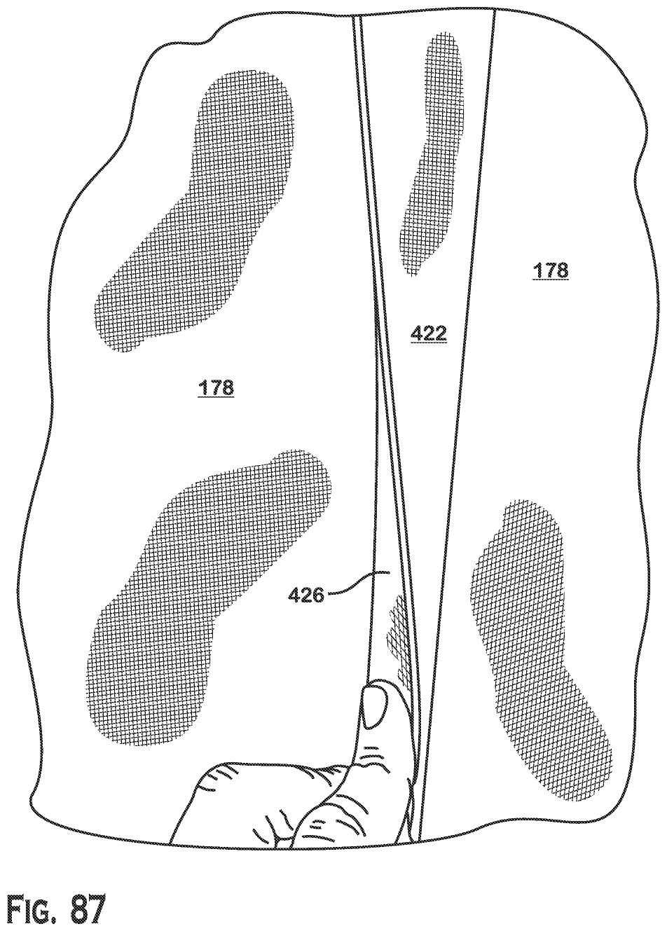

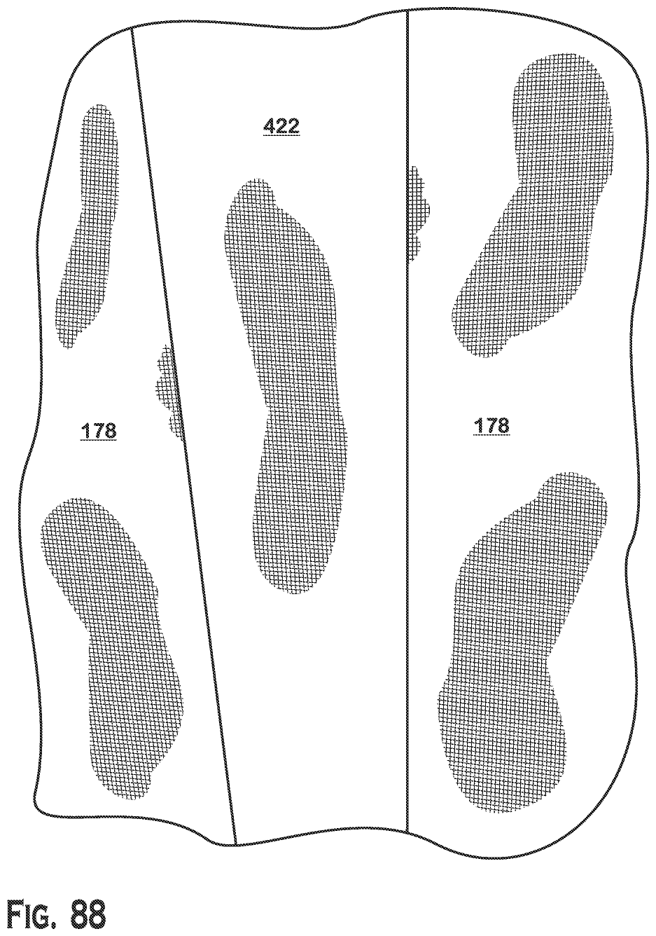

As shown in FIG. 86, a seam 422 may be visible between adjacent fabric panels 178. Referring to FIGS. 87 and 88, a strip 424 of material may be applied vertically over the seam 422 formed between adjacent fabric panels. The strip 424 of material may be treated on one side with an adhesive. As shown in FIG. 87, the strip 424 may be positioned and secured over a seam 422 between two adjacent fabric panels 178. Preferably, the strip of material may be decorative material, and the adhesive applied to one side of the strip 422 of material may be a heat sensitive coating. Generally, the heat sensitive adhesive may be activated by applying heat to the opposite side of the decorative strip. For instance, a heat gun may be used to activate the adhesive by applying heat to the decorative strip. Referring to FIG. 87, the strip 422 may then be pressed against the wall panels to form a patch. As shown in FIG. 88, the adhesive applied to the decorative strip may bond the decorative strip to the adjacent wall panels to cover the seam. Further, the decorative strip may be removed by applying hot air to the patch to deactivate the adhesive, and thus allow the patch to be removed from the adjacent wall panels by gently pulling the decorative strip away from the wall.

The first and second vertical posts 12, 14 further may include interior panels 220 of sound absorbing material. Additionally, each vertical track 206 may include a wall position sensor 222 (e.g., a self-contained light curtain receiver) or emitter 224 (e.g., a self-contained light curtain receiver). The sensor 222 and emitter 224 may be incorporated into a control system which detects the presence of an object between the vertical tracks 12, 14 as the flexible material barrier 16 is being lowered. For instance, the control system may stop deployment of the flexible material barrier 16 when the control system detects the presence of an object under the flexible material barrier 16. Further, the control system may raise the flexible barrier material 16 or require that the flexible barrier material 16 be fully retracted before allowing re-deployment.

Referring to FIGS. 25-27, the modular wall system 10 may include a lateral base track 226. The lateral base track 226 may retain the inferior edge of the flexible barrier material 16 and form a lower boundary of the roll-up wall. The lateral base track 226 may include an exterior track 230 and one or more interior track segments 232.

Referring to FIGS. 25 and 26, the interior track 232 may include a receptacle 234 for securely capturing the bottom keder 186 of an associated fabric panel 178. Further, a screw 236 may be advanced though a wall of the receptacle 234 and into the keder 186 to fix the keder in the receptacle. The interior track segment 232 further may include a pair of channels 238 adjacent to the receptacle. Each of the channels 238 may hold a weight bar 240. The weight bar 240 may be a steel bar. For example, the steel bar may weigh approximately three-quarter pounds per square foot.

The exterior track 230 may form a housing for the one or more interior track segments 232. The exterior track 230 may be formed by two interlocking pieces 242, 244. For instance, a rear half-piece of the exterior track 242 and a front half-piece of the exterior track 244. The two interlocking pieces 242, 244 may cooperate to form a rectangular shaped hollow member with a vertically oriented slot 246. The bottom of the exterior housing further may include two parallel rubber bumpers 248 that may deform to fill or cover irregularities or depressions in the surface 250 under the exterior track 230. Generally, the exterior track 230 may be formed from one segment. However, a plurality of exterior track segments may be secured together to form the exterior track 230. By contrast, abutting interior track segments 232 may remain unsecured, and thus may remain free to move vertically within the exterior track 230. Hence, the lateral base track 226 may be lowered to rest on an unlevel surface without affecting the vertical position of the interior track segments 232 that hold the flexible barrier material 16. Accordingly, the lateral base track 226 may be self-leveling.

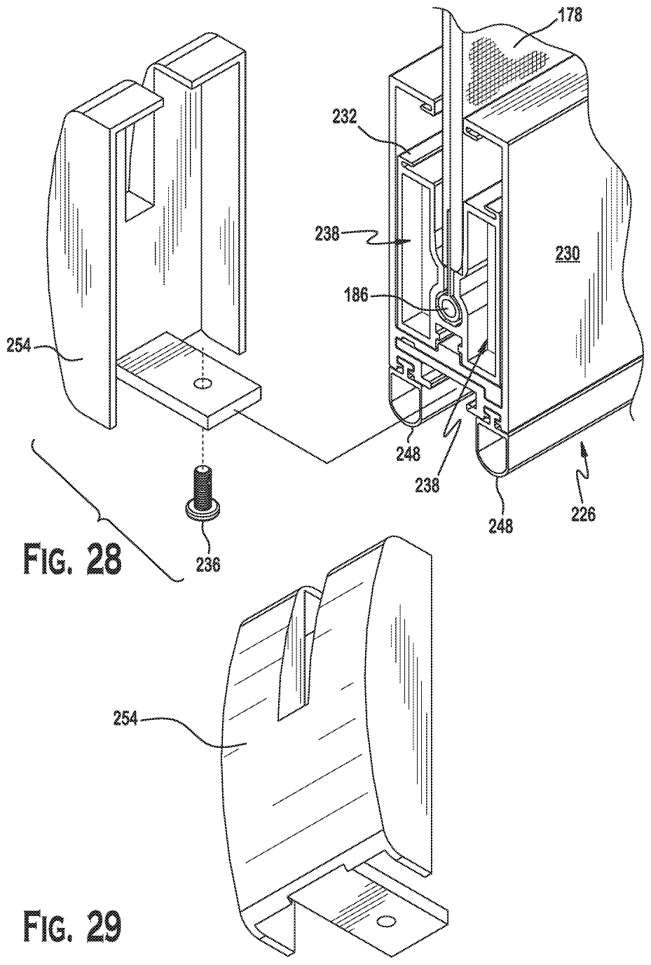

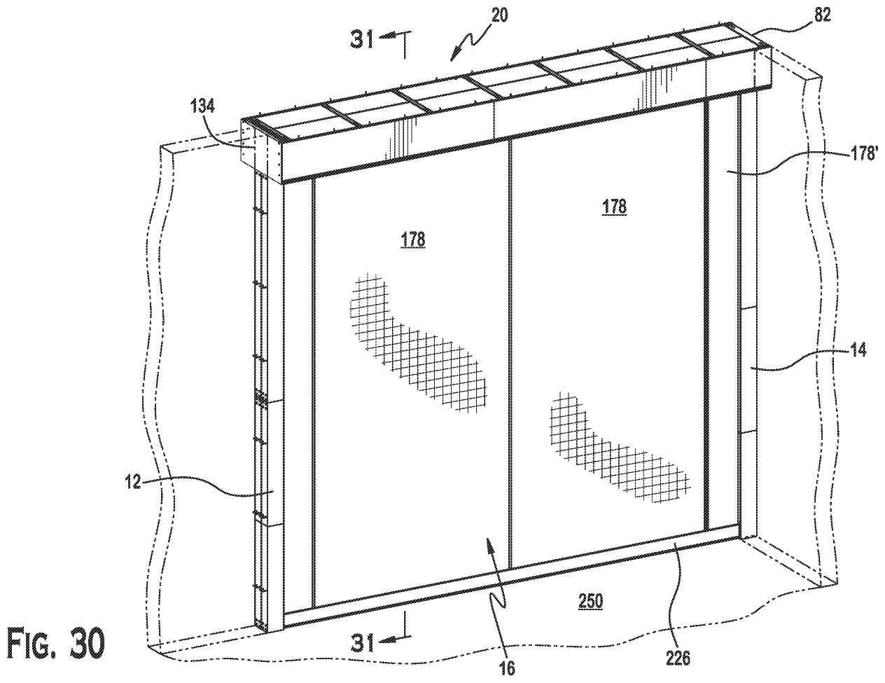

Referring to FIG. 28 and FIG. 29, the lateral base track 226 may further include a rounded end cap 254. The rounded end cap 254 may be formed from a nylon material and may fully cover the open end of the lateral base track. The rounded end cap 254 may protect the lateral base track 226 and facilitate movement of the lateral base track 226 within the associated vertical track 206. The rounded end cap 254 may be fixed to the lateral base track 226 with a screw 236.

Referring to FIG. 13, the screen or flexible barrier material 16 or fabric panel 178 may be wound around the tube assembly 104. The flexible barrier material 16 or fabric panel 178 may rest on the two larger dimeter rollers 30 that are secured to the frame 20. The flexible barrier material 16 or fabric panel 178 may pass through a screen feed gap 256 in the frame 20. As the frame 20 may be secured to the structure 258 above the opening in which modular wall system is to be installed, the modular wall system 10 may span longer distances than may otherwise be feasible because the tube assembly 104 is supported along its length. Referring to FIG. 12, a smaller diameter roller 32 may be positioned to feed and unwind the flexible barrier material 16 or fabric panel 178 from the tube assembly 104. Referring to FIG. 12 and FIG. 13, a plate or (anti-rotation arm) 100 may secure the tube assembly 104 to the frame 20. Moreover, the anti-rotation arm 100 may hold one end of the tube motor 120. During operation of the tube motor 120, the anti-rotation arm 100 may move about the fastener 146 which secures the anti-rotation arm 102 to the frame 20. Movement of the anti-rotation arm 100 may include rotational or translational movement of the anti-rotation arm with respect to the fastener 146.

Referring to FIG. 12 and FIG. 27, the modular wall system 10 may be configured as a double wall system 262. In a double wall construction, the vertical side posts 12, 14 may include abutting vertical tracks 206 (see e.g., FIG. 27). Also, the distance separating the flexible barrier material 16 of one roll-up wall and the flexible barrier material 16 of the second roll up wall 410 may be approximately 4 inches. The acoustical isolation provided by such a double wall construction in which the flexible barrier material panel 16 is formed from a core 190 of 1.5 pound per linear foot reinforced mass loaded vinyl may be rated approximately 46 STC.

For instance, acoustical testing of a partition formed from a double wall construction of flexible barrier material secured to a wood frame was conducted. In one test (Test A-P3024.01A), the partition was formed from one 48″ by 72″ frame constructed with 1½″ thick by 4″ wide wood lumber fastened together with screws. One wall (or flexible barrier material) was screwed to the wood frame on both sides creating a 4″ air space (or air gap). The walls were each approximately two mm thick and formed from ½ lbs/sf “Tudelu Private” MLV panels. In other words, the flexible barrier material walls were each formed from a 2-layer fabric panel 178. The 2-layer fabric panel included a one-half pound per linear foot reinforced mass loaded vinyl.

Referring to Table 3 (below), the acoustical test results and calculations for this partition revealed an STC rating of 23 and an OITC rating of 15. In a second test (Test B-P3024.01B), the partition was formed from one 48″ by 72″ frame constructed with 1½″ thick by 4″ wide wood lumber fastened together with screws. One wall (or flexible barrier material) was screwed to the wood frame on both sides creating a 4″ air space (or air gap). The walls were each approximately 10 mm thick and formed from 1½ lbs/sf “Tudelu Private” MLV panels. Each wall further included a 5 mm felt layer. The felt layer faced inward on both walls. In other words, the flexible barrier material walls were each formed from a 5-layer fabric panel 178. The 5-layer fabric panel included a 1.5 pound per linear foot reinforced mass loaded vinyl core and a 5 mm thick layer of felt backing material. Referring to Table 4 (below), the acoustical test results and calculations for this configuration revealed an STC rating of 48 and an OITC rating of 30. The acoustic testing was completed in accordance with ASTM E90-09 (2016), ASTM E413-22, ASTM E1332-22, and ASTM E2235-04 (2020).

TABLE 3
Double Wall Partition Acoustic Testing Results for a 2-Layer Fabric Panel (a)

| | Background | | Source | | | 95% | Number |
|---|---|---|---|---|---|---|---|
| Frequency | SPL | Absorption | SPL | Receive | Specimen | Sampling | Of |
| (Hz) | (dB) | (m²) | (dB) | SPL | TL | Limit | Deficiencies |
| 80 | 40.2 | 5.7 | 105 | 93 | 8 | 2.77 | — |
| 100 | 38.7 | 6.9 | 106 | 89 | 12 | 1.52 | — |
| 125 | 35.8 | 6.0 | 107 | 93 | 10 | 1.06 | 0 |
| 160 | 39.9 | 5.9 | 108 | 99 | 5 | 1.21 | 5 |
| 200 | 36.8 | 6.2 | 108 | 96 | 8 | 0.78 | 7 |
| 250 | 33.1 | 6.5 | 104 | 90 | 9 | 0.78 | 3 |
| 315 | 29.4 | 5.9 | 105 | 85 | 16 | 0.44 | 6 |
| 400 | 26.9 | 5.8 | 103 | 83 | 16 | 0.41 | 4 |
| 500 | 21.7 | 5.6 | 103 | 80 | 19 | 0.37 | 0 |
| 630 | 19.2 | 5.7 | 104 | 76 | 24 | 0.24 | 0 |
| 800 | 17.9 | 6.1 | 103 | 73 | 26 | 0.29 | 0 |
| 1000 | 13.9 | 6.0 | 104 | 71 | 29 | 0.28 | 0 |
| 1250 | 13.7 | 6.5 | 102 | 64 | 34 | 0.26 | 0 |
| 1600 | 10.1 | 7.0 | 100 | 58 | 36 | 0.17 | 0 |
| 2000 | 8.1 | 7.5 | 102 | 56 | 41 | 0.27 | 0 |
| 2500 | 7.1 | 8.7 | 103 | 52 | 44 | 0.27 | 0 |
| 3150 | 7.5 | 10.8 | 101 | 47 | 47 | 0.24 | 0 |
| 4000 | 7.9 | 13.8 | 99 | 41 | 50 | 0.20 | 0 |
| 5000 | 8.5 | 17.8 | 99 | 37 | 53 | 0.36 | — |

| | |
|---|---|
| STC Rating | 23 (Sound Transmission Class) |
| Deficiencies | 30 (sum of Deficiencies) |
| OTC Rating | 15 (outdoor-Indoor Transmission Class) |

Notes:
(a) Test Option: P3024.01A
(b) Total weight (lbs.), 49
(c) Average weight (lbs/ft2), 2.04
(d) Specimen Area, 2.23 m2
(e) Receive Temperature, 20.3 C.; Receive Humidity 45%
(f) Source Temperature, 20.1 C.; Source Humidity, 47%

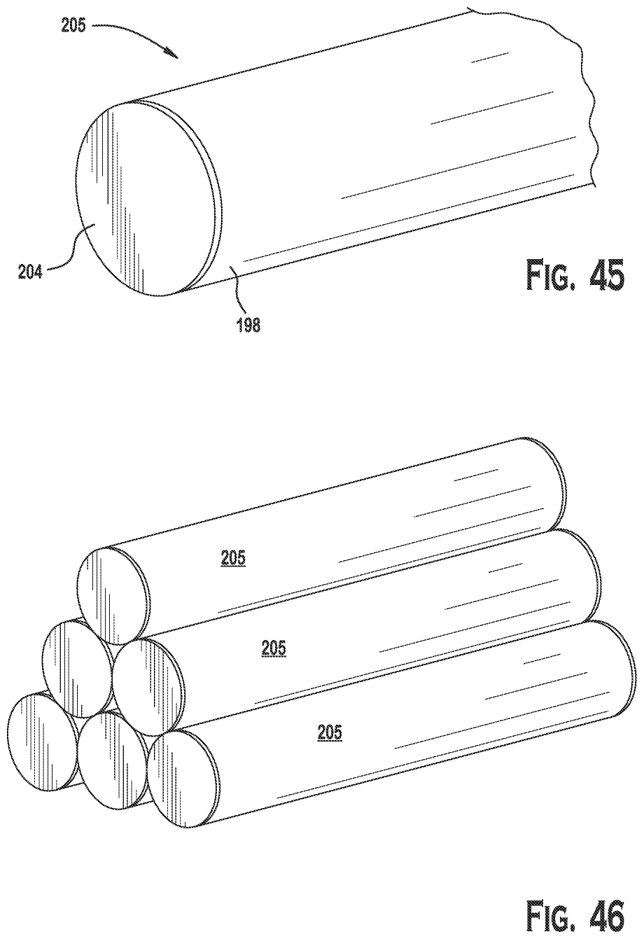

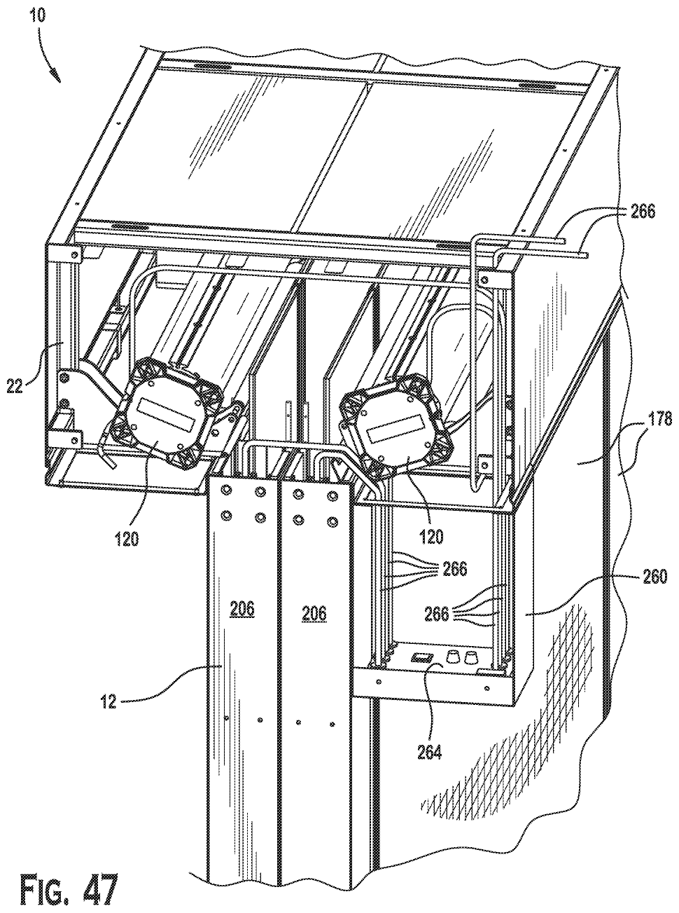

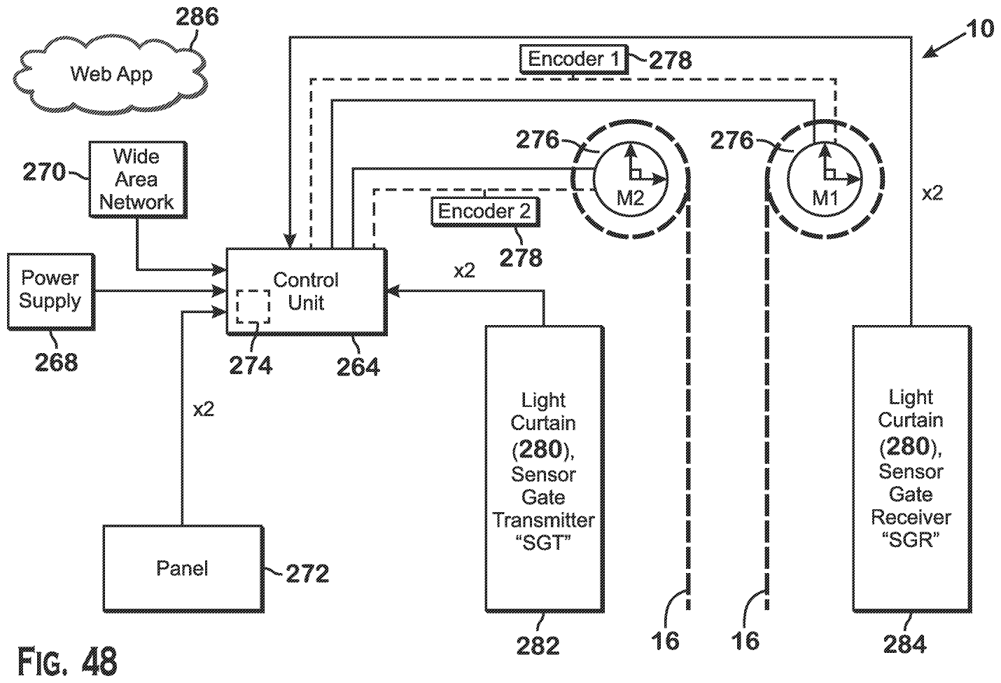

Referring to FIG. 47, the modular wall system 10 may further include an access panel 260 and a control box (or control unit) 264. The access panel 260 may provide a location for an operator to access the control panel 264, as well as cabling 266 for components of the modular wall system 10. Referring to FIGS. 48 and 49, a control unit 264 may connect a power supply 268, a wide area network—(e.g., the Internet)—270, and a local user interface (or panel) 272 to a main controller (e.g., a microcontroller) 274 that monitors and regulates operation of the modular roll-up wall system 10. For example, the control unit 264 may operatively connect, in part, a tube motor 276, a tube motor sensor (or encoder) 278, a light curtain 280—(e.g., an emitter sensor 282 and a receiver sensor 284 pair)—, a local user interface (or panel) 282, and a wide area network 270. Further, the main controller 274 may operatively connect with a web application 286. Referring to FIGS. 50, 52 and 53 the control unit 264 further may include indicator lights 288 which may signal the status or operating state of all or some of these devices, as well as other system components.

TABLE 4
Double Wall Partition Acoustic Testing Results for a 5-Layer Fabric Panel (a)

| | Background | | Source | | | 95% | Number |
|---|---|---|---|---|---|---|---|
| Frequency | SPL | Absorption | SPL | Receive | Specimen | Sampling | of |
| (Hz) | (dB) | (m²) | (dB) | SPL | TL | Limit | Deficiencies |
| 80 | 34.8 | 6.3 | 105 | 89 | 12 | 2.89 | — |
| 100 | 31.1 | 6.2 | 106 | 77 | 25 (g) | 1.42 | — |
| 125 | 33.7 | 5.6 | 107 | 79 | 24 | 1.37 | 8 |
| 160 | 39.9 | 4.7 | 108 | 75 | 30 (g) | 1.06 | 5 |
| 200 | 37.1 | 5.6 | 108 | 72 | 32 (g) | 0.71 | 6 |
| 250 | 34.4 | 6.0 | 104 | 60 | 40 (g) | 0.78 | 1 |
| 315 | 30.4 | 5.6 | 105 | 59 | 42 (g) | 0.58 | 2 |
| 400 | 24.1 | 5.6 | 104 | 53 | 42 (g) | 0.54 | 0 |
| 500 | 19.8 | 5.5 | 104 | 49 | 51 (g) | 0.37 | 0 |
| 630 | 17.7 | 5.6 | 104 | 47 | 54 (g) | 0.27 | 0 |
| 800 | 17.4 | 6.0 | 102 | 42 | 56 | 0.22 | 0 |
| 1000 | 11.3 | 6.0 | 104 | 39 | 61 | 0.28 | 0 |
| 1250 | 9.3 | 6.5 | 102 | 35 | 62 | 0.15 | 0 |
| 1600 | 6.8 | 6.9 | 99 | 30 | 64 | 0.18 | 0 |
| 2000 | 6.8 | 7.4 | 102 | 28 | 68 | 0.25 | 0 |
| 2500 | 6.5 | 8.7 | 103 | 27 | 70 (g) | 0.27 | 0 |
| 3150 | 6.8 | 10.6 | 101 | 25 | 69 (g) | 0.24 | 0 |
| 4000 | 7.7 | 13.6 | 99 | 20 | 71 (g) | 0.28 | 0 |
| 5000 | 8.4 | 17.5 | 99 | 17 | 74 (g) | 0.34 | — |

| | |
|---|---|
| STC Rating | 48 (Sound Transmission Class) |
| Deficiencies | 22 (sum of Deficiencies) |
| OTC Rating | 30 (Outdoor-Indoor Transmission Class) |

Notes:
(a) Test Option: P3024.01B
(b) Total weight (lbs.), 119
(c) Average weight (lbs/ft2), 4.96
(d) Specimen Area, 2.23 m2
(e) Receive Temperature, 20.1 C.; Receive Humidity 47%
(f) Source Temperature, 20.3 C.; Source Humidity, 46%
(g) Specimen TL level, filler wall correction applied.

Referring to FIG. 48, the control unit 264 further may include a communications circuit that connects to a web application 286. The web application 286 may include a user portal that may include a sign-in page and a system page. The system page may present operational data and controls for remotely regulating the modular roll-up wall system. The web application 286 further may include an admin page. The admin page may include an interface for a database which stores historical operating data for the modular roll-up wall system.

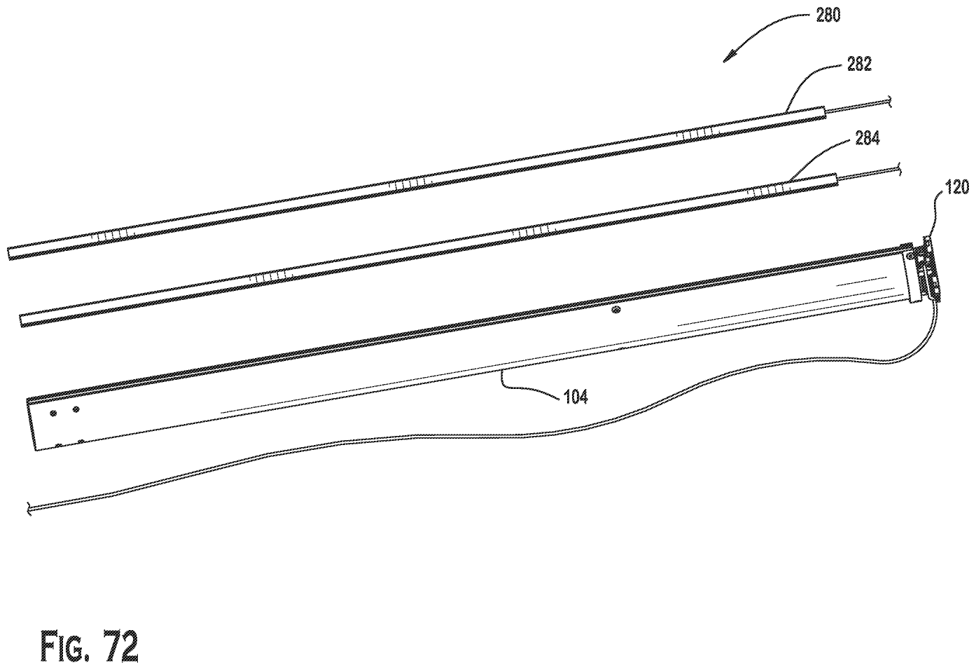

Referring to FIG. 49, the control unit 264 may include, in part, a main PCB 290 including a main controller (e.g., microcontroller) 274 which may monitor I/O peripherals, such as, a first tube motor sensor (or first encoder) 278A, a second tube motor sensor (or second encoder) 278B, a first self-contained light curtain 280A, a second self-contained light curtain 280B, a local pedal button 292, a remote user interface panel (e.g., keypad, or touchpad) 272, a first line control 294A which may include a first combinational logic circuit that regulates a first relay which energizes the first tube motor 276A and a second line control 294B which may include a second combinational logic circuit which regulates a second relay that energizes the second tube motor 276B. Moreover, the first self-contained light curtain 280A may include a first gate transmitter 282A and a first gate receiver 284A, and the second self-contained light curtain 280B may include a second gate transmitter 282B and a second gate receiver 284B. See e.g., FIGS. 27 and 72. The control unit 264 further may include a receptacle for an electric power supply 296 and a receptacle for an LAN or Internet connection 298. The control unit 274 further may include a circuit breaker 300. The main controller 274 may monitor the state of the power supply and the internet connection.

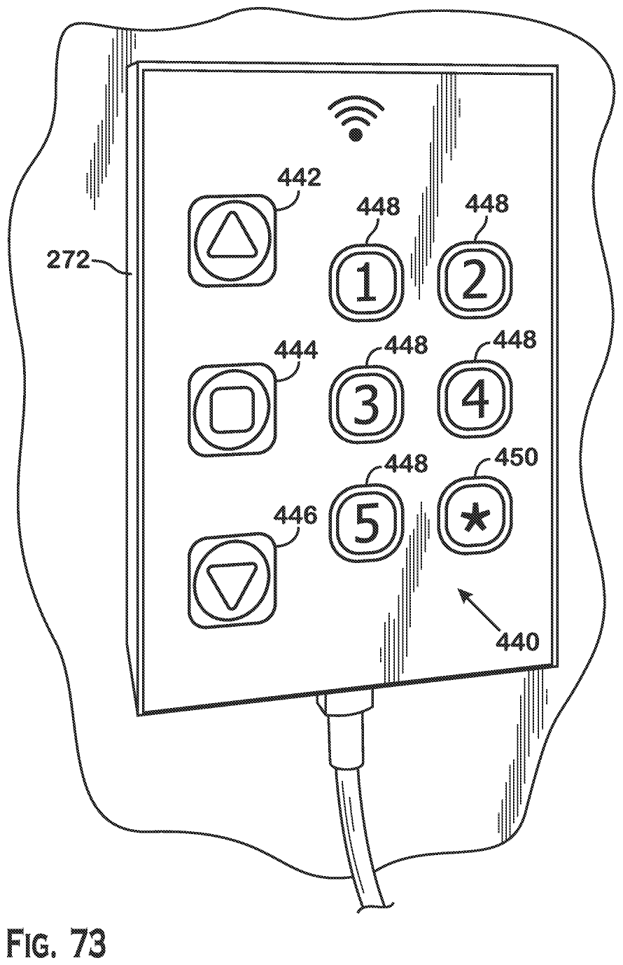

Referring to FIG. 50, the control unit may include a plurality of receptacles that are configured to interface with connectors that operatively connect the control box 264 to a power supply, a LAN or WAN connection, and other system cabling. Referring to FIG. 74, the other system cabling 304 may electrically connect the control unit 264 to the first tube motor 276A, the second tube motor 276B, the first tube motor sensor 278A, the second tube motor sensor 278B, the first gate transmitter 282A, the first gate receiver 284A, the second gate transmitter 282B, the second gate receiver 284B, a first user interface 272A, and a second user interface 272B.

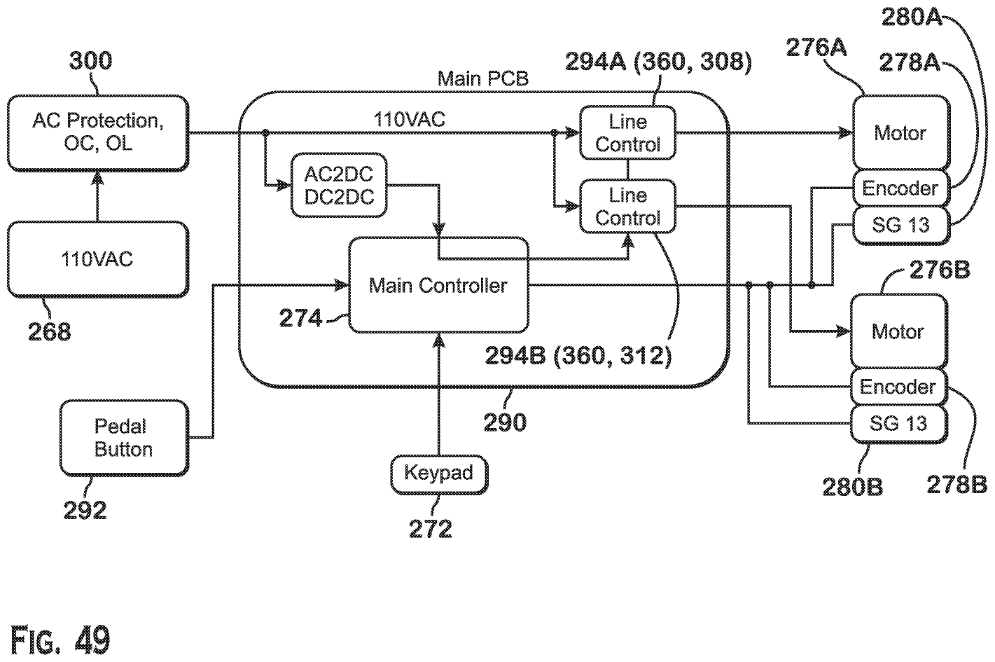

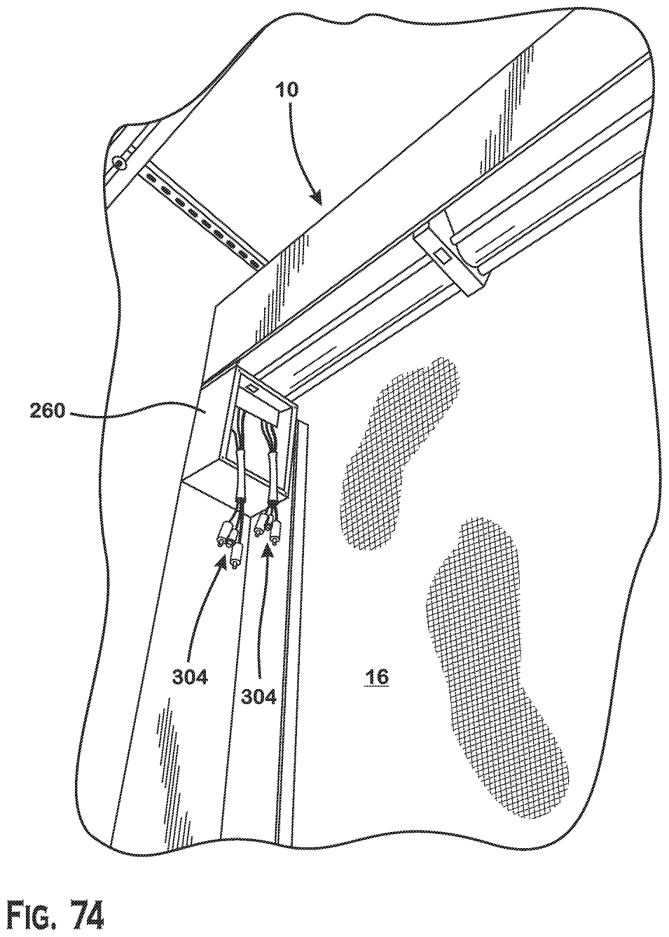

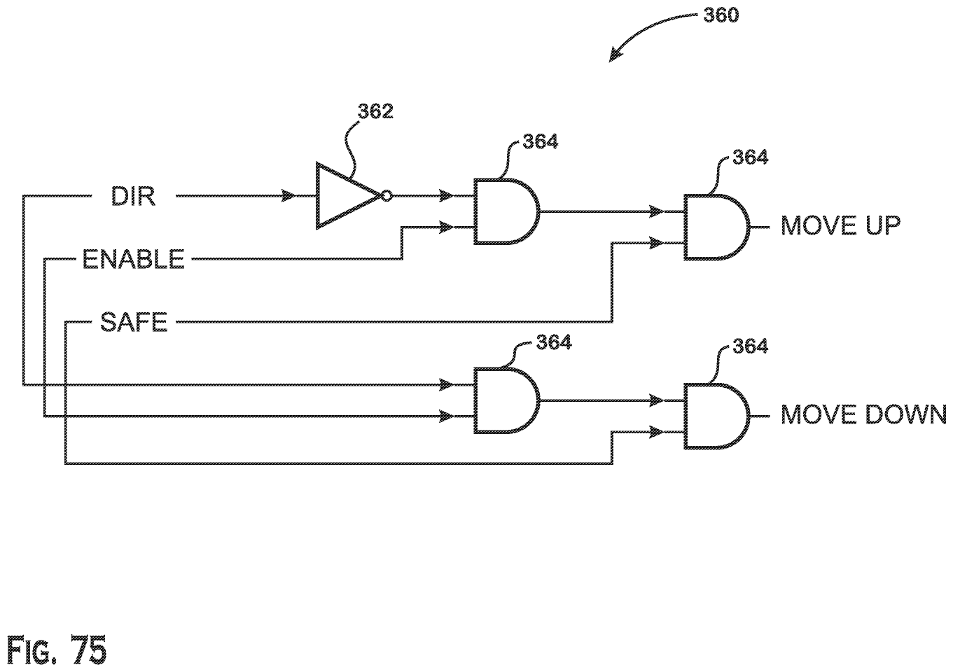

Referring to FIG. 51, in an exemplary embodiment, the main PCB 290 may include a pair of terminals 306 for a power supply (e.g., a 120V or 240V power supply), a first pair of line control relays 308 which deliver power to the first tube motor receptacle 310, and a second pair of line control relays 312 which deliver power to the second tube motor receptacle 314. The first pair of line control relays 308 and the second pair of line control relays 314 may be regulated by a plurality of IC logic devices 316. For example, as shown in FIG. 75, the plurality of logic devices may include one NOT-gate chip 316a and two AND-gate chips 316b. Generally, the plurality of IC logic devices 316 may be regulated by the main controller 274. The main controller 274 may be programed to read data from system components and execute instructions from a software program that resides in the main controller 274 or associated memory. For instance, FIG. 76 presents a state diagram which illustrates the functionality of an exemplary software program for governing operation of the main controller. Preferably, the main controller 274 may be a microcontroller. Although a microcontroller and a downloadable software program may be used in a preferred implementation of the main controller, a programmable microprocessor and memory chip set or an application specific integrated circuit (ASIC) also may be used.

Referring to FIG. 51, the control box 264a may include a second PCB 320 that is connected to the main PCB 290. The second PCB 320 may include designated receptacles for some of the specific connectors which operatively connect the control unit 264 to components of the modular roll-up wall system. For instance, the second PCB 320 may include: a first Type A USB receptacle 322 for receiving the first tube motor sensor cable connector; a second Type A USB receptacle 324 for receiving the second motor sensor cable connector; a first RJ45 receptacle 326 for receiving an Internet ethernet cable connector; a first Type B USB receptacle 328 for receiving a first user interface cable connector; and a second Type B USB receptacle 330 for receiving a second user interface cable connector.

Referring to FIG. 50 and FIG. 52, the control unit 264 may include front panel 264b which connects to the control box 264a and which further may include a third PCB 330 that is connected to the main PCB 290. The front panel 264b may include designated receptacles for specific connectors which operatively connect the control unit to components of the modular roll-up wall system. For instance, the front panel 264b may include: a first M12 4-pin S coded receptacle 310 for receiving the first tube motor cable connector; a first M12 5-pin A or L coded receptacle 332 for receiving the first gate receiver cable connector; a first M8 4-pin A or L coded receptacle 334 for receiving the first gate transmitter cable connector. Additionally, the front panel 264b may include: a second M12 4-pin S coded receptacle 314 for receiving the second tube motor cable connector; a second M12 5-pin A or L coded receptacle 336 for receiving the second gate receiver cable connector; a second M8 4-pin A or L coded receptacle 338 for receiving the second gate transmitter cable connector.

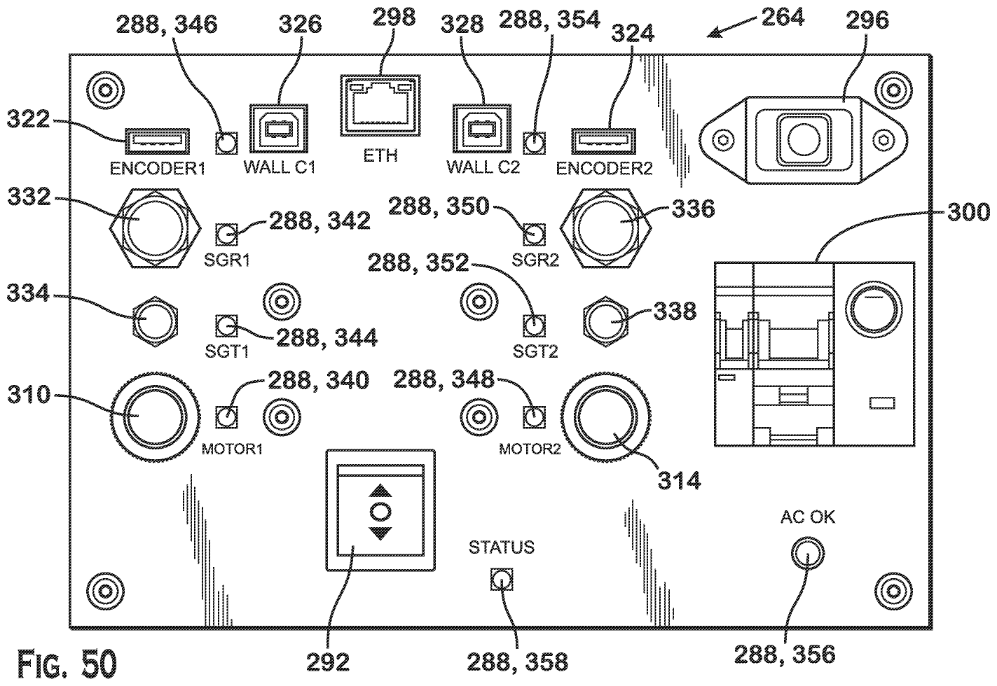

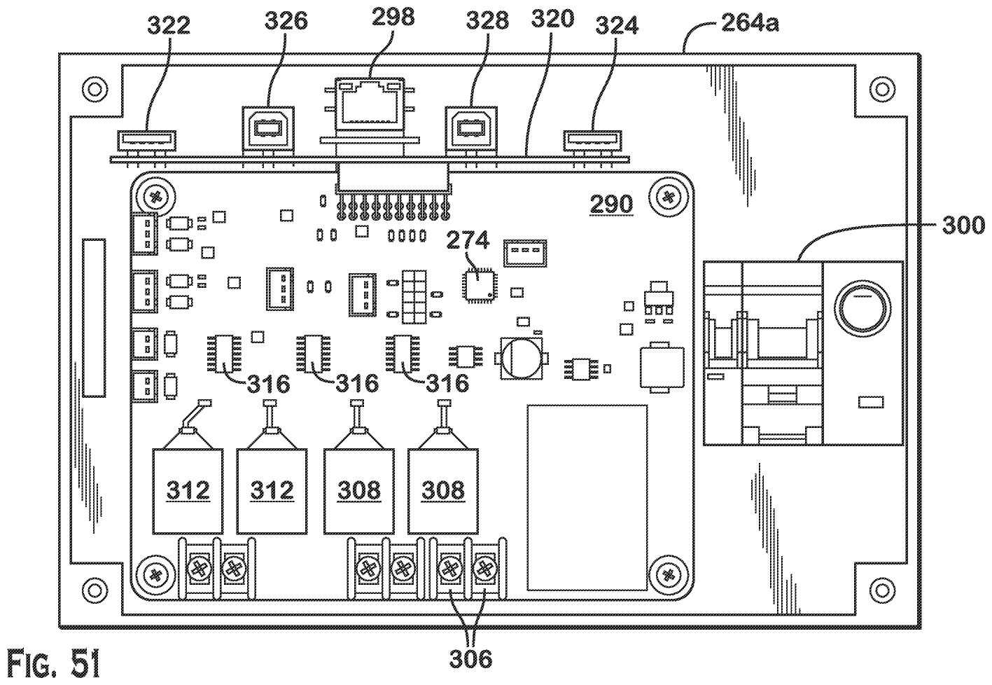

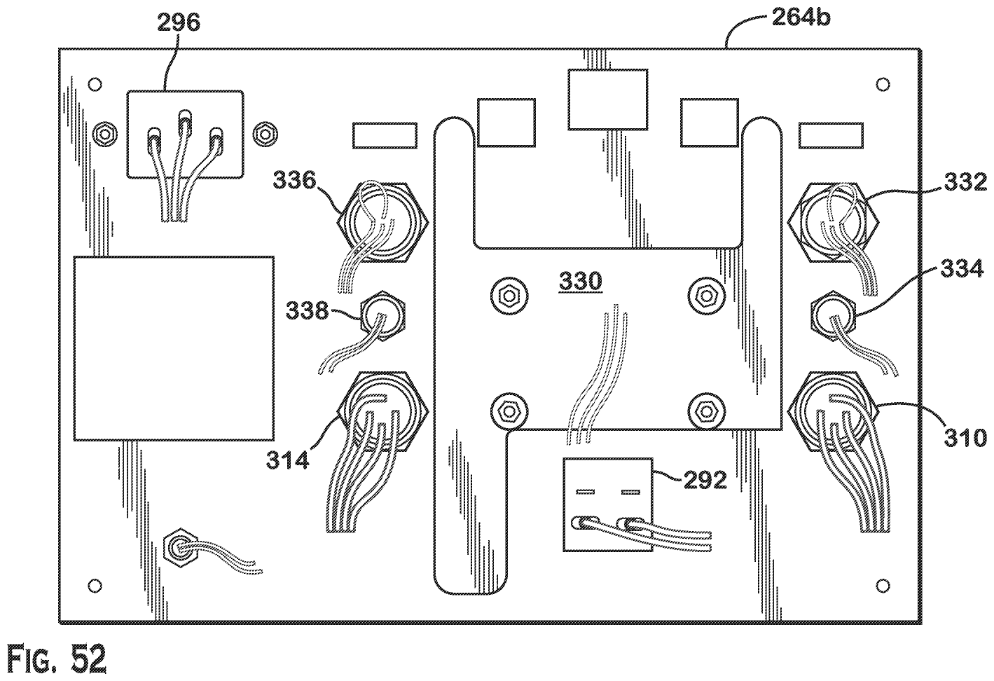

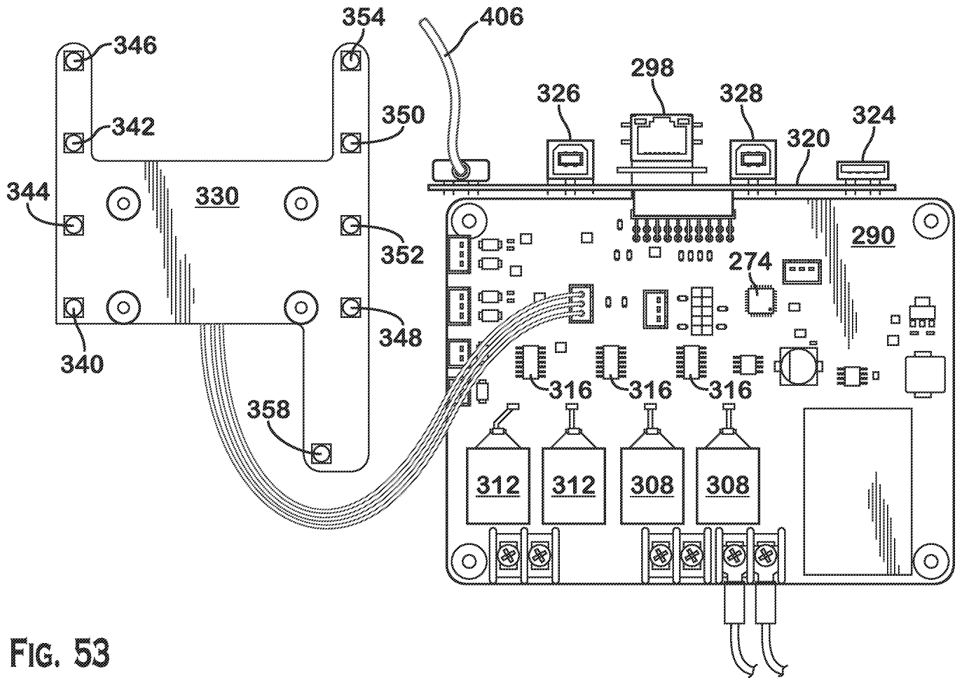

As shown in FIG. 50, the designated receptacles (e.g., 310, 322, 332, and 334) servicing the first tube motor 276A and associated sensors may be arranged in a grouping in one area (e.g., a left side area) of the front panel 264b of the control unit 264; whereas the designated receptacles servicing the second tube motor 267B and associated sensors may be arranged in a grouping in another area (e.g., a right side area) of the front panel 264b of the control unit 264. Referring to FIG. 50 and FIG. 53, the third PCB 330 may include a plurality of LEDs for indicating the status of various system components. For instance, in FIG. 50, a first LED 340 may be arranged adjacent to the first M12 4-pin S coded receptacle 310, a second LED 342 may be arranged adjacent to the first M12 5-pin A or L coded receptacle 332, a third LED 344 may be arranged adjacent to the first M8 4-pin A or L coded receptacle 334, and a fourth LED 346 may be arranged adjacent to the first Type A USB receptacle 322. Similarly, a fifth LED 348 may be arranged adjacent to the second M12 4-pin S coded receptacle 314, a sixth LED 350 may be arranged adjacent to the second M12 5-pin A or L coded receptacle 336; a seventh LED 352 may be arranged adjacent to the second M8 4-pin A or L coded receptacle 338, and an eighth LED 354 may be arranged adjacent to the second Type A USB receptacle 324. Additionally, another LED may be arranged near the AC power circuit breaker, and another LED 358 may be arranged next to the pedal button 288. Table 5 (below) identifies an illustrative set of visual states for these LEDs, along with an explanation of the corresponding visual signal associated with those states.

TABLE 5
Exemplary LEDs and Operating States and Signaling for Same

| Description | State | Meaning |
|---|---|---|
| Encoder | Blue | “CLICK” or “TURN ON” signaled |
| | Off | “NO CLICK” signaled - initial state |
| | Red | Not connected |
| Light-curtain sensor: | Green | “SAFE” or “NO CROSS” signaled |
| gate receiver | Red | Not connected or “CROSS” signaled |
| Light-curtain sensor: | Green | Connected |
| gate transmitter | Red | Not connected |
| Tube motor | Purple | Motor ON; screen moving “UP” |
| | White | Motor ON; screen moving “DOWN” |
| | Off | Motor OFF |
| Status | Green | All systems operational |
| | Cyan | All systems operational; no Internet |
| | Red | “ERROR” |

Referring to FIG. 49 and FIG. 51, the main controller 274 may regulate operation of the first tube motor 276A by controlling a first pair of relays 308 that are electrically connected to the first tube motor. The main controller 274 may regulate operation of the second tube motor 276B by controlling a second pair of relays 312 that are electrically connected to the second tube motor. Generally, the power relays may be normally open. Table 6 (below) illustrates how the states of a pair of power relays may regulate operation of a tube motor. See also, FIG. 76.

Although the first and second pairs of relays 308, 312 may be directly controlled by output signals from the main controller 274, in the disclosed embodiment an intermediate hardware component 360, 362 may be interposed between the main controller and the first and second pairs of relays 308, 312 to provide an additional layer of operational control. For example, the intermediate hardware component 360, 312 may include a plurality of standard logic ICs 316 which may form a combinational logic circuit that receives input signals from the main controller 274 and passes control signals to the first and second pairs of relays 308, 312. See e.g., FIG. 49 and FIG. 75.

TABLE 6
Exemplary Relay States for Line Control

| Relay 1 | Relay 2 | Tube Motor |
|---|---|---|
| Open | Open | Off |
| Open | Closed | On - Direction Up |
| Closed | Open | On - Direction Down |

Referring to FIG. 49 and FIG. 75, the intermediate hardware component may include a first combinational logic circuit 360 between the main controller 274 and the first pair of relays 308. As shown in FIG. 75, the first combinational logic circuit may include one Not-gate 362 and four AND-gates 364. The first combinational logic circuit may include three input signals from the main controller: (1) a “direction” signal: (2) a “safe” signal; and (3) an “enable” signal. Generally, the “direction” signal and the “safe” signal may be affected by operating parameters of the software program that is resident in the main controller. By contrast, the “enable” signal may be affected by the operating state of one or more I/O peripherals and hardware components that are monitored by the software program that is resident in the main controller. For instance, the “enable” signal may be affected by the operating state of one or more I/O peripherals and hardware components that are continuously monitored by the main controller and determined to be functioning properly.

Referring to FIGS. 75 and 76, the first combinational logic circuit 360 may produce a first control signal to one relay of the first pair of relays 308, as well as a second control signal to the other relay of the first pair of relays 308. The configuration of the first combinational logic circuit may ensure that the first pair of relays energizes the first tube motor 276A when the system's I/O peripherals and hardware components are operating properly (e.g., the “ENABLE” signal is high) and the software program specifically calls for the first tube motor to move (e.g., SAFE is high).

Additionally, as shown in FIG. 49 and FIG. 75, the intermediate hardware component further may include a second combinational logic circuit 360 between the main controller 274 and the second pair of power relays 312. The second combinational logic circuit may be the same as the first combinational logic circuit. The first combinational logic circuit and the second combinational logic circuit may share a common NOT-gate.

Referring to FIG. 49 and FIG. 56, the control system further may include an encoder (or sensor assembly) 278. Generally, the sensor assembly 278 may be part of an encoder apparatus 368. The encoder apparatus 368 may collect and transmit data from a tube motor assembly 366 to the main controller 274. The data may be processed by the main controller 274 to evaluate rotational travel of the associated tube assembly 104 and to regulate operation of the associated tube motor 120.

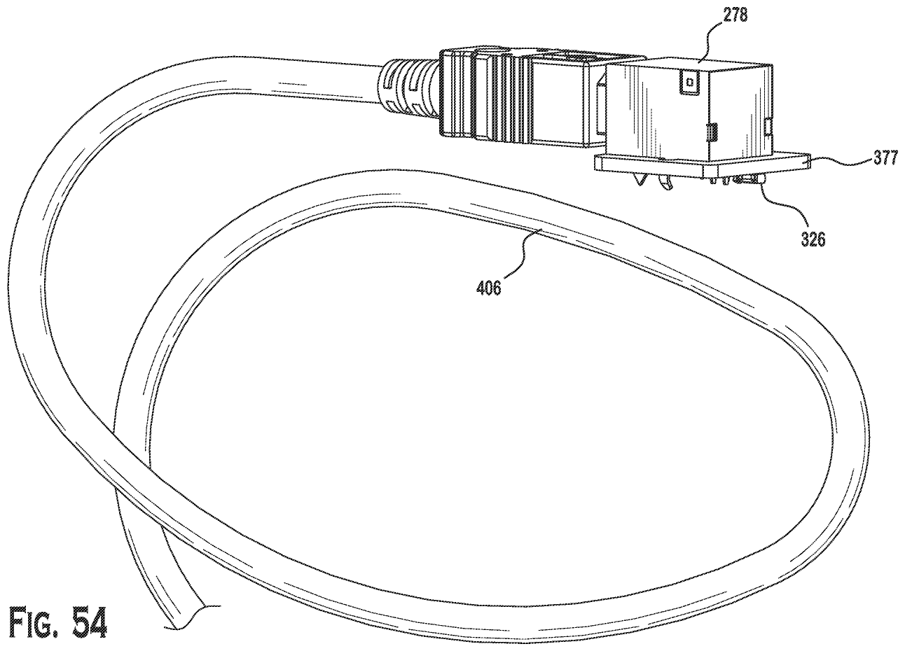

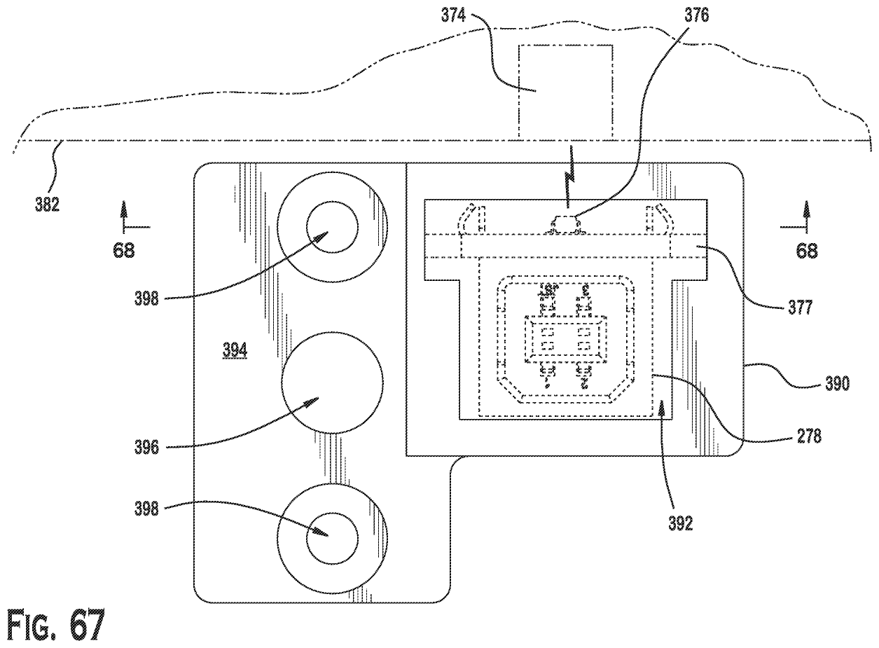

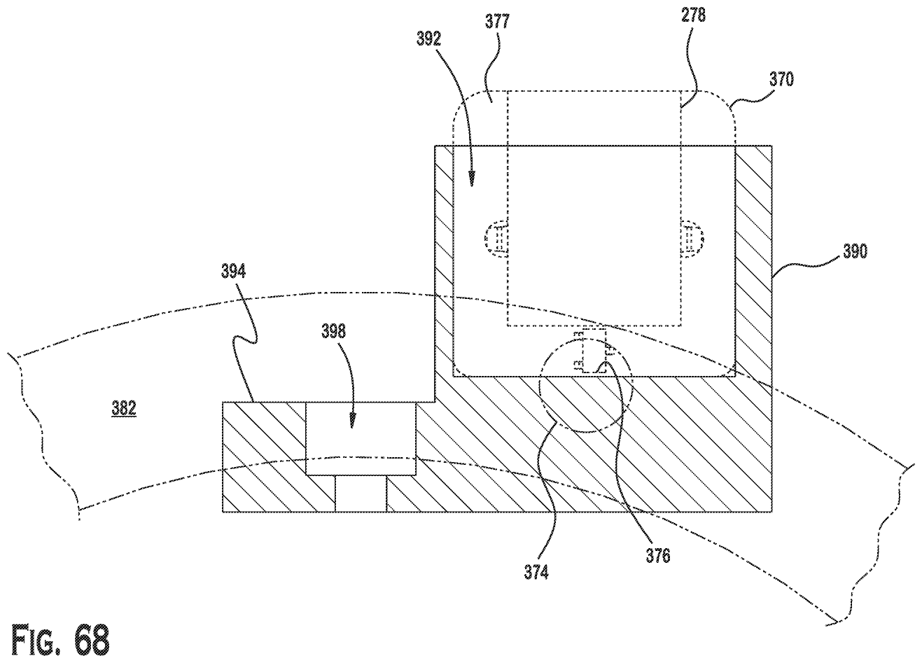

Referring to FIG. 56, the encoder apparatus 368 may include a sensor assembly 278, a sensor holder 390, and an encoder ring (or collar) 378. Referring to FIG. 55, the sensor assembly 278 may include a PCB 377 with a sensing circuit. The sensing circuit may include an encoder sensor 376 and a cable receptacle 408. As shown in FIG. 53 and FIG. 54, a cable 406 (e.g., a USB 2.0 cable (A to B)) may connect receptacle 322 of the control unit 264 to the sensor assembly 278. The sensor assembly 278 may be housed in a sensor receptacle 390 that is fixed to the tube motor housing 372. The sensor receptacle 390 may be positioned proximate to the encoder ring (or collar) 378. The encoder ring 378 may include a plurality of sensor targets 374. The sensor targets 374 may be distributed about the around the proximal end of the tube assembly 104. See e.g., FIGS. 56, 58, and 59. Each sensor target 374 may possess a physical characteristic that activates the encoder sensor 376 in the sensing circuit when the sensor target 374 and encoder sensor 376 are proximate to each other. See e.g., FIG. 67 and FIG. 68.

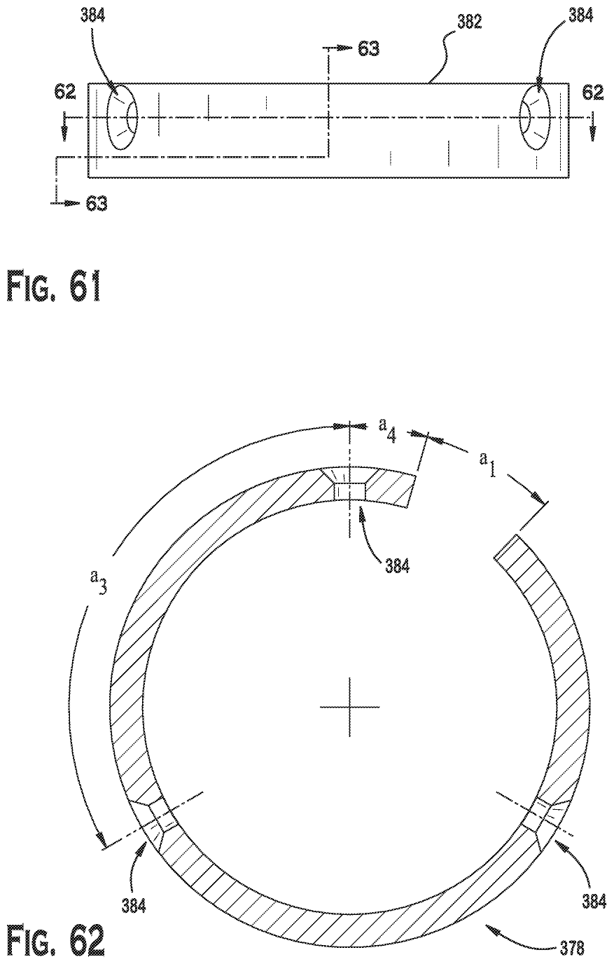

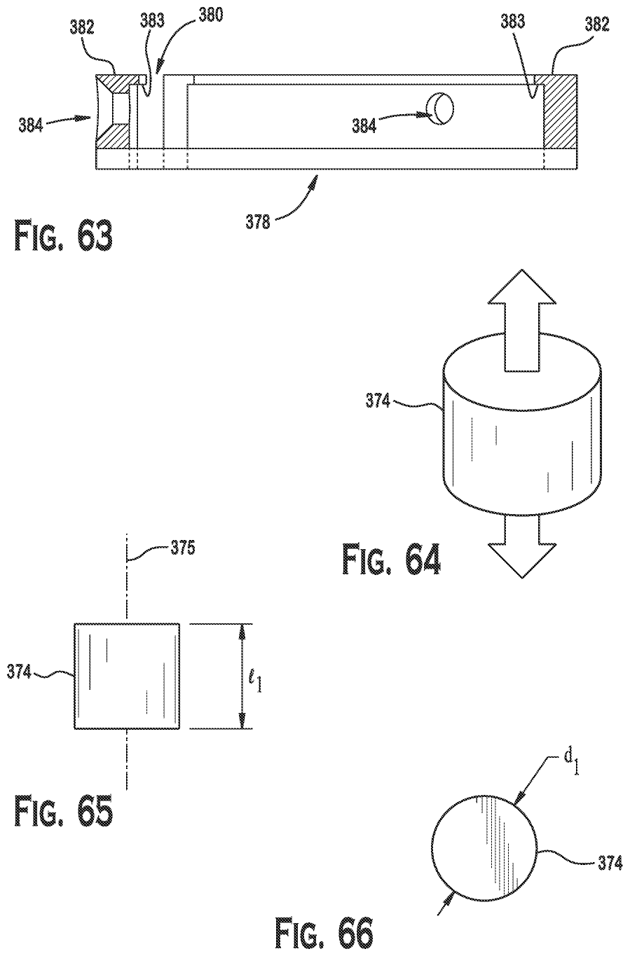

As shown in FIG. 58, the collar may be configured and dimensioned to be received on the proximate end of a tube assembly 104. For instance, referring to FIGS. 58, 59 and 60, the collar 378 may include a gap 380 to accommodate the cleat 156 on the tube assembly 104. As shown in FIG. 60, the gap 380 may extend over an are having an angle α₁ measuring approximately 28 degrees, and the sensor targets 374 may be arranged about the face 382 of the collar at an angular interval α₂ of approximately 45 degrees. Referring to FIGS. 64, 65 and 66, the sensor targets 374 may be circular cylindrical in shape. For instance, each sensor target may possess a central axis 375, a diameter d₁, and height l₁. For example, in the preferred embodiment, the sensor target may have a diameter d₁ of approximately 0.25 inches and a height h₁ of approximately 0.25 inches. Referring to FIG. 64, each sensor target may be magnet, and the magnetic poles of the magnet may be aligned with the longitudinal axis of the sensor target. Referring to FIG. 60, the center of each sensor target 374 may be aligned with a reference circle 388 on the collar 378. For instance, the radius r₁ of the reference circle 388 may be approximately 600 mm. Although the collar 378 may include eight sensor targets in a preferred embodiment, fewer or more magnets may be used provided that sufficient control over the tube motor assembly 366 may be maintained by the control system during operation of the modular wall system.

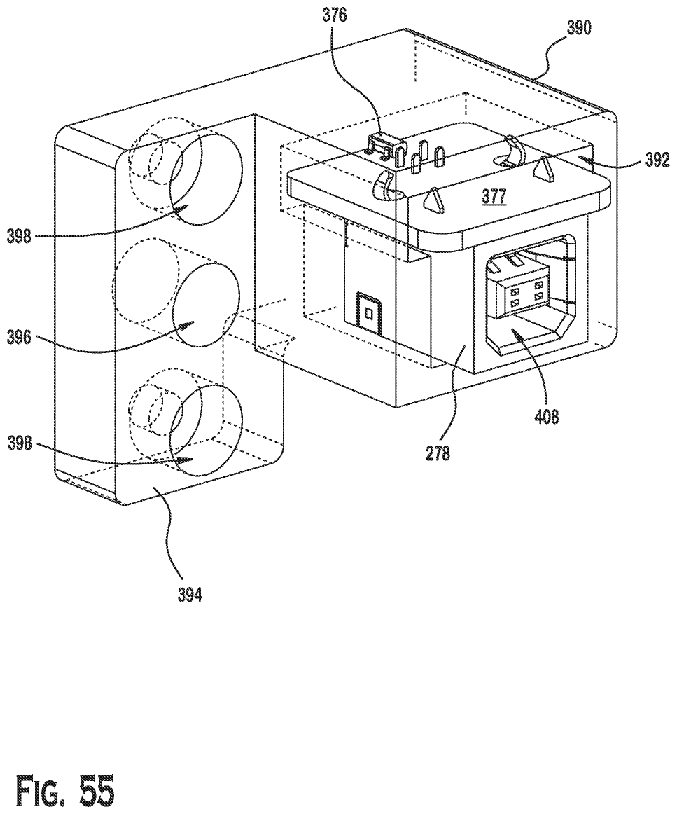

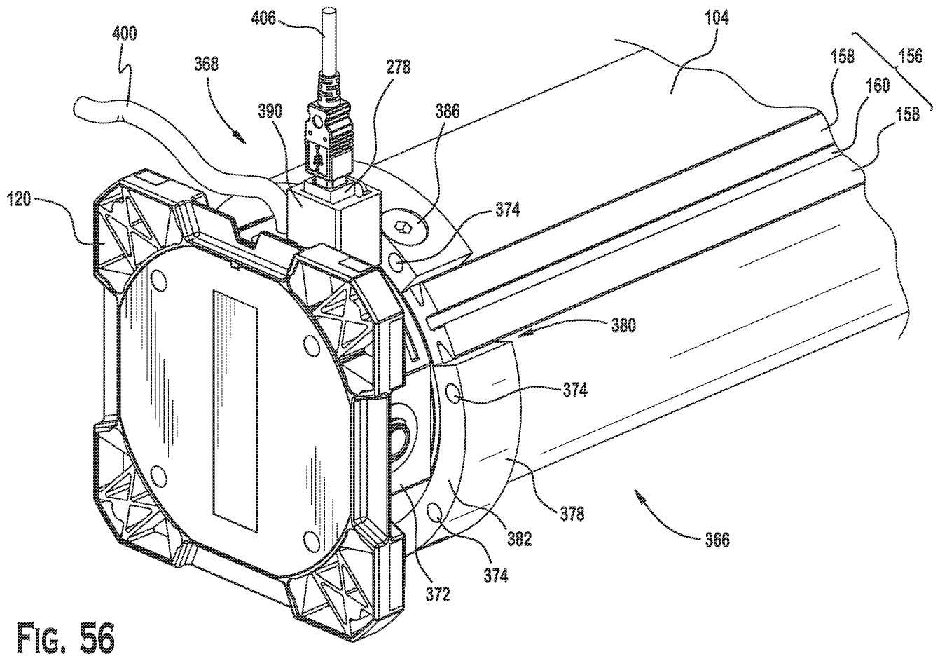

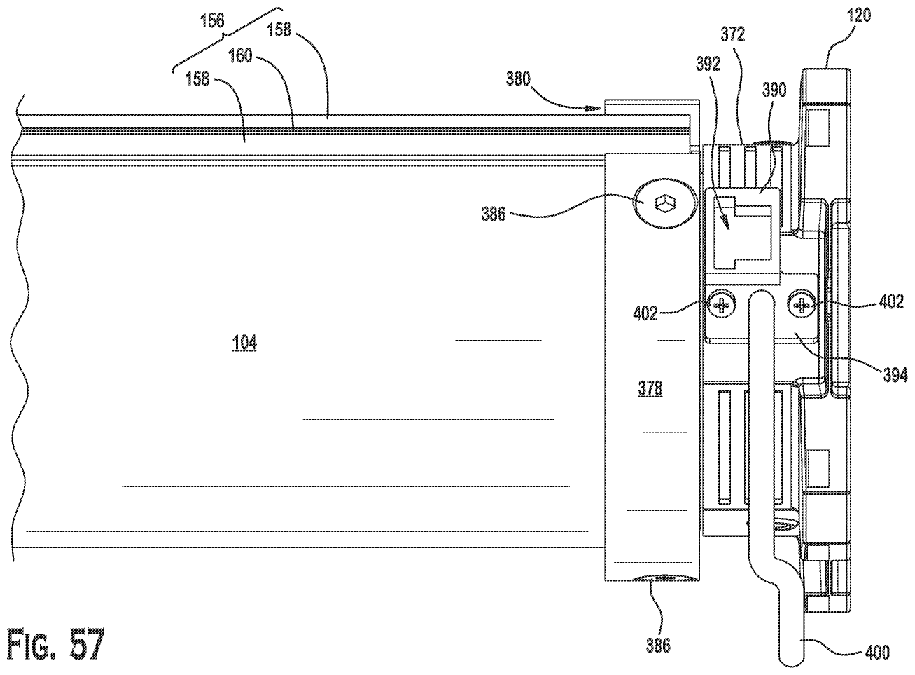

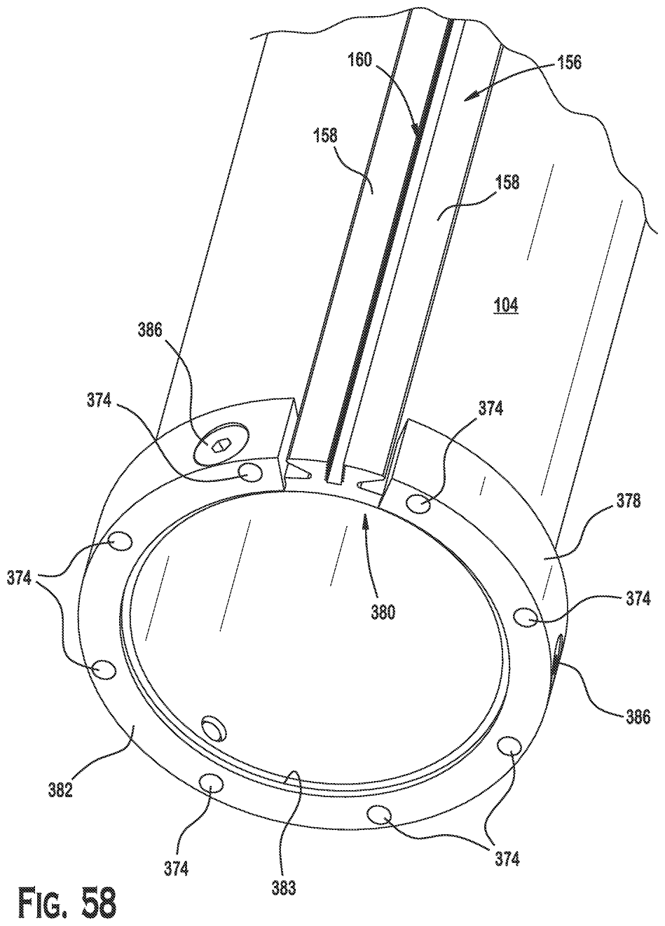

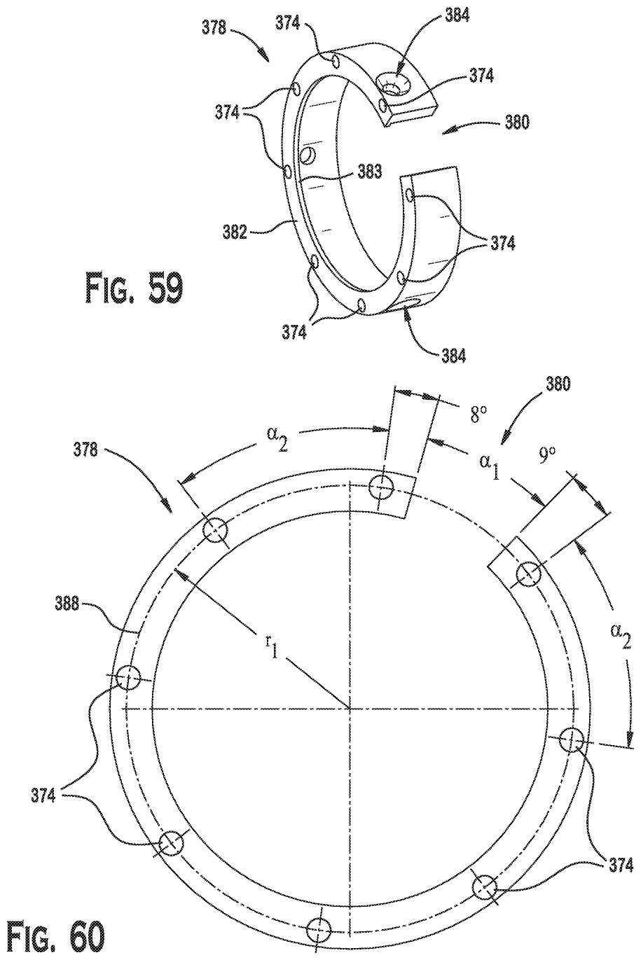

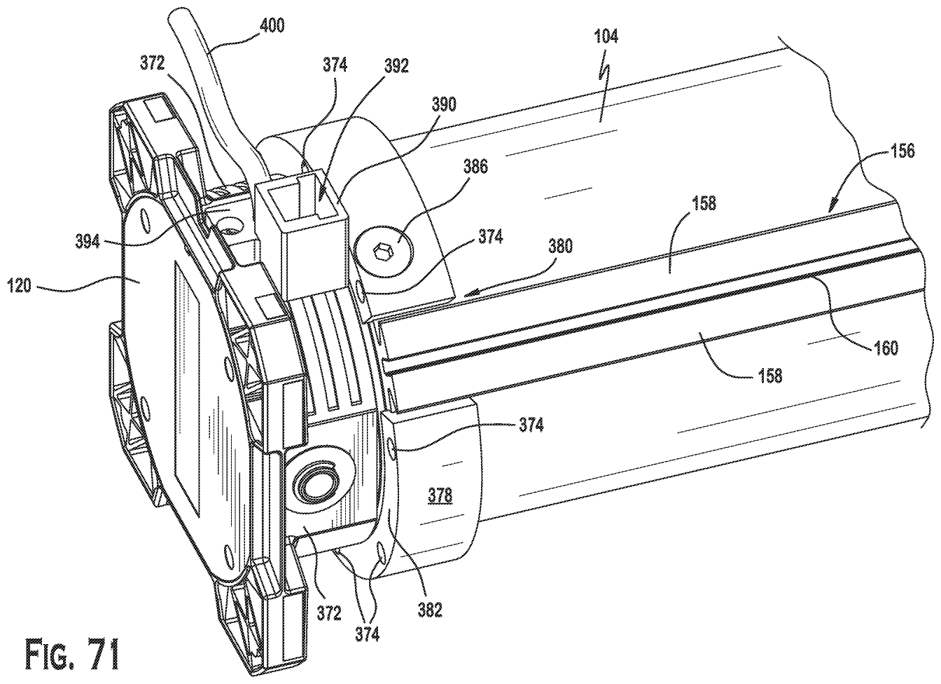

Referring to FIGS. 61, 62 and 63, the collar 378 further may include one or more fastener receiving holes 384. The one or more fastener receiving holes 384 may receive a fastener (e.g., a M8 screw) 386 which may be advanced into the tube assembly 104 to fix the collar 378 to the tube assembly. See, e.g., FIGS. 57, 58 and 71. For instance, referring to FIG. 62, the fastener receiving holes 384 may be arranged uniformly about the circumference of the collar 378. For example, the fastener receiving holes may be arranged circumference of the collar 378 at an angular interval α₃ of approximately 120 degrees. Additionally, the gap 380 may be offset from a fastener receiving hole 378 by an angle α₄ of approximately 16 degrees. In the disclosed embodiment, the inner diameter may be approximately 4.4 inches, and the outer diameter of the collar may be approximately 5.1 inches. As shown in FIG. 59 and FIG. 63, one end of the collar may include a circumferential lip 383. In the disclosed embodiment, the inner diameter of the circumferential lip 383 may be approximately 4.2 inches. Referring to FIG. 58, the circumferential lip 383 may abut the proximal end of the tube assembly.

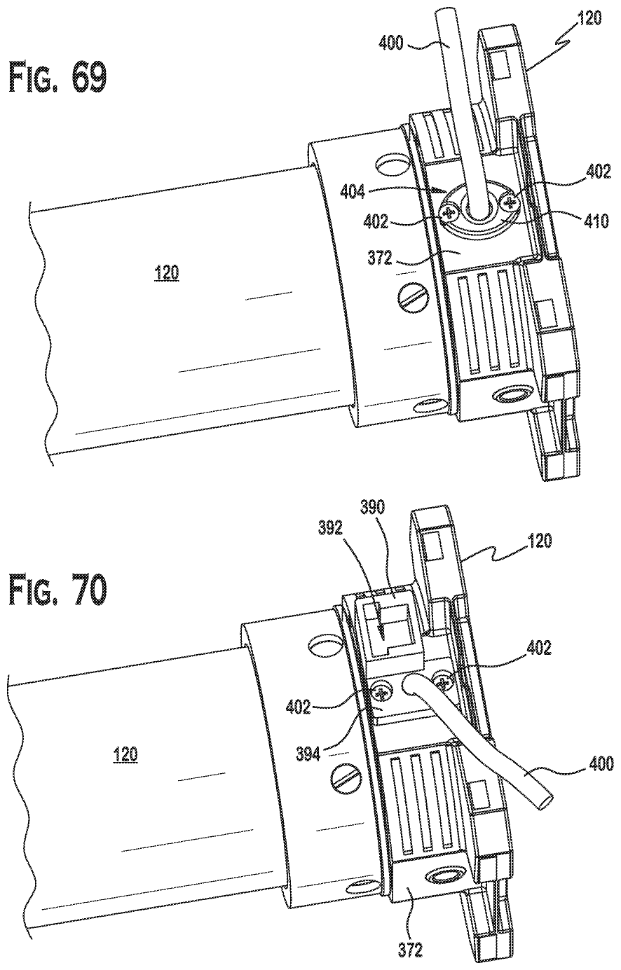

Referring to FIGS. 56, 57 and 70, the tube motor assembly 366 further may include a sensor holder 390. The sensor holder 390 may include a sensor receptacle 392 for receiving the sensor assembly 370 as well as an anchor portion 394 for securing the sensor holder 390 to the tube motor housing 372. As shown in FIG. 70, the anchor portion 394 may include a generally centrally located aperture 396 having circular shape, as well as two adjacent fastener receiving holes 398. The aperture 396 may be configured and dimensioned to receive a cord 400 that supplies electrical power to motor terminals inside the tube motor housing 372. The two adjacent fastener receiving holes 398 each may be configured and dimensioned to receive a fastener (e.g., a screw) 402 for fixing the sensor holder 390 to the tube motor housing 372. Referring to FIG. 69 and FIG. 70, the aperture 396 and adjacent fastener receiving holes 398 in the anchor portion 394 of the sensor holder 390 may be configured and dimensioned to conform to corresponding openings in the tube motor housing 372 as provided by the tube motor manufacturer. Thus, the sensor holder 370 may replace an access cover 410 supplied with the tube motor 120.

Referring to FIG. 49 and FIG. 54, the encoder sensor 376 may include a magnetic sensor device. For example, the magnetic sensor device may include a Hall effect sensor (or Hall sensor) which detects the presence of a magnetic field. For instance, the magnetic sensor device may be a unipolar digital Hall-effect sensor IC. For example, an SS341RT manufactured by Honeywell Sensing and Controls of Golden Valley, MN. The encoder sensor 376 may be mounted on a PCB 377 in a high-side sensing circuit. The high side sensing circuit may be connected to a cable receptacle 408. The other end of the cable may be connected to an encoder receptacle (e.g., 322 or 324) on the control unit 264. Thus, the other end of the cable 406 may be a Type A USB connector. Generally, the magnetic sensor device may possess a detection threshold, which is the amount of magnetic flux required to pass through the Hall sensor mounted inside the magnetic sensor device to activate the Hall sensor. Typically, a magnet must apply a flux greater than the detection threshold to reliably activate the Hall sensor. Accordingly, a magnet may reliably activate the magnetic sensor device if the magnet passes within a certain distance (or range) from the Hall sensor. This may be referred to as a “turn-on” event. By contrast, if a magnet moves away from and out of range of the Hall sensor, the magnetic field will go below the detection threshold and the magnetic sensor device may return to its initial state.

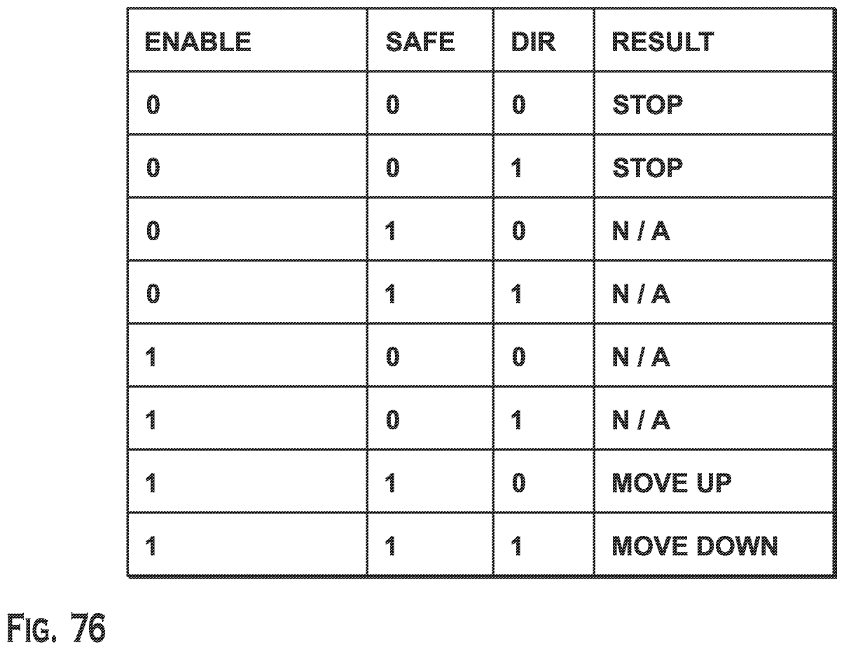

Referring to FIGS. 56, 67, 71 and 68, the sensor receptacle 392 may be configured and dimensioned to hold the PCB 377 and encoder sensor (e.g., the magnetic sensor device) 376 such that the sensor (e.g., a Hall sensor) is adjacent to the face 382 of the collar 378 when the collar is deployed on the tube assembly 104. Generally, in operation the collar 376 may rotate in unison with the tube assembly 104. As each sensor target 374 (e.g., circular cylindrical magnet) passes within range of the sensor (e.g., Hall sensor), the encoder (or sensor assembly) experiences a “turn on” event and signals the main controller 274 (e.g., a microcontroller). Moreover, as each sensor target 374 (e.g., circular cylindrical magnet) passes out of range of the sensor (e.g., the Hall sensor), the magnetic field falls below the detection threshold, and the sensor returns to its initial state. Accordingly, referring to FIG. 56, the encoder (or sensor assembly) 278 may experience eight “turn on” events (or clicks) per revolution of the tube assembly 104. As described in connection with FIG. 77 and FIG. 78, the software program resident in the main controller 274 (e.g., the microcontroller) may read and evaluate the “turn on” event signals to regulate operation of the associated tube motor 120.

Referring to FIGS. 27, 48, 49 and 72, the modular roll-up wall system 10 may include a light curtain 280. Generally, a light curtain may be a safety device which acts in conjunction with the control or operation of a machine. Light curtains may be supplied as a sensor pair with a transmitter and receiver. The transmitter may project an array of parallel infrared light beams to the receiver which may consist of a number of photoelectric cells. When an object breaks one or more of the beams a stop signal may be sent to the guarded equipment or machine. Moreover, the light beams emitted from the transmitter may be sequenced, one after the other, and pulsed at a specific frequency. The receiver may be designed to only accept the specific pulse and frequency from its dedicated transmitter. This may enable the rejection of spurious infrared light, and thus enhance the reliability of these components within a safety system.

Referring to FIGS. 48 and 50, each gate transmitter 282 and gate receiver 284 pair may be connected to the main controller 274 via cables that plug into receptacles 332, 334, 336, 338 in the control unit 264. Referring to FIGS. 27 and 49, each roll-up wall may include a light curtain 280 (282, 284) between the vertical tracks 206. The light curtain 280 may be designed to span the opening in which the screen or flexible barrier material 16 is lowered. For example, a first self-contained light curtain 280A may be arranged below the first screen 16 and a second self-contained light curtain 280B may be arranged below the second screen 16. More particularly, the first self-contained light curtain 280A may include a first gate transmitter 282A and a first gate receiver 284A, and the second self-contained light curtain 280B may include a second gate transmitter 282B and a second gate receiver 284B. For instance, the first gate transmitter 282A may be positioned in one of the first or second vertical posts 206, and the first gate receiver 284A may be positioned in the opposing vertical post 206. Similarly, the second gate transmitter 282B may be positioned in one of the adjacent vertical posts 206 and the second gate receiver 284B may be positioned in the opposing vertical post 206. Referring to FIG. 72, preferably the self-contained light curtain 280 may be manufactured by Telco A/S of Køge Denmark. For instance, the self-contained light curtain 280 may be a SpaceGuard™ SG 13 Series Light Curtain.

Referring to FIGS. 49 and 73, the modular roll-up wall system 10 may include one or more user interface panels (e.g., keypad, or touchpad) 272. For example, as shown in FIG. 73, the user interface panel 272 may include a keypad 440 which includes an “up” arrow key 442, a “stop” key 444, and a “down” arrow key 446. Also, the keypad 440 may include a numeric keypad. Although the numeric keypad may be a 17-key or 10-key numeric keypad, in an exemplary embodiment the numeric keypad may include 5 numeric keys 448 and one asterisk (or star) key 450. The user interface device 272 may be used by an operator to raise, lower, or stop movement of the modular roll-up wall system screens 16. The operator may raise or lower the modular roll-up wall system screens 16 by pressing the “up” arrow key 442 or the “down” arrow key 446, respectively. The operator may stop movement of the modular roll-up wall system screens 16 by pressing the “stop” key 444. Functional access to the “up” arrow key 442, the “stop” key 444, and the “down” arrow key 446 may be passcode protected. For instance, a passcode may be a four-digit number. An operator may key the four number sequence and asterisk (or star) key 450 to enter the passcode. Alternatively, the “stop” key 444 may be enabled without the need to enter a passcode during normal operating conditions so that any operator may stop movement of the modular roll up-wall system screens 16. In another embodiment, the keypad 440 include a GUI on a touch screen.

Referring to FIG. 77, the software program resident in the main controller may regulate the modular roll-up wall system between a plurality of modes. The plurality of modes may include a set of operating states 500 including: (1) “idle/stop” 502: (2) “up” 504; and (3) “down” 506. Additionally, the plurality of modes may include a set of auxiliary states including: (1) “up-safe” 508; (2) “technician” 510; and (3) “alarm” 512.

Generally, the default state may be the “idle/stop” state 502. In the “stop/idle” state the main controller 274 may regulate operation of the first tube motor 276A and the second tube motor 276B to fix the positions of their respective screens 16A. 16B. From the “stop/idle” state 502 the modular wall system may transition to the “up” state when the “up cmd” 516 is input to the main controller. In the “up” state 504 the main controller 274 regulates operation of the first tube motor 276A and the second tube motor 276B to roll-up their respective screens. The “up cmd” 516 may be initiated by pressing the “up” arrow key 442 on one user interface panel 272.

The modular roll-up wall system may exit the “up” state 504 by a plurality of transitions which may include: (1) “stop cmd” 518: (2) “timer_out” 520: (3) “down cmd” 522 and (4) “misalign” 524. For instance, the “stop cmd” 518 may be initiated by pressing the “stop” key 444 on a user interface panel 272. The “stop cmd” 518 may transition the modular roll-up wall system wall from the “up” state 504 to the “stop/idle” state 502.

Moreover, the modular roll-up wall system may transition from the “up” state 504 to “stop/idle” state 502 by a “timer_out” 520 transition that allows the “up cmd” 516 to operate until a timer expires (e.g., 60 sec). After the timer expires the modular roll-up wall system may enter the “stop/idle” state 502. Additionally, the modular wall system may transition to the “down” state 506 when the “down cmd” 522 is input to the main controller. In the “down” state 506 the main controller 274 regulates operation of the first tube motor 276A and the second tube motor 274B to roll down their respective screens. The “dwn cmd” 522 may be initiated by pressing the “down” arrow key 446 on the user interface panel 272.

Also, the modular roll-up wall system also may transition from the “up” state 504 to the “stop/idle” state 502 by a “misalign” transition 524. The “misalign” transition 524 may be initiated by a subroutine that monitors the first encoder sensor assembly 278A and the second encoder sensor assembly 278B and then evaluates the difference between the estimated travel distance of the first tube assembly 104A and the estimated travel distance of the second tube assembly 104B. In the event the estimated travel distance of the first tube assembly 102A and the estimated travel distance of the second tube assembly 102B is greater than a reference travel distance, then the microcontroller may stop the tube motor 120 with the greater estimated travel distance for a predetermined period. For instance, the reference travel distance may be 30 mm and the predetermined period may be 100 microseconds. After the predetermined period has elapsed, the main controller may initiate the “up_cmd” 516 and transition to the “up” state 504.

Similarly, the modular roll-up wall system may exit the “down” state 506 by a plurality of transitions which may include: (1) “stop cmd” 518: (2) “timer_out” 520: (3) “up cmd” 516 and (4) “misalign” 524. For instance, the “stop cmd” 518 may be initiated by pressing the “stop” key 444 on a user interface panel 272. The “stop cmd” 518 may transition the modular roll-up wall system wall from the “down” state 506 to the “stop/idle” state 502. Moreover, the modular roll-up wall system may transition from the “down” state 506 to the “stop/idle” state 502 by a “timer_out” transition 520 that allows the “down cmd” 522 to operate until a timer expires. After the timer expires the modular roll-up wall system may enter the “stop/idle” state 502. Additionally, the modular wall system may transition to the “up” state 504 when the “up cmd” 516 is input to the main controller.

Also, the modular roll-up wall system may transition from the “down” state 506 to the “stop/idle” state 502 by a “misalign” transition 524. The “misalign” transition 524 may be initiated by a subroutine that monitors the first encoder sensor assembly 278A and the second encoder sensor assembly 274B and then evaluates the difference between the estimated travel distance of the first tube assembly 104A and the estimated travel distance 104B of the second tube assembly. In the event the estimated travel distance of the first tube assembly and the calculated travel distance of the second tube assembly is greater than a reference travel distance, then the main controller may stop the tube motor 120 with the greater estimated travel distance for a predetermined period. For instance, the reference travel distance may be 30 mm and predetermined period may be 30 microseconds. After the predetermined period has elapsed, the main controller 274 may initiate the “down_cmd” 522 and transition to the “down” state 506.

Moreover, the modular roll-up wall system may transition from the “down” state 506 to the “up-safe” state 508. For instance, the main controller 274 may monitor the first self-contained light curtain 280A and the second self-contained light curtain 280B. In the event, the first self-contained light curtain 280A or the second self-contained light curtain 280B may signal a break, the main controller 274 may regulate operation of the first tube motor 276A and the second tube motor 276B to roll-up their respective screens. The modular roll-up wall system may exit the “up-safe” state 508 by a plurality of transitions which may include: (1) “up cmd” 516: (2) “timer_out” 520; and (3) “misalign” 524.

Further still, the modular roll-up wall system may transition from the “stop/idle” state 502 to the “up” state 504 or “down” state 506 by a technician-initiated transition. For instance, a technician may depress the pedal button 292 on the control unit 264 to signal the “up cmd” 516 or the “down cmd” 522. The pedal button may signal the “stop cmd” when the pedal button 292 is released. Moreover, the main controller 274 may include an “external trigger” signal 528 which may signal that a fire alarm or similar alert has been activated 528 or cleared 530. Accordingly, the software program may include an “alarm” state 512. The software program may enter the “alarm” state 512 when the “external alarm signal” is triggered or “on” 528. The software program may transition out of the “alarm” state 512 to the “up_alarm” state 514 by the alarm_cmd” transition 526 in which the main controller regulates operation of the first tube motor 276A and the second tube motor 276B to roll-up their respective screens fully and then stop. The software program may transition from the “up_alarm” state 514 to the “stop/idle” state 502 after the “external alarm signal” is cleared or “off” 530.

FIG. 78 presents an exemplary algorithm 600 for implementing a misalign transition 524. The algorithm 600 may form the basis for a differential travel subroutine which may be a part of the software program resident in the main controller 274. Generally, the algorithm 600 may involve the determination of the estimated travel distance (TD) of a rotating tube assembly 104. For instance, the estimated travel distance (TD) of the tube assembly may be the sum of the estimated lead distance (LDD), plus the full sector travel distance (SRD), plus the estimated lag distance (LGD). For example, the LDD may be substantially equal to (first_click_time−operation_start_time)*speed. The SRD may be substantially equal to (num_of_clicks−1)*(2*PI*R)/8. And, the LGD may be substantially equal to (current_time−last click time)*speed. In the disclosed embodiment, radius R may be substantially equal to 60 mm and the speed may be approximately 10 rpm. Moreover, the operation_start_time may be the time at which the tube assembly began to rotate. The first_click_time may be the time at which a sensor target first triggered the sensor assembly. The last_click_time may be the time at which a sensor target last triggered the sensor assembly. The current_time may be the time elapsed from the operation_start_time. And, the number_of_clicks may be the number count of sensor assembly trigger events.

Further, the algorithm 600 may require that the differential travel subroutine monitor the first encoder sensor 278A and the second encoder sensor 278B and then evaluate the difference between the estimated travel distance of the first tube assembly 104A (TD1) and the estimated travel distance of the second tube assembly 104B (TD2). The algorithm 600 further may require that in the event the estimated travel distance of the first tube assembly (TD1) and the estimated travel distance of the second tube assembly (DT2) differ by more than a reference travel distance (RTD), then the software program may stop the tube motor assembly (i.e., 366A or 366B) with the greater estimated travel distance for a predetermined period (P). For example, the reference travel distance (RTD) may be 30 mm and the predetermined period (P) may be 30 microseconds. After expiry of the predetermined period (P), the algorithm may require the software program to restart the tube motor assembly (i.e., 366A or 336B) that had been stopped.

Accordingly, the first tube motor assembly 366A may include a first magnetic sensor device 278A, a first encoder ring 378A, and a first tube assembly 104A (not shown). The second tube motor assembly 366B may include a second magnetic sensor device 278B, a second encoder ring 378B, and a second tube assembly 104B (not shown). Each encoder ring 378A, 378B may include a plurality of magnets 374. The plurality of magnets 374 may be uniformly distributed about the encoder ring. The magnets 374 may be spaced at 45° on center. The center of each magnet may be disposed on a reference circle. The center of the circle may coincide with the axis of rotation of the tube motor. In an exemplary embodiment, the radius R of the reference circle may be 60 cm.

Referring to FIGS. 81-85, individual magnets 374 in the encoder ring 378 may be identified by a letter. For instance, the eight magnets 374 may be identified by the letters A, B, C, D, E, F, G, and H. During normal operation of the tube motor assembly 366, each magnet 374 on the encoder ring 378 may approach the sensor holder 390 and associated sensor assembly 278. When each magnet moves into range of the magnetic sensor device 376, the magnet 374 may apply a flux greater than the detection threshold to reliably activate the magnetic sensor device 376. This may be referred to as a “turn-on” event (or click). For instance, a “turn-on” event (or click) may occur when one of the eight magnets A, B, C, D, E, F, G, or H crosses the dashed vertical line at the top of the figure.

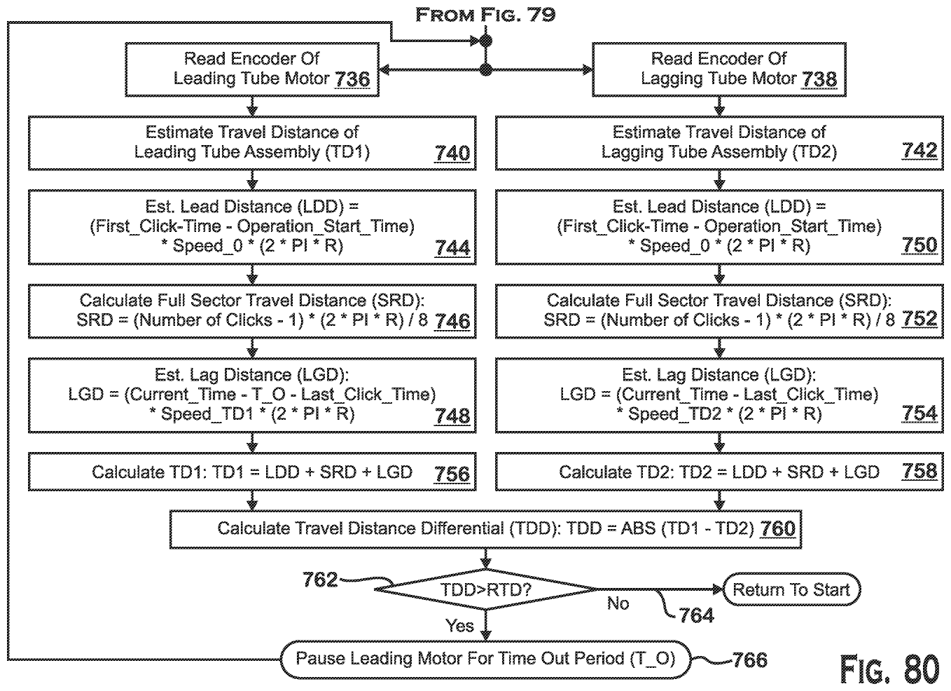

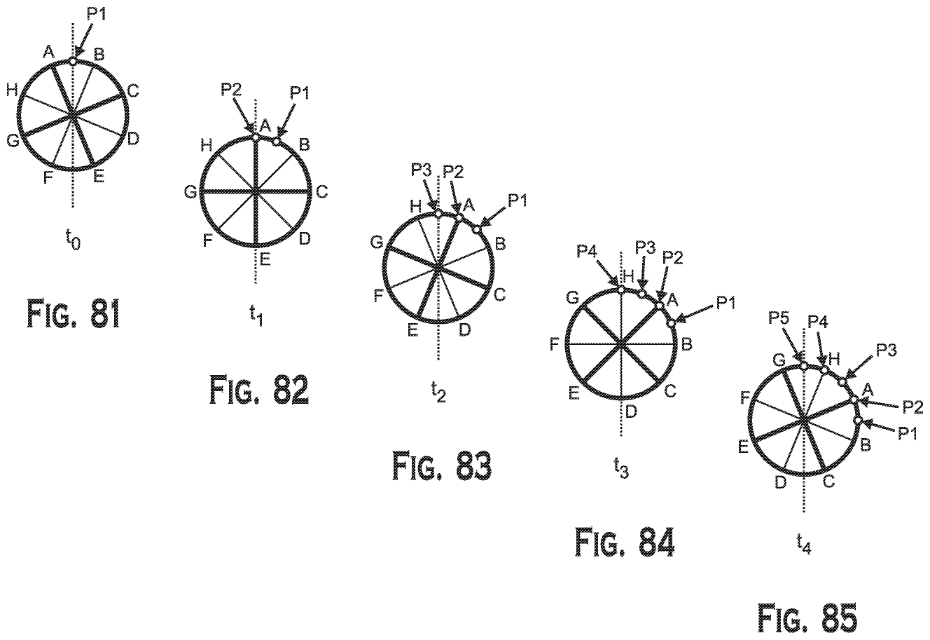

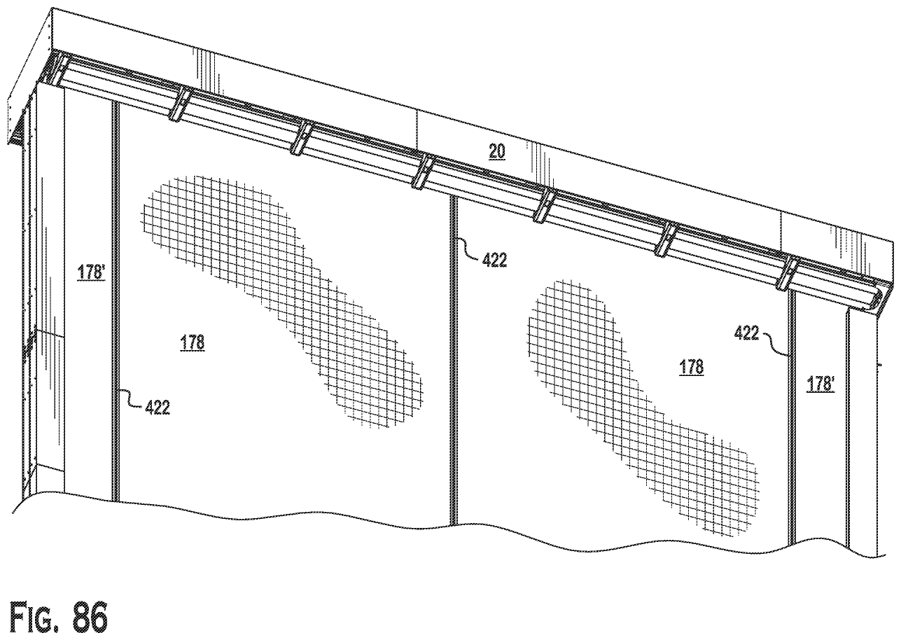

In FIG. 82, at time t equals t₁ the A magnet may initiate a “turn on” event as the A magnet crosses the dashed vertical line at the top of the figure. Referring to FIG. 84, at time t equals t₃ the H magnet may initiate a “turn on” event as the H magnet crosses the dashed vertical line at the top of the figure. These “turn-on” events may be referred to as a “first click” and a “second click”, respectively. By contrast, at t equals t₀ (FIG. 81), t₂ (FIG. 83), and t₄ (FIG. 85) the magnet nearest to the magnetic sensor device 376 at those times may be out of range of the magnetic sensor device, and thus the magnetic sensor device may be in its initial state.

Referring to FIGS. 48, 56 and 78, as the first tube assembly 104A and the second tube assembly 104B rotate, the software program resident in the main controller 274 may estimate the travel distance (TD) of the tube assembly. For example, the travel distance (or travel) of a rotating tube assembly 104 may refer to the arc length of the reference circle between an initial position and a current position of the encoder ring 378. Referring to FIG. 81 and FIG. 82, as the encoder ring 378 rotates from time to to t₁, the travel may equal the arc length between points P1 and P2. Referring to FIG. 81 and FIG. 85, as the encoder ring 378 rotates from time t₀ to t₄, the travel may equal the arc length between points P1 and P5. Additionally, the arc length between points P1 and P2 may be referred to as a leading segment (see e.g., FIG. 82), the arc length between points P2 and P4 may be referred to as a full-sector segment (see e.g., FIG. 84), and the arc length between points P4 and P5 may be referred to as a lagging segment (see e.g., FIG. 85).

Accordingly, the arc length of the full segment may be equal to the circumference C of the reference circle divided by the number of sectors (N). The arc length of the leading segment may be equal to the circumference of the reference circle C multiplied by the product of a nominal rate of rotation (SPEED_0) of the reference circle and the time-period of interest (e.g., Δt). For instance, the nominal rate of rotation may correspond to the rated speed of the tube motor (e.g., 10 rpm). Similarly, the arc length of the lagging segment may be equal to the circumference of the reference circle C multiplied by the product of the measured rate of rotation (or SPEED) of the reference circle and the time-period of interest (e.g., Δt).

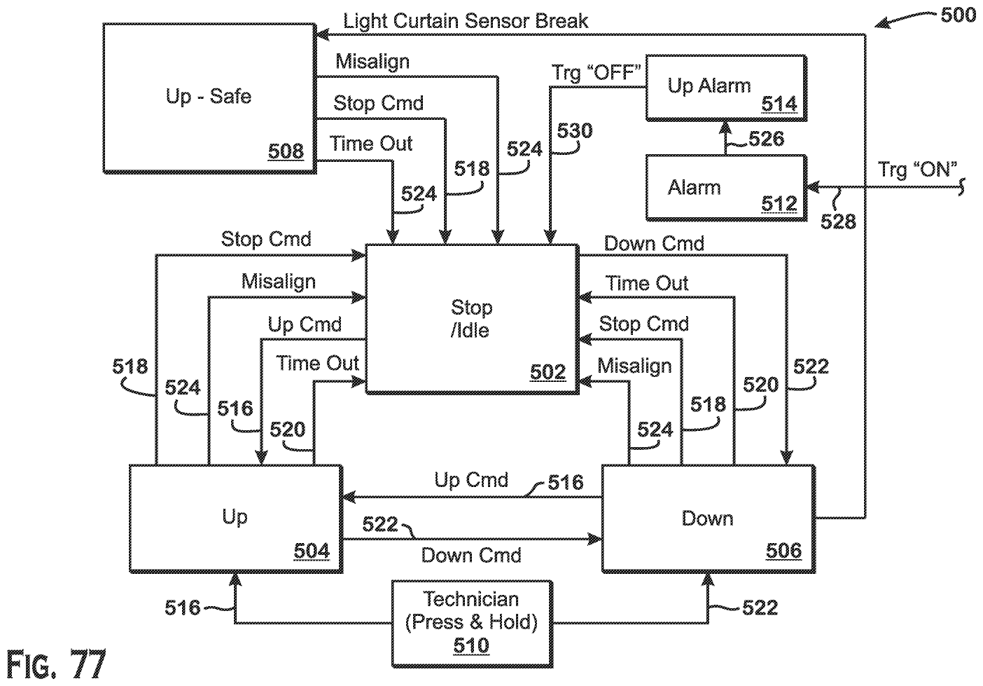

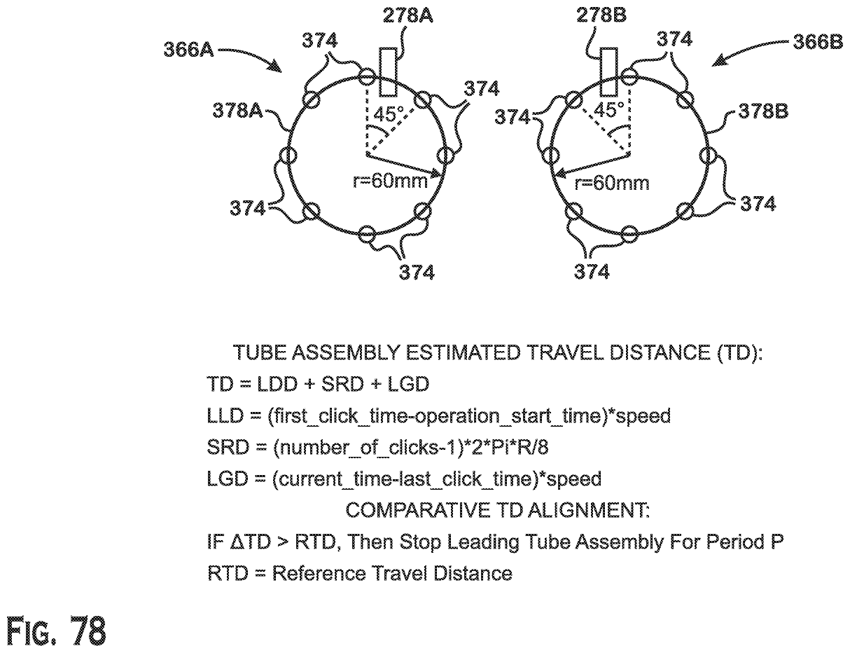

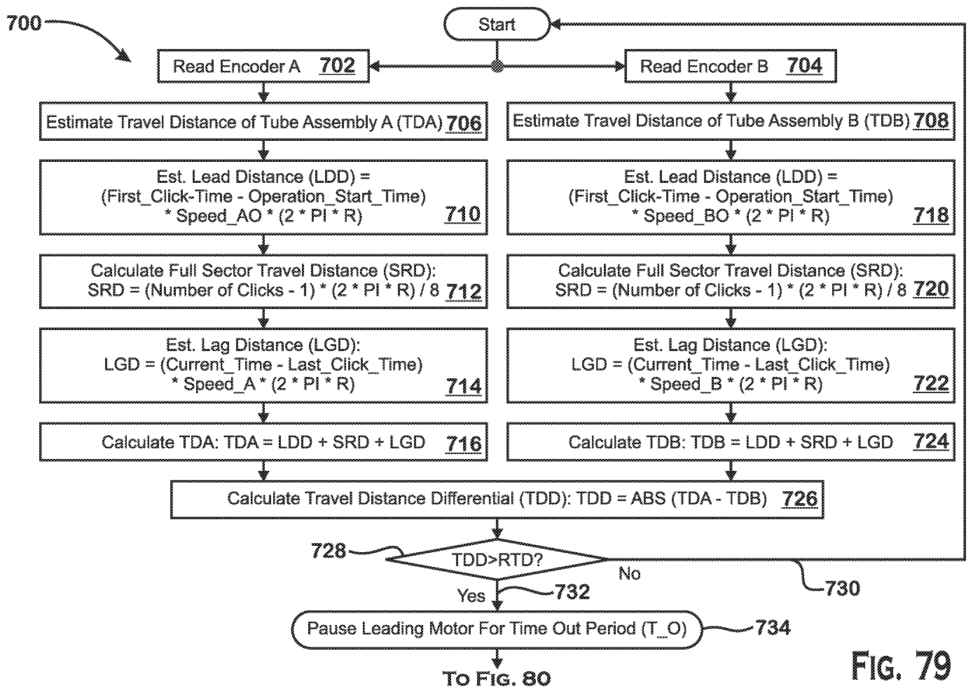

FIGS. 79 and 80, present an exemplary flow chart 700 for a subroutine of the software program resident in the main controller which monitors and corrects for differential rotational travel between the first tube assembly and the second tube assembly. Generally, the main controller may read signals from Encoder A 702 and Encoder B 704. The software program may then estimate the travel distance of tube assembly A 706 and tube assembly B 708, respectively. The estimated travel distance of the tube assembly A (TDA) may be the sum of the estimated lead distance (LDD) 710, the calculated full sector travel distance (SRD) 712, and the estimated lag distance (LGD) 714. Likewise, the estimated travel distance of the tube assembly B (TDB) may be the sum of the estimated lead distance (LDD) 718, the calculated full sector travel distance (SRD) 720, and the estimated lag distance (LGD) 722. After these parameters have been determined, the subroutine may calculate the travel distance of tube assembly A (TDA) 726 and tube assembly B (TDB) 724, respectively.

More particularly, the LDD may be equal to the product of the initial speed (SPEED_0), the circumference of the encoder ring reference circle (2*PI*R), and the difference between the FIRST_CLICK_TIME and the OPERATION_START_TIME. The initial speed (SPEED_0) may be a nominal speed (e.g., the rate of rotation in revolutions per second). The OPERATION_START_TIME may be the time at which the motor begins to operate or the time at which an operation timer is initiated. The FIRST_CLICK_TIME may be the time at which the encoder sensor signals the first CLICK or “Turn-on” event. For instance, referring to FIGS. 81-85, time to may be the OPERATION_START_TIME, and time t₁ may be the FIRST_CLICK_TIME. Also, the nominal speed may correspond to a listed motor speed of 10 revolutions per minute (e.g., 0.0167 revolutions per second). Referring to FIG. 83, the LDD may be the arc length of the segment from P1 to P2.

Referring to FIG. 79, the SRD may be equal to the arc length of one sector—(2*PI*R)/8—multiplied by the number of full sectors that have rotated past the encoder sensor 376—(NUMBER_OF_CLICKS−1). In FIG. 84, the SRD may be the arc length of the segment from P2 to P4.

Referring to FIG. 79, the LGD may be equal to the product of the current speed (SPEED_A), the circumference of the encoder ring reference circle (2*PI*R), and the difference between the CURRENT_TIME and the LAST_CLICK_TIME. The current speed (SPEED_A) may be estimated from the from the difference between the LAST_CURRENT_TDA and the SECOND_LAST_TDA divided by the difference between the LAST_CURRENT_TIME and SECOND_LAST_CURRENT_TIME. In FIG. 84, t₃ may be the LAST_CURRENT_TIME and t₂ may be the SECOND_LAST_CURRENT_TIME. Additionally, the arc length of the segment from P1 to P4 may be the LAST_CURRENT_TDA and the arc length of the segment from P1 to P3 may be SECOND_LAST_TDA.

Referring to FIG. 79, the software program may then calculate the travel distance differential (TDD) 726. The TDD may be the absolute value of the difference between TDA and TDB. The software program may compare the TDD with a reference travel distance (RTD) 728. The RTD may be a maximum allowable differential between the estimated travel distances of the two tube assemblies. For example, if the TDD is less than or equal to the RTD, then the software program does not initiate action to correct any difference between TDA and TDB 730. By contrast, if TDD is greater than RTD, then the software program may initiate action to reduce the difference between the TDD and the RTD 732. For example, the software program may stop the leading tube motor temporarily before resuming operation of the leading tube motor 734. For instance, the RTD may range from approximately 15 mm to approximately 60 mm. In the disclosed embodiment, the RTD may be 30 mm. Additionally, the time out period (T_O) may range from approximately 50 microseconds to approximately 200 microseconds. In the disclosed embodiment, the T_O may be 100 microseconds.

Referring to FIG. 80, the software program 700 may read signals from the encoder sensor of the leading tube motor assembly 736 and the encoder sensor from the lagging tube motor assembly 738, respectively. The software program then may estimate the travel distance of the leading tube motor assembly 740 and the lagging tube motor assembly 742 respectively. For instance, the estimated travel distance of the leading tube assembly (TD1) may be the sum of the estimated lead distance (LDD) 744, the full sector travel distance (SRD) 746, and the estimated lag distance (LGD) 748. The LGD, however, may be unchanged, and thus the expression for calculating LGD of the leading tube assembly may include an adjustment to the expression for LGD described above. More particularly, the time interval for estimating the lag distance (LGD) may be shortened by the time out period (T_O) because the leading tube motor may be stopped during this period. Likewise, the estimated travel distance of the lagging tube assembly (TD2) 742 may be the sum of the estimated lead distance (LDD) 750, the full sector travel distance (SRD) 752, and the estimated lag distance (LGD) 754. After these parameters have been determined, the subroutine may calculate the travel distance of the leading tube assembly (TD1) 756 and the lagging tube assembly (TD2) 758, respectively.

The software program 700 may then calculate the travel distance differential (TDD) between the leading tube motor assembly (TD1) and the lagging tube motor assembly (TD2) 760. The TDD may be the absolute value of the difference between TD1 and TD2. The software program may compare the TDD with the reference travel distance (RTD) 762. If the TDD is less than or equal to the RTD, then the software program does not initiate action to correct any difference between TDA and TDB 764. By contrast, if TDD is greater than RTD, then the software program may initiate action to reduce the difference between the TDD and the RTD 766.

In use, a structural opening may be evaluated for receiving a modular wall system in accordance with the present disclosure. The length and height of the structural opening may be measured. Although the embodiments of the modular components disclosed herein may be appropriate for structural openings having a length of approximately 40 ft and a height of approximately 14 ft, other embodiments of a modular roll-up wall systems in accordance with the present disclosure may be appropriate for structural openings having greater dimensions. Based on the length of the structural opening a frame may be constructed.

The frame may be constructed by connecting a center frame to a motor frame. Successive center frame components may be added to the motor frame until the desired length is exceeded. The last center frame may be cut to length such that the overall frame is the desired length. The support arms may then be secured to the frame. The support arms may be installed approximately every 24 inches, along with the respective 1.375-inch rollers and 0.75 inch rollers. The distal end cap may then be secured to the distal end of the frame, and the terminal set of rollers installed. The tube assembly may be constructed. A tube motor having appropriate torque for the application may be installed in the tube assembly. The tube assembly may be placed in the frame between the 1.375-inch rollers such that the side having the tube motor is adjacent to the proximal end of the frame. The proximal end cap may then be secured to the frame, and the tube motor may be secured to the anti-rotation arm. The vertical tracks may then be erected under the frame and the electrical power and control wires connected to the control unit.

A hook segment and connected fabric panel may then be secured to the tube assembly. As each abutting hook segment and fabric panel is secured to the tube assembly the abutting fabric panels may be zipped together. The fabric panels may be wound up onto the tube assembly. The lateral base track segments may be secured to the bottom of the fabric panels. The exterior track of the lateral base track segments may be connected to form a unitary base track. The tube motors may be operable from a wall switch, computer application or local WiFi application to raise or lower the flexible barrier material(s). In the lowered configuration, the flexible barrier material(s) may form a wall (or barrier) adjacent to the frame within the structural opening.

Generally, the disclosed embodiment of a modular wall systems may possess a length (e.g., a distance measured along the longitudinal axis of the frame) of approximately 40 feet and a height of approximately 14 feet. A modular wall system having two flexible barrier material walls with an air gap of approximately 4 inches may achieve a Sound Transmission Class rating of 48 STC under testing conducted in accordance with ASTM E 90-09.

The modular wall system may include a control box. The control box may be mounted within an access panel in the modular roll-up wall system by a plurality of magnets. The control box may house power and controls for operating the modular roll-up wall system. The control box may include a plurality of connectors for receiving power and control cabling. The plurality of connectors may connect a main control unit to a power source, the Internet and other system cabling. For example, the other system cabling may electrically connect the control unit to a first tube motor, a second tube motor, a first encoder, a second encoder, a first self-contained light curtain, a second self-contained light curtain, a first user interface, and a second user interface. The control box further may include a circuit breaker and a pedal button. The control unit may monitor and correct differential rotational travel between the first tube assembly and the second tube assembly.

While it has been illustrated and described what at present are considered to be preferred embodiments of the invention, it will be understood by those skilled in the art that various changes and modifications may be made, and equivalents may be substituted for elements thereof without departing from the true scope of the invention. For example, the number of sensor targets on an encoder ring may be increased. Additionally, features and/or elements from any embodiment may be used singly or in combination with other embodiments. Therefore, it is intended that the invention not be limited to the particular embodiments disclosed herein, but that it have the full scope defined by the language of the following claims, and equivalents thereof.

What is claimed is:

1. A roll-up wall system comprising:
a frame having a longitudinal axis, the frame comprising
a first roller, and
a second roller, the second roller being spaced from the first roller along a first axis that is perpendicular to the longitudinal axis;
a first tube motor assembly, the first tube motor assembly being disposed in the frame and comprising
a first tube assembly which comprises a proximal end and a distal end, the first tube assembly being spaced from the first roller and the second roller along a second axis, the second axis being perpendicular to the longitudinal axis and the first axis;
a first tube motor received in the first tube assembly, and
a first collar connected to the first tube assembly, the first collar comprising a first plurality of sensor targets, and
a first sensor assembly disposed proximate to the first collar;
a second tube motor assembly, the second tube motor assembly being disposed adjacent to the first tube motor assembly and comprising
a second tube assembly,
a second tube motor received in the second tube assembly,
a second collar connected to second tube assembly, the second collar comprising a second plurality of sensor targets, and
a second sensor assembly disposed proximate to the second collar;
a control unit operatively associated with the first tube motor assembly and the second tube motor assembly, the control unit comprising means for monitoring and correcting differential rotational travel between the first tube assembly and the second tube assembly.

2. The roll-up wall system of claim 1, further comprising
a first screen connected to the first tube assembly, and
a second screen connected to the second tube assembly.

3. The roll-up wall system of claim 2, wherein the first screen and the second screen comprise an acoustic barrier adjacent to the frame.

4. The roll-up wall system of claim 3, wherein the acoustic barrier achieves a Sound Transmission Class rating ranging from approximately 31 STC to 53 STC.

5. The roll-up wall system of claim 4, wherein the acoustic barrier achieves a Sound Transmission Class rating of approximately 46 STC.

6. The roll-up wall system of claim 5, further comprising a first hook segment, and the first hook segment connects the first screen to the first tube assembly.

7. The roll-up wall system of claim 6, wherein the first tube assembly further comprises a cleat, and the first hook segment further comprises an inferior surface which comprises a cleat shaped groove, the cleat and the cleat shaped groove being interlocked to connect the first hook segment to the first tube assembly.

8. The roll-up wall system of claim 7, wherein the first hook segment further comprises an edge adjacent to the cleat shaped groove, the edge comprising a crevice, the first screen and the crevice being interlocked to connect the first screen to the first hook segment.

9. The roll-up wall system of claim 1, further comprising an anti-rotation arm connected to the first tube motor.

10. The roll-up wall system of claim 8, wherein the first tube motor is a 280 N-m tube motor.

11. The roll-up wall system of claim 8, wherein the first tube motor is a 300 N-m tube motor.

12. The roll-up wall system of claim 1, further comprising a plurality of support arms disposed in the frame.

13. The roll-up wall system of claim 12, wherein each of the plurality of support arms are spaced approximately 24 inches on center.

14. The roll-up wall system of claim 2, wherein the first screen comprises mass loaded vinyl.

15. The roll-up wall system of claim 14, wherein the first screen comprises a reinforced mass loaded vinyl core and a felt backing.

16. The roll-up wall system of claim 15, wherein the first screen further comprises a decorative material, and the decorative material is laminated to the reinforced mass loaded vinyl core.

17. The roll-up wall system of claim 1, wherein a first sensor assembly comprises a magnetic sensor device.

18. The roll-up wall system of claim 17, wherein the magnetic sensor device comprises a Hall-effect sensor.

19. The roll-up wall system of claim 1, wherein the first collar further comprises a face, and the plurality of sensor targets are arranged at an angular interval α₂ about the face.

20. The roll-up wall system of claim 19, wherein each of the first plurality of sensor targets are magnets.

21. The roll-up wall system of claim 21, wherein the angular interval α₂ is approximately 45 degrees.

22. The roll-up wall system of claim 19, wherein each of the first plurality of sensor targets activates the first sensor assembly when proximate to the first sensor assembly.

23. A method of correcting differential rotational travel of a roll-up wall system having a first tube assembly and a second tube assembly comprising:
calculating a first initial estimated travel distance for the first tube assembly;
calculating a second initial estimated travel distance for the second tube assembly;
calculating an initial travel distance differential for the first tube assembly and the second tube assembly;
identifying a leading tube assembly from the first tube assembly or the second tube assembly; and
pausing rotation of the leading tube assembly for a period;
calculating a subsequent estimated travel distance for the first tube assembly;
calculating a second subsequent estimated travel distance for the second tube assembly; and
calculating a subsequent travel distance differential between the first tube assembly and the second tube assembly.
